(19) United States
(12) Patent Application Publication
(10) Pub. No.: US 2005/0086952 A1
(43) Pub. Date: Apr. 28, 2005

(54) Refrigerator-freezer controller of refrigenator-freezer, and method for determination of leakage of refrigerant

(76) Inventors: Hikaru Nonaka, Tokyo (JP); Tsutomu Sakuma, Tokyo (JP); Munehiro Horie, Tokyo (JP); Yoshihiko Uenoyama, Tokyo (JP); Shoji Hashimoto, Tokyo (JP); Shinji Hirai, Tokyo (JP); Susumu Saruta, Tokyo (JP); Ryousuke Yamamoto, Tokyo (JP); Katsushi Sumihiro, Tokyo (JP)

Correspondence Address: PILLSBURY WINTHROP LLP, 725 S. FIGUEROA STREET, SUITE 2800, LOS ANGELES, CA, 90017, US

(21) Appl. No.: 10/490,123

(22) PCT Filed: Sep. 19, 2002
(86) PCT No.: PCT/JP02/09615

(30) Foreign Application Priority Data
Sep. 19, 2001 (JP) 2001-285605
Sep. 27, 2001 (JP) 2001-295387
Jan. 18, 2002 (JP) 2002-10817

(51) Int. Cl. G01K 13/00

(52) U.S. Cl. 62/129

(57) ABSTRACT

A refrigerator-freezer is described, in which refrigerant leakage from the refrigeration cycle can be safely detected. The refrigerator-freezer comprises: a refrigeration cycle formed by a compressor, a capillary, an evaporator and an accumulator connected in series, and filled with a flammable refrigerant; a cooling fan configured to blow the cold air cooled by the evaporator in the refrigerator-freezer; and a refrigerant leakage detection system configured to detect leakage of the flammable refrigerant, wherein the refrigerant leakage detection system is provided with a temperature sensor configured to measure the temperature of a refrigerant conduit of the evaporator and judges that the flammable refrigerant is leaking in the low pressure side of the refrigeration cycle when the temperature is detected by the temperature sensor with the compressor being halted is no lower than a predetermined temperature.

### TECHNICAL FIELD

The present invention is related to a refrigerator-freezer provided with a refrigerant leakage detection system, a control device for a refrigerator-freezer and a method of judging refrigerant leakage for a refrigerator-freezer.

### BACKGROUND OF THE INVENTION

In recent years, there is an increasing interest on a global mass scale in ozone layer protection measures and the warming of the Earth's temperature. At the present, while most of commercially available refrigerator-freezers make use of an HFC (hydrofluorocarbon) as a refrigerant, HFC refrigerants have higher ozone depletion potentials as compared with those of natural refrigerants. Because of this, the use of an HC (hydrocarbon) whose global warming potential is low have been considered for a future refrigerant with zero ozone depletion potential.

However, since an HC refrigerant is flammable, there is a potential for causing fire by refrigerant leakage. Accordingly, in the case where an HC refrigerant is used, some safety measure must be implemented in order not to cause fire or other problems even if refrigerant leakage takes place by a shock during transportation or due to a defective product. For example, disclosed in Japanese Patent Published Application No. Hei 09-14811 is a temperature sensor or a pressure sensor provided at the inlet port and the outlet port of an evaporator for judging whether or not there is refrigerant leakage by comparing the differential temperature or the differential pressure therebetween with a predetermined value as saved in advance. On the other hand, disclosed in Japanese Patent Published Application No. Hei 09-329386 is a refrigerant leakage detector provided in the vicinity of an evaporator while when refrigerant leakage is detected, an emergency procedure is taken, for example, by forcibly exhausting the refrigerant as leaked to the atmosphere together with air through a conduit which is provided also for draining meltwater from a defroster.

Furthermore, disclosed in Japanese Patent Published Application No. Hei 2000-146429 is a technique in accordance with which the operation of a refrigerator-freezer does not start when connected to a power source with a plug just after the placement but do start only when a power switch provided in the chamber of the refrigerator-freezer is turned on, taking into consideration the possibility of refrigerant leakage into the chamber, in which the refrigerant gas resides. This technique has been proposed in order to prevent an accident from occurring, while the door is to be open before the power switch is turned on so as to release the HC refrigerant, whose specific gravity is greater than air, to the outside even if the chamber is filled with the refrigerant.

Still further, disclosed in Japanese Patent Published Application No. 2001-228283 filed by the assignee of this application is a technique in which the operation of a refrigerator-freezer starts only after judging whether or not refrigerant leakage takes place with a gas sensor, i.e., no electric signal appears, i.e., the flammable refrigerant is not leaking out.

However, it increases the cost and makes assembling work troublesome to provide sensors in two locations, i.e., the inlet port side and the outlet port side of the evaporator. Also, in accordance with prior art techniques, it is impossible to determine at which of the low pressure side and the high pressure side of the evaporator the refrigerant leakage takes place so as to require much time for repairs. Furthermore, in the case where the door is frequently opened and closed or where a substantial amount of food having a relatively high temperature is loaded, the temperature of the evaporator and the pressure of the refrigerant tend to change so that the judgment of refrigerant leakage may fail since the judgment is based on either the temperature or the pressure.

Furthermore, since refrigerant leakage is judged by means of a refrigerant leakage detector, it is impossible to detect refrigerant leakage only after the concentration of the refrigerant as leaked reach a predetermined level even if refrigerant leakage have taken place. In other words, a certain speed of refrigerant leakage is required in order to detect refrigerant leakage by means of a refrigerant leakage detector.

Generally speaking, while refrigerant leakage can be caused by abrupt leakage through a crack formed by a shock during transportation or slow leakage through a pinhole, most of actual trouble cases have occurred due to the later cause. Namely, even if there is slow leakage, a refrigerant as leaked flows away during opening and closing of the door, the concentration of the refrigerant does not reach a detectable level in many case. As a result, refrigerant leakage can not be detected to continue the operation resulting in breakdown of the compressor. Furthermore, the refrigerant leakage detector is expensive to boost the cost.

### DISCLOSURE OF THE INVENTION

In accordance with an aspect of the present invention, a refrigerator-freezer comprises: a refrigeration cycle formed by a compressor, a capillary, an evaporator and an accumulator connected in series, and filled with a flammable refrigerant; a cooling fan configured to blow the cold air cooled by said evaporator in said refrigerator-freezer; and a refrigerant leakage detection system configured to detect leakage of said flammable refrigerant, wherein said refrigerant leakage detection system is provided with a temperature sensor configured to measure the temperature of a refrigerant conduit of said evaporator and judges that said flammable refrigerant is leaking in the low pressure side of the refrigeration cycle when the temperature is detected by said temperature sensor with said compressor being halted is no lower than a predetermined temperature.

In accordance with another aspect of the present invention, a refrigerator-freezer comprises: a refrigeration cycle formed by a compressor, a capillary, an evaporator and an accumulator connected in series, and filled with a flammable refrigerant; a cooling fan configured to blow the cold air cooled by said evaporator in said refrigerator-freezer; and a refrigerant leakage detection system configured to detect leakage of said flammable refrigerant, wherein said refrigerant leakage detection system is provided with a temperature sensor configured to measure the temperature of a refrigerant conduit of said evaporator and judges that said flammable refrigerant is leaking from the high pressure side of the refrigeration cycle when the temperature detected by said temperature sensor with said compressor being operated is no higher than a predetermined temperature.

In accordance with a further aspect of the present invention, a refrigerator-freezer comprises: a refrigeration cycle formed by a compressor, a capillary, an evaporator and an accumulator connected in series, and filled with a flammable refrigerant; a cooling fan configured to blow the cold air cooled by said evaporator in said refrigerator-freezer; and a refrigerant leakage detection system configured to detect leakage of said flammable refrigerant, wherein said refrigerant leakage detection system is provided with a temperature sensor configured to measure the temperature of a refrigerant conduit of said evaporator and judges that said flammable refrigerant is leaking in the high pressure side of the refrigeration cycle when the temperature detected by said temperature sensor is no lower than a predetermined temperature while the input power to said compressor is decreasing, and that said flammable refrigerant is leaking in the low pressure side of the refrigeration cycle when the temperature detected by said temperature sensor is no higher than a predetermined temperature while the input power to said compressor is increasing.

In accordance with a further aspect of the present invention, a refrigerator-freezer comprises: a refrigeration cycle formed by a compressor, a capillary, an evaporator and an accumulator connected in series, and filled with a flammable refrigerant; a cooling fan configured to blow the cold air cooled by said evaporator in said refrigerator-freezer; and a refrigerant leakage detection system configured to detect leakage of said flammable refrigerant, wherein said refrigerant leakage detection system is provided with temperature sensors configured to measure the temperatures of refrigerant conduits in the inlet and outlet port sides of said evaporator and judges that said flammable refrigerant is leaking in the high pressure side of the refrigeration cycle when the differential temperature between temperatures detected by said temperature sensors is no lower than a predetermined temperature while the input power to said compressor is decreasing, and that said flammable refrigerant is leaking in the low pressure side of the refrigeration cycle when the differential temperature between temperatures detected by said temperature sensors is no higher than a predetermined temperature while the input power to said compressor is increasing.

In accordance with a further aspect of the present invention, a refrigerator-freezer comprises: a refrigeration cycle formed by a compressor, a capillary, an evaporator and an accumulator connected in series, and filled with a flammable refrigerant; a cooling fan configured to blow the cold air cooled by said evaporator in said refrigerator-freezer; and a temperature sensor configured to measure the temperature of said flammable refrigerant flowing in said evaporator; and a refrigerant leakage detection system configured to monitor the temperature change of said flammable refrigerant by said temperature sensor and judge leakage of said flammable refrigerant on the basis of the temperature change with reference to the state transitions of said refrigerator-freezer.

In accordance with a further aspect of the present invention, a refrigerator-freezer comprises: a thermal insulated cabinet in which a fresh-food compartment and a freezer compartment are defined; a fresh-food compartment evaporator configured to cool said fresh-food compartment; a fresh-food compartment capillary located in the inlet port side of said fresh-food compartment evaporator; a freezer compartment evaporator configured to cool said freezer compartment; a freezer compartment capillary located in the inlet port side of said freezer compartment evaporator; a refrigerant path switch mechanism located in the upstream side of said fresh-food compartment capillary and said freezer compartment capillary and configured to switch the refrigerant path for selectively supplying said flammable refrigerant to said fresh-food compartment evaporator and said freezer compartment evaporator; a compressor constituting a circulation path of said flammable refrigerant including two routes for cooling said fresh-food compartment and said freezer compartment as a cooling cycle of said refrigerator-freezer together with said fresh-food compartment evaporator, said freezer compartment evaporator, said fresh-food compartment capillary, said freezer compartment capillary and said refrigerant path switch mechanism and configured to compress said flammable refrigerant; a temperature sensor located configured to detect the temperature of said flammable refrigerant flowing in at least one of said fresh-food compartment evaporator and said freezer compartment evaporator; and a refrigerant leakage detection system configured to monitor the temperature change of said flammable refrigerant by said temperature sensor and judge leakage of said flammable refrigerant on the basis of the temperature change with reference to the state transitions of said refrigerator-freezer.

In accordance with a further aspect of the present invention, in a control device for a refrigerator-freezer comprises: a thermal insulated cabinet in which a fresh-food compartment and a freezer compartment are defined; a fresh-food compartment evaporator configured to cool said fresh-food compartment; a fresh-food compartment capillary located in the inlet port side of said fresh-food compartment evaporator; a freezer compartment evaporator configured to cool said freezer compartment; a freezer compartment capillary located in the inlet port side of said freezer compartment evaporator; a refrigerant path switch mechanism located in the upstream side of said fresh-food compartment capillary and said freezer compartment capillary and configured to switch the refrigerant path for selectively supplying said flammable refrigerant to said fresh-food compartment evaporator and said freezer compartment evaporator; a compressor constituting a circulation path of said flammable refrigerant including two routes for cooling said fresh-food compartment and said freezer compartment as a cooling cycle of said refrigerator-freezer together with said fresh-food compartment evaporator, said freezer compartment evaporator, said fresh-food compartment capillary, said freezer compartment capillary and said refrigerant path switch mechanism and configured to compress said flammable refrigerant; a controller configured to calculate the frequency of said compressor on the basis of a PID calculation with reference to the inner temperatures of said fresh-food compartment and said freezer compartment, and control said compressor and said refrigerant path switch mechanism in accordance with the frequency as calculated in order to alternately cool said fresh-food compartment and said freezer compartment, said control device is provided with a refrigerant leakage detection system configured to judge refrigerant leakage on the basis of the rate of change of the duty ratio of said compressor.

In accordance with a further aspect of the present invention, in a method of judging refrigerant leakage for a refrigerator-freezer comprises: a thermal insulated cabinet in which a fresh-food compartment and a freezer compartment are defined; a fresh-food compartment evaporator configured to cool said fresh-food compartment; a fresh-food compartment capillary located in the inlet port side of said fresh-food compartment evaporator; a freezer compartment evaporator configured to cool said freezer compartment; a freezer compartment capillary located in the inlet port side of said freezer compartment evaporator; a refrigerant path switch mechanism located in the upstream side of said fresh-food compartment capillary and said freezer compartment capillary and configured to switch the refrigerant path for selectively supplying said flammable refrigerant to said fresh-food compartment evaporator and said freezer compartment evaporator; a compressor constituting a circulation path of said flammable refrigerant including two routes for cooling said fresh-food compartment and said freezer compartment as a cooling cycle of said refrigerator-freezer together with said fresh-food compartment evaporator, said freezer compartment evaporator, said fresh-food compartment capillary, said freezer compartment capillary and said refrigerant path switch mechanism and configured to compress said flammable refrigerant; a controller configured to calculate the frequency of said compressor on the basis of a PID calculation with reference to the inner temperatures of said fresh-food compartment and said freezer compartment, and control said compressor and said refrigerant path switch mechanism in accordance with the frequency as calculated in order to alternately cool said fresh-food compartment and said freezer compartment, refrigerant leakage is judged by comparing the duty ratio in the current cycle of a cooling mode with the duty ratio in the previous cycle of the same cooling mode.

### BRIEF DESCRIPTION OF DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 is a flowchart showing a method of judging refrigerant leakage for the refrigerator-freezer in accordance with a first embodiment of the present invention.

FIG. 2 is a flowchart showing another method of judging refrigerant leakage for the refrigerator-freezer in accordance with the first embodiment of the present invention.

FIG. 3 is a longitudinal cross sectional view showing the refrigerator-freezer in accordance with the first embodiment of the present invention.

FIG. 4 is a schematic diagram showing the refrigeration cycle of the refrigerator-freezer in accordance with the first embodiment of the present invention.

FIG. 5 is a schematic diagram showing a control block diagram of the refrigerator-freezer in accordance with the first embodiment of the present invention.

FIG. 6 is a graphic diagram showing the temperature change of the evaporator and the pressure change of the refrigerant in the refrigerator-freezer in accordance with the first embodiment of the present invention in the case where refrigerant leakage occurs in the low pressure side of the refrigeration cycle after the normal operation without refrigerant leakage.

FIG. 7 is a graphic diagram showing the pressure change of the refrigerant and the temperature change of the evaporator in the refrigerator-freezer in accordance with the first embodiment of the present invention in the case where refrigerant leakage occurs in the high pressure side of the refrigeration cycle after the normal operation without refrigerant leakage.

FIG. 8 is a graphic diagram showing variation of the input power (W) to the compressor when refrigerant leakage occurs in the refrigerator-freezer in accordance with the first embodiment of the present invention.

FIG. 9 is a longitudinal cross sectional view showing the refrigeration cycle of the refrigerator-freezer in accordance with a second embodiment of the present invention.

FIG. 10 is a schematic diagram showing the refrigeration cycle of the refrigerator-freezer in accordance with the second embodiment of the present invention.

FIG. 11 a schematic diagram showing the operation modes of the refrigerator-freezer in accordance with the second embodiment of the present invention including a freezer compartment cooling mode as illustrated in FIG. 11(a), a fresh-food compartment cooling mode as illustrated in FIG. 11(b), the full close mode as illustrated in FIG. 11(c) and the full open mode as illustrated in FIG. 11(d).

FIG. 12 is a graphic diagram showing the temperatures of the inlet port and the outlet port of each of the fresh-food compartment evaporator and the freezer compartment evaporator of the refrigerator-freezer in accordance with the second embodiment of the present invention.

FIG. 13(A) is a graphic diagram showing the concentrations of the inlet port and the outlet port of each of the fresh-food compartment evaporator and the freezer compartment evaporator of the refrigerator-freezer in accordance with the second embodiment of the present invention.

FIG. 13(B) is a graphic diagram showing the temperatures of the inlet port and the outlet port of each of the fresh-food compartment evaporator and the freezer compartment evaporator of the refrigerator-freezer in accordance with the second embodiment of the present invention.

FIG. 14(A) is a graphic diagram as expanded showing the concentrations of the inlet port and the outlet port of each of the fresh-food compartment evaporator and the freezer compartment evaporator of the refrigerator-freezer in accordance with the second embodiment of the present invention.

FIG. 14(B) is a graphic diagram as expanded showing the temperatures of the inlet port and the outlet port of each of the fresh-food compartment evaporator and the freezer compartment evaporator of the refrigerator-freezer in accordance with the second embodiment of the present invention.

FIG. 15 is a flowchart showing a method of judging refrigerant leakage for the refrigerator-freezer in accordance with the second embodiment of the present invention.

FIG. 16 is a flowchart showing another method of judging refrigerant leakage for the refrigerator-freezer in accordance with the second embodiment of the present invention.

FIG. 17 is a perspective view showing a method of fixing a temperature sensor to the fresh-food compartment evaporator of the refrigerator-freezer in accordance with the second embodiment of the present invention.

FIG. 18 is a perspective view showing another method of fixing temperature sensors to the fresh-food compartment evaporator of the refrigerator-freezer in accordance with the second embodiment of the present invention.

FIG. 19 is a schematic diagram showing the functional blocks of a controller of the refrigerator-freezer in accordance with the second embodiment of the present invention.

FIG. 20 is a flowchart showing a method of judging refrigerant leakage for the refrigerator-freezer in accordance with the second embodiment of the present invention.

FIG. 21 is a schematic diagram showing the functional blocks of another controller of the refrigerator-freezer in accordance with the second embodiment of the present invention.

FIG. 22 is a flowchart showing another method of judging refrigerant leakage for the refrigerator-freezer in accordance with the second embodiment of the present invention.

FIG. 23 is a schematic diagram showing the functional blocks of a further controller of the refrigerator-freezer in accordance with the second embodiment of the present invention.

FIG. 24 is a flowchart showing a further method of judging refrigerant leakage for the refrigerator-freezer in accordance with the second embodiment of the present invention.

FIG. 25 is a schematic diagram showing the functional blocks of a still further controller of the refrigerator-freezer in accordance with the second embodiment of the present invention.

FIG. 26 is a flowchart showing a still further method of judging refrigerant leakage for the refrigerator-freezer in accordance with the second embodiment of the present invention.

FIG. 27 is a longitudinal cross sectional view showing the refrigerator-freezer in accordance with a third embodiment of the present invention.

FIG. 28 is a schematic diagram showing the refrigeration cycle of the refrigerator-freezer in accordance with the third embodiment of the present invention.

FIG. 29 is a schematic diagram showing the functional blocks of a controller of the refrigerator-freezer in accordance with the second embodiment of the present invention.

FIG. 30 is a flowchart showing the procedure for determining the timing to check the duty ratio of the compressor in accordance with the third embodiment of the present invention.

FIG. 31 is a flowchart showing the procedure for sampling duty ratios in accordance with the third embodiment of the present invention.

FIG. 32 is a flowchart showing the procedure for checking the differential temperature between the inlet port and the outlet port of the evaporator aside the freezer compartment in accordance with the third embodiment of the present invention.

FIG. 33 is a flowchart showing the procedure for judging the increase of the duty ratio in accordance with the third embodiment of the present invention.

FIG. 34 is a flowchart showing the procedure for judging refrigerant leakage in the low pressure side in accordance with the third embodiment of the present invention.

FIG. 35 is a flowchart showing the procedure for judging the decrease of the duty ratio and judging refrigerant leakage in the high pressure side in accordance with the third embodiment of the present invention.

FIG. 36 is a flowchart showing the variation of the duty ratio in accordance with the third embodiment of the present invention when refrigerant leakage occurs in the low pressure side.

FIG. 37 is a flowchart showing the variation of the duty ratio in accordance with the third embodiment of the present invention when refrigerant leakage occurs in the low pressure side.

FIG. 38 is a flowchart showing the variation of the duty ratio in accordance with the third embodiment of the present invention when refrigerant leakage occurs in the high pressure side.

FIG. 39 is a flowchart showing the variation of the duty ratio and the variation of the temperatures in accordance with the third embodiment of the present invention when refrigerant leakage occurs in the low pressure side.

FIG. 40 is a flowchart showing the variation of the duty ratio and the variation of the temperatures in accordance with the third embodiment of the present invention when refrigerant leakage occurs in the high pressure side.

FIG. 41 is a flowchart showing the variation of the duty ratio, the variation of the temperatures and the variation of the PID value in accordance with the third embodiment of the present invention when refrigerant leakage occurs in the low pressure side.

### THE PREFERRED EMBODIMENT OF THE INVENTION

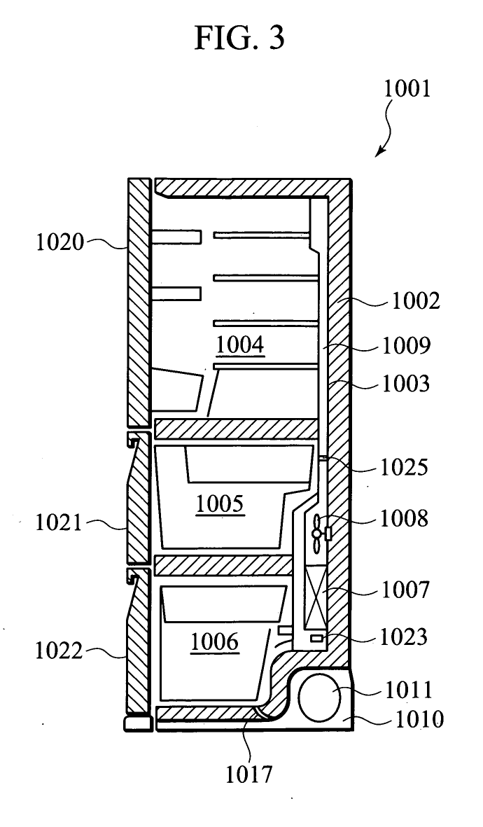

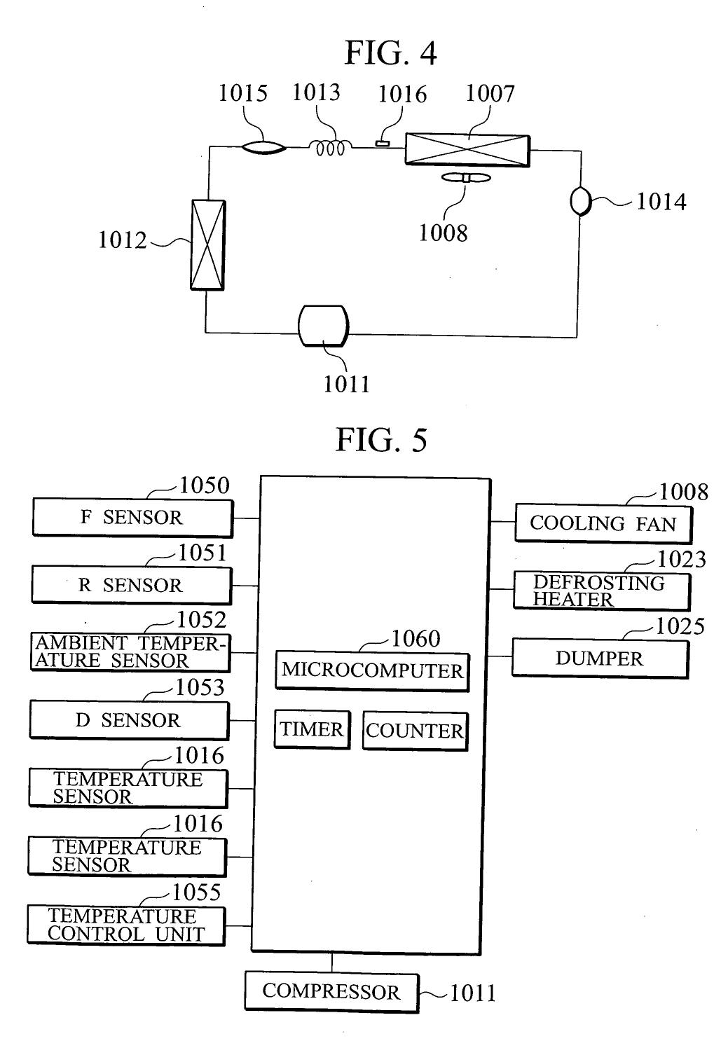

In the followings, various embodiments of the present invention will be described with reference to the accompanying drawings. FIG. 3 is a longitudinal cross sectional view showing a refrigerator-freezer in accordance with a first embodiment of the present invention. FIG. 4 is a schematic diagram showing the refrigeration cycle of the refrigerator-freezer.

The reference numeral 1001 designates the refrigerator-freezer composed of a thermal insulated cabinet 1002 and an inner cabinet 1003 which is partitioned into a fresh-food compartment 1004, a vegetable compartment 1005 and a freezer compartment 1006, each compartment being provided with an individual door 1020 to 1022. An evaporator 1007 and a cooling fan 1008 are provided behind the vegetable compartment 1005 and operated in synchronism with a compressor 1011. Also, a cold air circulation duct 1009 is provided behind the fresh-food compartment 1004 for supplying the cold air to the inside of the fresh-food compartment 1004 and the inside of the vegetable compartment, together with a dumper 1025 for controllig the amount of the cold air.

A condenser 1012 is provided in a machine room 1010 located in the rear bottom of the body 1001 of the refrigerator-freezer, as well as the compressor 1011, for constituting the refrigeration cycle of an HC refrigerant included therein as a flammable refrigerant, for example, isobutane. Also, the temperature sensor 1016 is located on the conduit at the inlet port side of the evaporator 1007. The refrigerant as output from the compressor 1011 is passed through the condenser 1012, a capillary tube 1013, the evaporator 1007 and an accumulator 1014 and then returned to the compressor 1011 again. The cold air as cooled by the evaporator 1007 with the cooling fan 1008 is supplied to the fresh-food compartment 1004, the vegetable compartment 1005 and the freezer compartment 1006 to cool them.

As illustrated in FIG. 5 which is a control block diagram, a freezer compartment temperature sensor 1050 (referred to as the F sensor in the following explanation) is provided in the freezer compartment 1006 for detecting the temperature of the freezer compartment 1006 while a fresh-food and vegetable compartment temperature sensor 1051 (referred to as the R sensor in the following explanation) is provided for detecting the temperature of the fresh-food compartment 1004 and the vegetable compartment 1005. When the output value from the R sensor 1051 is judged to be higher than a reference temperature as predetermined by a microcomputer 1060, the compressor 1011 is driven to cool the fresh-food compartment 1004 and the vegetable compartment 1005.

The cold air is circulated to the freezer compartment 1006 by the cooling fan 1008 and to the fresh-food compartment 1004 and the vegetable compartment 1005 through the cold air circulation duct 1009 by opening the dumper 1025. Also, when the inner temperatures of the fresh-food compartment 1004 and the vegetable compartment 1005 become lower than the reference temperature, the dumper 1025 is closed to stop supplying the cold air to the compartments in order to control the temperatures in the compartments. On the other hand, when the output value from the F sensor 1050 is judged to be lower than a reference temperature as predetermined, the compressor 1011 is stopped. Thereafter, when the output value becomes higher than the reference temperature due to temperature elevation, the operation of the compressor 1011 is resumed. It is preferred that the reference temperature can be adjusted by means of the temperature control unit 1055 provided with an ambient temperature sensor 1052, a manipulation panel and so forth.

The inner temperatures of the respective compartments such as the vegetable compartment are adjusted by repeatedly halting and resuming the operation of the compressor 1011 with reference to the reference temperature and the output values of the respective sensors.

On the other hand, when the accumulated operation time of the compressor 1011 reaches to a predetermined time or when the number of opening/closing times of each door as counted reaches to a predetermined number, the defrosting operation of the evaporator 1007 is started by energizing the defrosting heater 1023 located below the evaporator 1007. During the defrosting operation, the compressor 1011 and the cooling fan 1008 are halted while the output value of a defrosting sensor (located in the vicinity of the accumulator 1014 and referred to as the D sensor in the following explanation) 1053 is output to the microcomputer 1060. When the output value becomes higher than the reference temperature as predetermined, for example, 3° C., the defrosting operation is terminated by judging that the frost on the evaporator 1007 has completely thawed and halting power supply to the defrosting heater 1023.

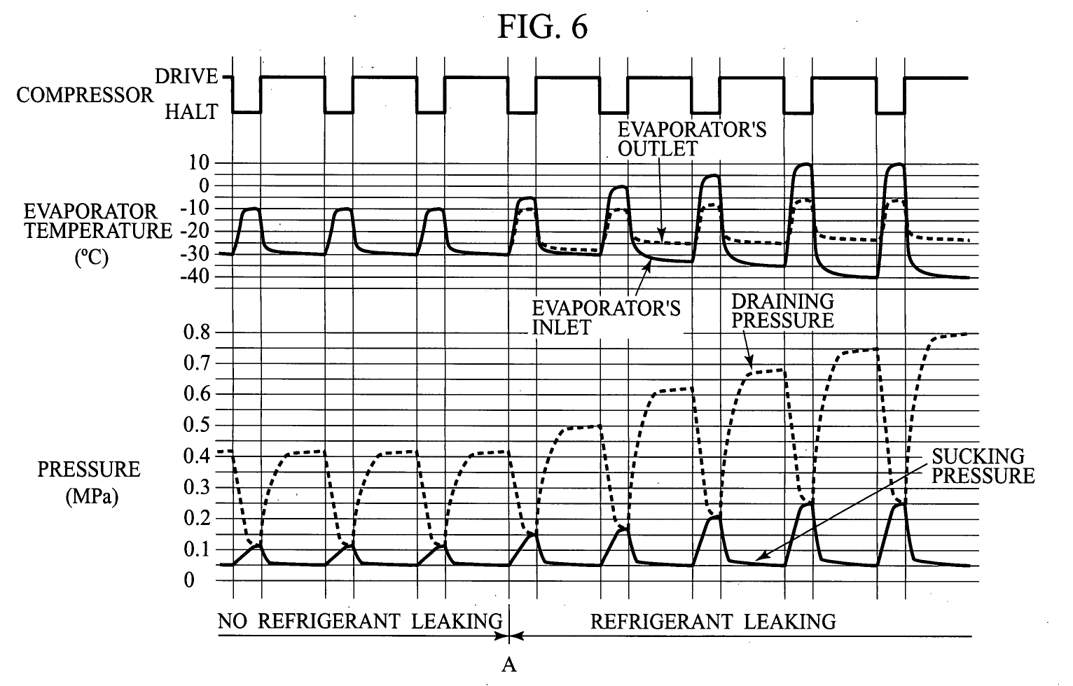

Next, the temperature change of the evaporator and the pressure change of the refrigerant will be explained with reference to FIG. 6 in the case where refrigerant leakage occurs in the low pressure side of the refrigeration cycle after the normal operation without refrigerant leakage.

While a flammable isobutane (R1600a) is used as the refrigerant in the above described refrigeration cycle, the operation of the compressor 1011 is halted when the temperature of the evaporator 1007 falls to −28° C. and resumed when the temperature rises to −10° C.

In this case, the refrigerant draining pressure (Pd) is about 0.45 MPa just before the compressor 1011 is halted and then rises to about 0.11 MPa with the compressor 1011 being halted. Also, the refrigerant sucking pressure (Ps) is about 0.05 MPa with the compressor 1011 being operated and falls to about 0.11 MPa with the compressor 1011 being halted to balance with the refrigerant draining pressure (Pd). Meanwhile, the pressure of the atmosphere is about 0.1 MPa while the boiling point of isobutane is about −11° C.

Accordingly, the pressure of the refrigerant in the low pressure side of the refrigeration cycle including the evaporator 1007 is no higher than the pressure of the atmosphere during operation of the compressor 1011, and therefore the refrigerant does not leak when there is formed a pinhole or a crack through a refrigerant conduit in the low pressure side of the refrigeration cycle, but rather the external air is sucked into the refrigerant conduit through the pinhole or the crack at this time. The pressure of the refrigerant is gradually elevated in the refrigeration cycle while repeating sucking the air, and when the pressure of the conduit becomes higher than the pressure of the atmosphere, the refrigerant begins leaking to the air.

When there appears some defect causing refrigerant leakage, which is equivalent to a pinhole of 0.1 mm diameter, in the low pressure side of the refrigeration cycle at the time point A, as illustrated in FIG. 6, there is little change in the pressure of the refrigerant when the compressor is halted just after the refrigerant leakage while the temperature of the evaporator 1007 is elevated by about 5K in the inlet port side. When the operation of the compressor is resumed, the pressure of the refrigerant is elevated by about 0.07 MPa in the refrigerant draining side and slightly elevated in the refrigerant sucking side. The temperature is elevated by about 3K in the outlet port side of the evaporator 1007 during the operation of the compressor 1007, but falls down by 1K in the inlet port side.

Thereafter, the pressure of the refrigerant is significantly elevated in the refrigerant draining side of the refrigeration cycle during operation, and slightly elevated in the refrigerant sucking side, while halting and resuming the operation of the compressor 1011. Also, the temperature of the refrigerant is elevated in the outlet port side of the evaporator 1007 during operation, when halting and resuming the operation of the compressor 1011, while the temperature of the evaporator 1007 in the inlet port side substantially rises during the operation and substantially falls with the compressor 1011 being halted increasing the differential temperature therebetween.

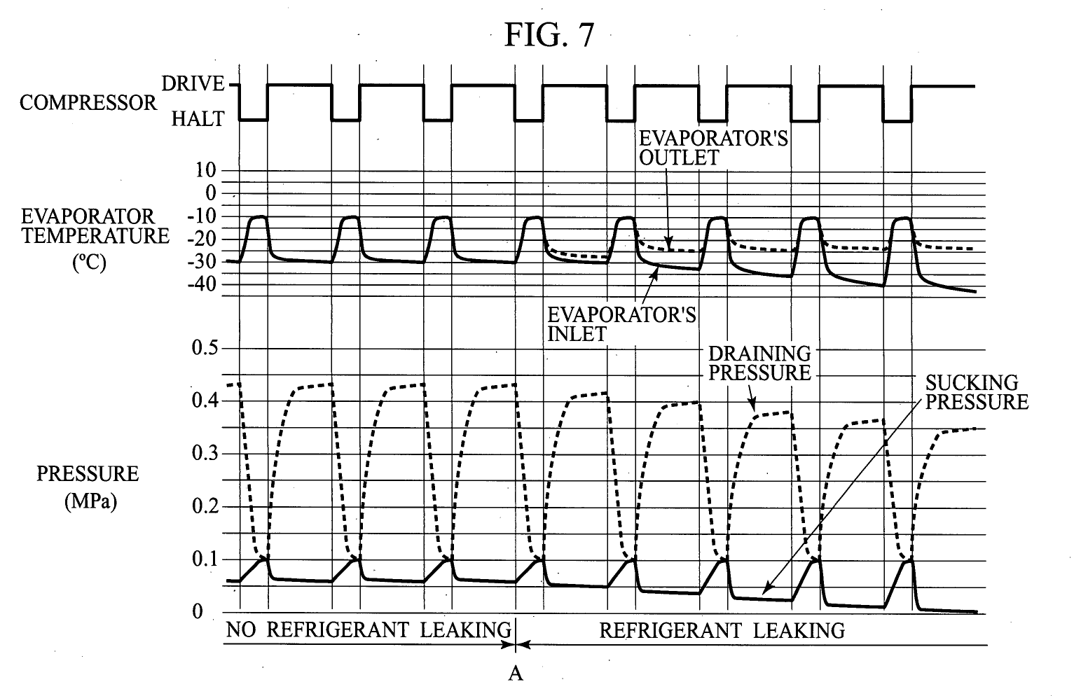

Next, with reference to FIG. 7, the pressure change of the refrigerant and the temperature change of the evaporator will be explained in the case where refrigerant leakage occurs in the high pressure side of the refrigeration cycle after the normal operation without refrigerant leakage.

The refrigerant pressures Pd and Ps and the temperatures of the refrigerant at the inlet and outlet ports of the compressor 1011 which is halted and operated are same as described above. In contrast with the case in the low pressure side, since the pressure in the high pressure side of the conduit is higher than the pressure of the atmosphere during operation of the compressor 1011, the refrigerant immediately leaks when there is formed a pinhole or a crack through a refrigerant conduit.

When there appears some defect causing refrigerant leakage, which is equivalent to a pinhole of 0.1 mm diameter, in the high pressure side of the refrigeration cycle at the time point A, as illustrated in FIG. 7, there is little change in the pressure of the refrigerant when the compressor is halted just after the refrigerant leakage while the load on the compressor 1011 becomes light during operation because of refrigerant leakage with the pressure in the refrigerant draining side decreasing to about 0.42 MPa and with the pressure in the refrigerant sucking side decreasing to about 0.05 MPa. Then, the temperature in the outlet port side of the evaporator 1007 is elevated by about 3K while the temperature in the inlet port side of the evaporator 1007 is lowered by about 1K.

Thereafter, the pressure in the refrigerant draining side gradually falls while the pressure in the refrigerant sucking side also falls little by little with the compressor repeatedly halting and resuming its operation. On the other hand, each time when the operation of the compressor is halted and resumed, the temperature in the outlet port side of the evaporator 1007 is elevated while the temperature in the inlet port side of the evaporator 1007 is lowered due to the under-charge effect.

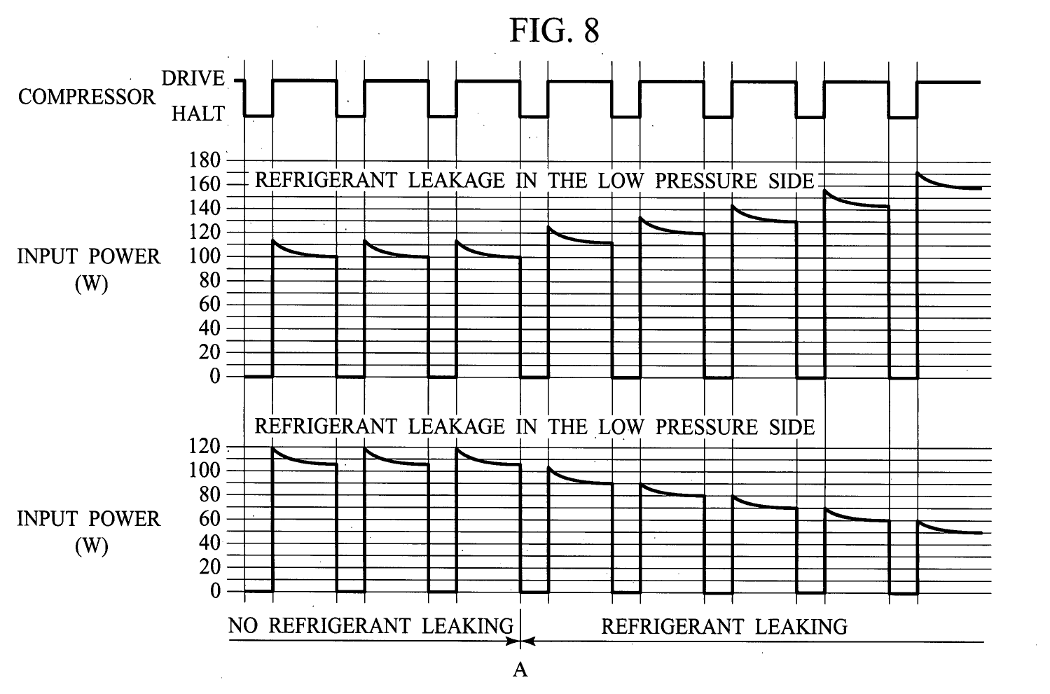

The variation of the input power (W) to the compressor 1011 when refrigerant leakage occurs will be explained with reference to FIG. 8. If refrigerant leakage occurs the low pressure side of the refrigeration cycle, the input power to the compressor gradually increases. This is because the load on the compressor 1011 increases due to the air sucked into a refrigerant conduit. Conversely, if refrigerant leakage occurs the high pressure side of the refrigeration cycle, the input power to the compressor gradually decreases. This is because the amount of the refrigerant in the refrigeration cycle decreases due to refrigerant leakage to decrease the load on the compressor 1011.

<First Exemplary Implementation>

In the followings, a first exemplary implementation of the refrigerator-freezer in accordance with the first embodiment of the present invention will be explained. In this case, when the temperature at the inlet port side of the evaporator 1007 as detected by the temperature sensor 1016 becomes higher than a maximum level as predetermined by the microcomputer 1060 with the compressor 1011 being halted, refrigerant leakage is judged to occur from the low pressure side of the refrigeration cycle.

When the compressor 1011 is halted, the refrigerant flows into the evaporator 1007 in the low pressure side of the refrigeration cycle from the condenser in the high pressure side so that the temperature of the evaporator at the inlet port is elevated to about −10° C. However, when refrigerant leakage occurs in the low pressure side, for example, at the outlet port of the evaporator, the pressure of the refrigeration cycle is elevated with the air enterring through the leakage path so as to increase the amount of the refrigerant flowing from the high pressure side resulting in further increase in the pressure.

As a result, since the temperature of the inlet port of the evaporator 1007 gradually rises when the compressor 1011 is halted, the maximum level of the temperature of the inlet port of the evaporator 1007 is set to 5° C. so that, when the temperature of the inlet port becomes as explained higher than 5° C., it is judged that refrigerant leakage occurs in the low pressure side.

As above described, when refrigerant leakage occurs through a pinhole or a crack on a conduit inside of the refrigerator-freezer, it is possible to judge that refrigerant leakage occurs in the low pressure side before the concentration of the refrigerant as leaked reaches the lower explosion limit, and therefore to quickly take a necessary procedure with safety.

Also, since the refrigerant leakage detection system can be implemented only by providing a single temperature sensor in one place, the structure is excellent in terms of manufacture, and therefore it is possible to keep production costs to a minimum level.

<Second Exemplary Implementation>

In the followings, a second exemplary implementation of the refrigerator-freezer in accordance with the first embodiment of the present invention will be explained. In this case, when the temperature at the inlet port side of the evaporator 1007 as detected by the temperature sensor 1016 becomes lower than a minimum level as predetermined by the microcomputer 1060 during operation of the compressor 1011, refrigerant leakage is judged to occur from the high pressure side of the refrigeration cycle.

Unlike the above described first exemplary implementation, when refrigerant leakage occurs in the high pressure side, the air is not sucked while the refrigerant is released through a conduit to the atmosphere, and therefore the refrigeration cycle becomes scarce of the refrigerant. During operation of the compressor 1011, therefore the temperature of the inlet port of the evaporator 1007 therefore tends to fall down while the temperature of the outlet port tends to rise.

Then, the minimum level of the temperature at the inlet port of the evaporator is set, for example, to −40° C. (usually, about −30° C.), and if a temperature no higher than this level it is judged that refrigerant leakage occurs in the high pressure side. Furthermore, in this case, refrigerant leakage in the high pressure side can more safely be detected by introducing another detection criteria that the temperature of the inlet port of the evaporator 1007 is lower than a maximum level, for example, 5° C. when the compressor 1011 is halted. By this configuration, it is possible to detect refrigerant leakage when the temperature of the evaporator becomes lower than a predetermined value during the operation of the compressor, and therefore to quickly take a necessary procedure with safety. Also, since the location of refrigerant leakage can be determined to be in the high pressure side, it is possible to reduce the time required for identifying the location of refrigerant leakage and so forth.

Furthermore, since the refrigerant leakage detection system can be implemented only by providing a single temperature sensor in one place, the structure is excellent in terms of manufacture, and therefore it is possible to keep production costs to a minimum level.

<Third Exemplary Implementation>

In the followings, a third exemplary implementation of the refrigerator-freezer in accordance with the first embodiment of the present invention will be explained. In this case, when the operation of the compressor 1011 is continued, the compressor is halted after each continuous run for a predetermined time period. Namely, when refrigerant leakage from the low pressure side is judged by comparing the temperature of the inlet port of the evaporator 1007 with the maximum level, the compressor 1011 has to be halted.

However, when the compressor is not halted due to a heavy load on the compressor and therefore continuously operated, it is impossible to detect the highest temperature of the inlet port of the evaporator which is attained just before the operation of the compressor is resumed.

Accordingly, when the cooling operation is continued for 10 hours, the compressor 1011 is unconditionally halted to judge refrigerant leakage. It is therefore possible to safely detect refrigerant leakage by confirming the temperature of the inlet port of the evaporator 1007 which is elevated when the compressor 1011 is halted.

<Fourth Exemplary Implementation>

In the followings, a fourth exemplary implementation of the refrigerator-freezer in accordance with the first embodiment of the present invention will be explained. In this case, refrigerant leakage is judged with reference to the input power of the compressor 1011 and the temperature of the evaporator at the inlet port during operation of the compressor. Namely, when the temperature of the inlet port of the evaporator 1007 is no lower than 5° C. when the compressor 1011 is halted or no higher than −40° C. when the compressor 1011 is operated, the refrigerant leakage is judged to occur in the high pressure side of the refrigeration cycle if the input power to the compressor 1011 tends to decrease and judged to occur in the low pressure side of the refrigeration cycle if the input power to the compressor 1011 tends to increase.

During operation of the compressor 1011, the temperature of the evaporator at the inlet port tends to decrease when refrigerant leakage occurs, irrespective of in which side of the low or high pressure side the refrigerant is leaking. If refrigerant leakage occurs in the low pressure side, the air is sucked into a conduit to increase the inside pressure and the input power to the compressor. However, as described above, when the pressure rises higher than a predetermined level, the refrigerant starts leaking so that the workload of the compressor 1011 decreases to lower the input power to the compressor after an amount of the refrigerant has been leaked.

Accordingly, when the temperature of the evaporator at the inlet port becomes no higher than the minimum level, refrigerant leakage is judged to occur followed by monitoring the input power. The change of the input power can be judged by comparing the current input power with the input powers of the preceding 2 to 3 cycles. Accordingly, if the input power tends to increase, refrigerant leakage is judged to occur in the low pressure side as understood from the graphic pattern as illustrated in FIG. 8.

On the other hand, if refrigerant leakage occurs in the high pressure side, the refrigerant is released to the air to decrease the pressure and then to decrease the input power. Hence, when the temperature of the evaporator at the inlet port falls down beyond the minimum level, it is judged that refrigerant leakage occurs followed by monitoring the input power. If the input power tends to decrease, refrigerant leakage is judged to be occurring in the high pressure side.

<Fifth Exemplary Implementation>

In the followings, a fifth exemplary implementation of the refrigerator-freezer in accordance with the first embodiment of the present invention will be explained. In this case, refrigerant leakage is judged with reference to the differential temperature between the inlet port and the outlet port of the evaporator rather than the temperature of the inlet port of the evaporator 1007 as compared with a minimum level. Namely, a temperature sensor 1016′ is provided in the outlet port side of the evaporator 1007 to detect the differential output signal between the temperature sensor 1016 in the inlet port side and the temperature sensor in the outlet port side to judge refrigerant leakage.

By this configuration, even if the temperature of the inlet port of the evaporator falls lower than a usual level by forcibly driving the compressor in response to an increase in temperature, for example, when a substantial amount of food having a relatively high temperature is loaded, the temperature of the outlet port of the evaporator also tends to fall so that the pattern is distinguished from that in the case of refrigerant leakage. By this configuration, refrigerant leakage can more accurately be detected by the use of the differential temperature between the inlet port and the outlet port of the evaporator in order to avoid misjudgment of refrigerant leakage.

<Sixth Exemplary Implementation>

In the followings, a sixth exemplary implementation of the refrigerator-freezer in accordance with the first embodiment of the present invention will be explained. In this case, a D-sensor 1053 provided for the accumulator 1013 is used also as the temperature sensor 1016′ provided in the outlet port side of the evaporator 1007. By this configuration as described above, since only one additional temperature sensor is required for detecting refrigerant leakage, it is possible to avoid an increase in the cost and to detect refrigerant leakage with a high degree of accuracy.

<Seventh Exemplary Implementation>

In the followings, a seventh exemplary implementation of the refrigerator-freezer in accordance with the first embodiment of the present invention will be explained. In this case, while a ventilation conduit 1017 for intercommunicating with the external space is provided in the bottom section of a cooling room in which is located the evaporator 1007, the operation of the cooling fan 1008 is halted when refrigerant leakage is detected.

When refrigerant leakage occurs in the refrigerator-freezer, the refrigerant as leaked heavier than the air tends to remain in the bottom section inside of the refrigerator-freezer. In this situation, if the cooling fan 1008 is rotated, the refrigerant is mixed with the air and diffused into the respective cooling compartments.

In the case where the amount of the refrigerant as enclosed in the refrigeration cycle is not so much, the concentration thereof would not reach the lower explosion limit even if the entirety of the refrigerant has leaked inside of the refrigerator-freezer since the refrigerant is diffused into the fresh-food compartment 1004, the freezer compartment 1006 and the vegetable compartment 1005. However, in the case of this embodiment of the present invention provided with a single evaporator in the refrigeration cycle, a relatively much amount of the refrigerant is enclosed in the refrigeration cycle so that, if the refrigerant as leaked is diffused into the respective compartments by rotating the cooling fan 1008, the concentration of the refrigerant can reach an explosion level.

Hence, if refrigerant leakage is detected, the cooling fan 1008 is halted in order to avoid mixture with the air and release to the external space by itself through the ventilation conduit 1017. Accordingly, even if there is refrigerant leakage, the safety is assured.

<Eighth Exemplary Implementation>

In the followings, an eighth exemplary implementation of the refrigerator-freezer in accordance with the first embodiment of the present invention will be explained. In this case, when refrigerant leakage is detected, a notice such as an alarm is generated a predetermined time after the detection of refrigerant leakage.

The concentration of the refrigerant as leaked may reach an explosion level in the vicinity of the refrigerator-freezer since the concentration is particularly high just after the refrigerant leakage. In this case, there is a possibility that the user has doubts about the reliability of the notice or alarm and therefore may try to connect again the electric power plug or to open/close the door. When refrigerant leakage is detected, therefore the notice is postponed until the refrigerant as leaked is diffused by itself around the refrigerator-freezer to decrease the concentration in order to take a necessary procedure with safety.

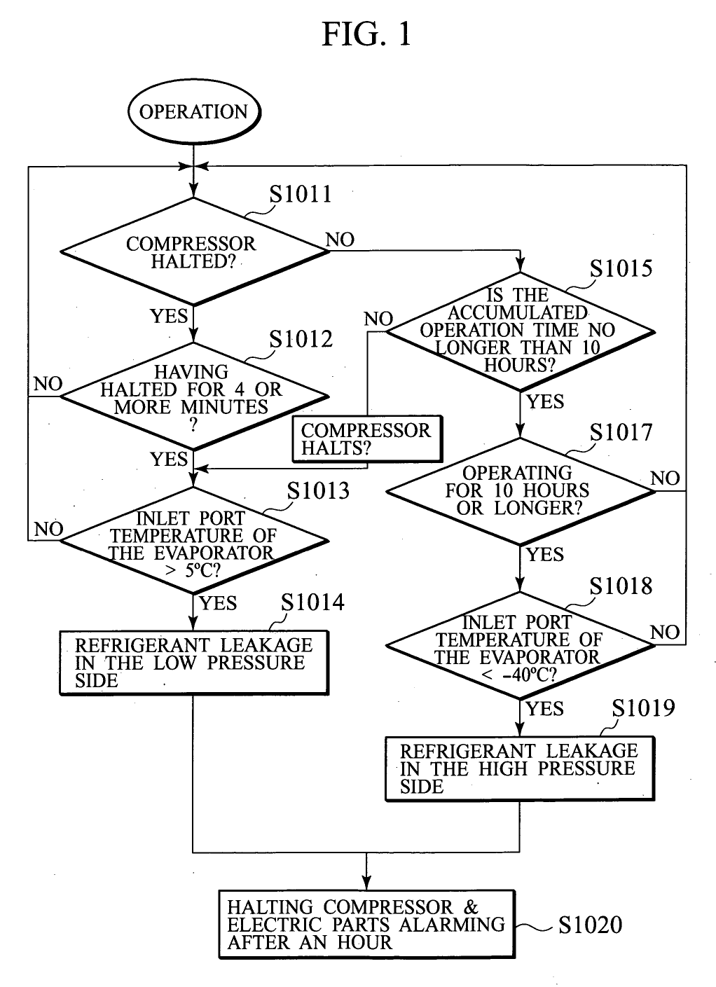

The operation will be explained with reference to FIG. 1 in details. Since the compressor 1011 has to be halted when refrigerant leakage is judged in the low pressure side of the refrigeration cycle, it is judged in advance whether the compressor 1011 is operated or halted (in the step S1011). However, even with the compressor being halted, it is impossible to accurately detect refrigerant leakage just after halting so that it is judged whether or not the compressor has been halted for four or more minutes (in the step S1012).

Next, if the temperature of the inlet port of the evaporator is higher than a maximum level, for example, 5° C., refrigerant leakage is judged to occur in the low pressure side (in the step S1013). When refrigerant leakage is judged to occur in the low pressure side, the judgment result is stored in the microcomputer 1060 and the like (in the step S1014) so that it can be read out later. On the other hand, when the inner temperature of the refrigerator-freezer does not fall down to a predetermined temperature, the compressor 1011 is not halted. Since refrigerant leakage can not be detected in the low pressure side with the compressor 1011 being operated, it is judged whether or not the accumulated operation time of the compressor 1011 reaches to a predetermined time, for example, 10 hours (in the step S1015), and if the accumulated operation time reaches 10 hours, the compressor is halted for 4 minutes or more (in the step S1016) followed by judging refrigerant leakage in the low pressure side (in the step S1013).

Also, when refrigerant leakage is judged in the high pressure side, it is judged in advance whether or not a predetermined time period, for example, 10 minutes elapses after the compressor 1011 starts operating (in the step S1017) since the temperature can not accurately be detected just after starting, followed by proceeding to the next step. Then, it is judged whether or not the temperature of the inlet port of the evaporator 1007 is no higher than a minimum level, for example, −40° C. (in the step S1018). If the temperature is no higher than the minimum level, refrigerant leakage is judged to occur in the high pressure side (in the step S1019).

The temperature of the evaporator at the inlet port can fall down beyond the minimum level even when refrigerant leakage occurs in the low pressure side of the refrigeration cycle. However, in this case, as apparent from FIG. 6 and FIG. 7, the temperature exceeds the maximum level in advance of falling down beyond the minimum level, and therefore it is correct to judge refrigerant leakage to occur in the high pressure side in the case where it is judged in the step S1013 that the temperature falls down beyond the minimum level while it is judged in the step S1018 that the temperature does not exceed the maximum level.

Then, if refrigerant leakage is judged to occur in the low pressure side or in the high pressure side, electric parts including the compressor 1011 and the cooling fan 1008 are halted, and after a predetermined time period elapses a notice such as an alarm or an indication is generated to inform the user of the refrigerant leakage in the step 1020. Alternatively, a valve is provided between the compressor 1011 and the evaporator 1007 in order to be immediately closed just after refrigerant leakage is judged to occur in the low pressure side while the operation of the compressor 1011 is continued for a predetermined time period to collect the refrigerant from the low pressure side.

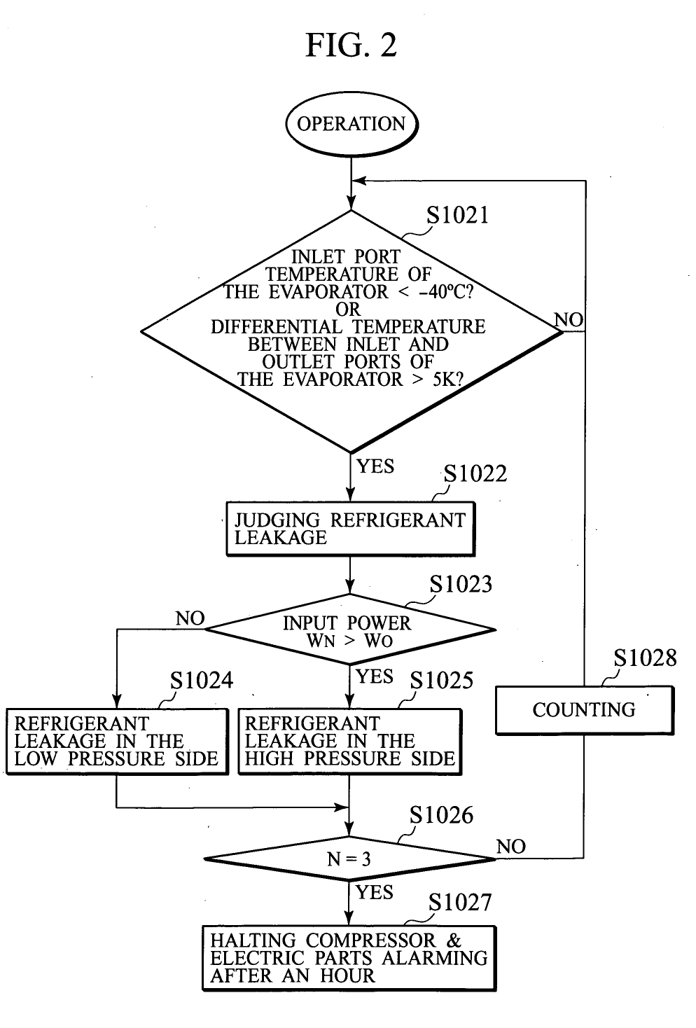

Next, a method of detecting refrigerant leakage with reference to the input power to the compressor 1011 in accordance with the above described embodiment will be explained with reference to FIG. 2. First, during operation of the compressor 1011, it is judged whether or not the output value of the temperature sensor 1016 is no higher than a minimum level, for example, −40° C., or whether or not the differential temperature between the temperature sensor 1016 and the temperature sensor 1016′, i.e., the differential temperature between the inlet port side and the outlet port side of the evaporator 1007 is smaller than 5K (in the step S1021).

By this configuration, refrigerant leakage is safely detected (in the step S1022). If there is detected refrigerant leakage, it is then judged whether or not the current input power W_{O} of the compressor 1011 is smaller than a past input power W_{N} (in the step S1023). Namely, in the case where the current input power W_{O} is smaller, the load on the compressor 1011 decreases so that refrigerant leakage is judged to occur in the high pressure side (in the step S1025). Conversely, in the case where the current input power W_{O} is larger, the load on the compressor 1011 tends to increase so that refrigerant leakage is judged to occur in the low pressure side (in the step S1024).

In order to ensure the reliablity, the procedure as described above is repeated for a predetermined times, for example, for three times. Namely, the number of cycles is counted and stored in the microcomputer 1060 together with the current input power (in the step S1028) until the predetermined times. In the case where the procedure has been repeated for the predetermined times, electric parts including the compressor 1011 and the cooling fan 1008 are halted, and after a predetermined time period elapses a notice such as an alarm or an indication is generated to inform the user of the refrigerant leakage in the step 1027.

Alternatively, a valve is provided between the condenser 1012 and the evaporator 1007 in order to be immediately closed just after refrigerant leakage is judged to occur in the low pressure side while the operation of the compressor 1011 is continued for a predetermined time period to collect the refrigerant from the low pressure side.

Meanwhile, in the case of in the present embodiment, refrigerant leakage is detected mainly with reference to the temperature of the inlet port of the evaporator 1007. However, since there is a significant temperature change in the outlet port side of the evaporator when refrigerant leakage occurs as illustrated in FIG. 6 and FIG. 7, the temperature change can be detected in order to detect refrigerant leakage by detecting the temperature change in the outlet port. Also, while only one evaporator is used in the refrigeration cycle in the present embodiment, it is possible to apply this technique to a refrigerator-freezer in which a freezer compartment and a fresh-food compartment are provide respectively with individual evaporators and the refrigerant flows in turn therethrough and to refrigeration cycles implemented within an air conditioner and the like.

In accordance with the present invention, it is possible to judge which in the high pressure side or in the low pressure side of the refrigeration cycle there occurs refrigerant leakage by detecting the temperature of the inlet port of the evaporator with the compressor being halted or by detecting the variation of the temperature of the inlet or outlet port of the evaporator with the compressor being operated, and therefore possible to implement a refrigerant leakage detection system at a low cost with a high degree of accuracy.

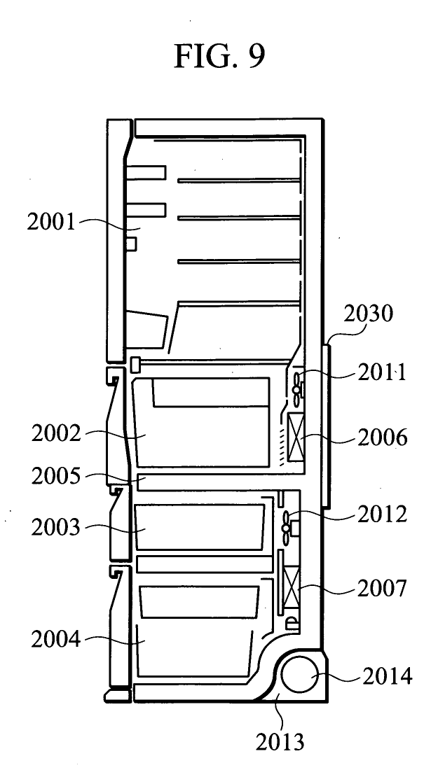

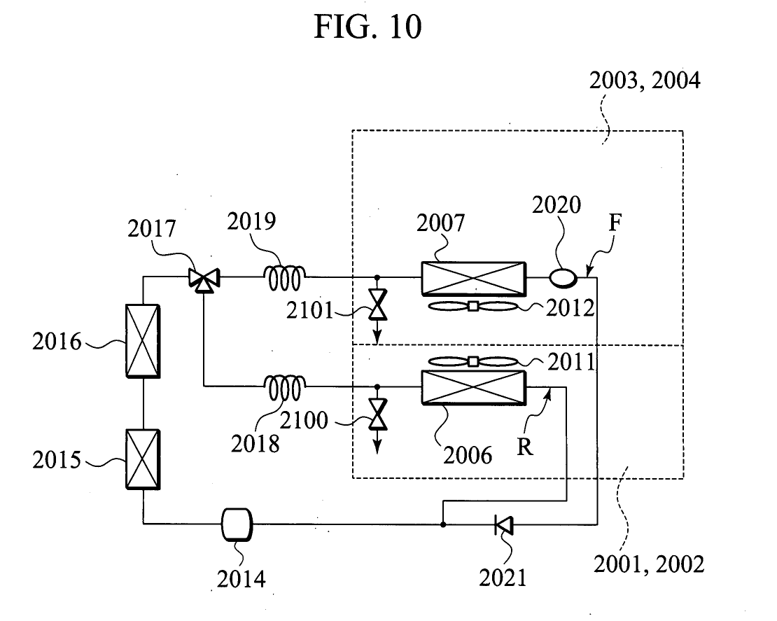

FIG. 9 is a longitudinal cross sectional view showing a refrigerator-freezer in accordance with a second embodiment of the present invention. FIG. 10 is a schematic diagram showing the refrigeration cycle of the refrigerator-freezer.

The refrigerator-freezer in accordance with this embodiment of the present invention is a two-evaporator parallel cycle refrigerator-freezer whose inside is partitioned into a fresh-food compartment 2001, a vegetable compartment 2002, a switchable compartment 2003 and a freezer compartment 2004. Also, a heat insulating wall 2005 is provided between the bottom of the vegetable compartment 2002 and the ceiling of the switchable compartment 2003 in order to partition the inside space of the refrigerator-freezer into two sections in different temperature zones. A fresh-food compartment evaporator 2006 is located in the rear side of the vegetable compartment 2002 while a freezer compartment evaporator 2007 is located in the rear side of the freezer compartment 2004. The cold air of the fresh-food compartment 2001 and the cold air of the freezer compartment 2004 are completely separated from each other and shall not be mixed with each other. Also, while a fresh-food compartment cooling fan 2011 is also provided in the rear side of the vegetable compartment 2002 beside the fresh-food compartment evaporator 2006, a freezer compartment cooling fan 2012 is also provided in the rear side of the freezer compartment 2004 beside the freezer compartment evaporator 2007, Furthermore, a compressor 2014 and a condenser 2015 (not shown in FIG. 9) are located in a machine room 2013 at the rear bottom of the refrigerator-freezer 2013 as illustrated in FIG. 10.

FIG. 10 is a schematic diagram showing the refrigeration cycle of the refrigerator-freezer in accordance with this embodiment of the present invention. In this refrigeration cycle, an HC refrigerant is compressed and drained by means of the compressor 2014 and passed through a condenser 2015 and a clean pipe 2016 followed by switchingly flowing in one of conduits selected by a refrigerant path switch mechanism of a three-way valve 2017 functioning as shunt means for the refrigerant.

One outlet port of the three-way valve 2017 is connected to a fresh-food compartment capillary (an R capillary) 2018 and the fresh-food compartment evaporator (an R evaporator) 2006 in series while the other outlet port of the three-way valve 2017 is connected to a freezer compartment capillary (an F capillary) 2019, the freezer compartment evaporator (an F evaporator) 2007 and an accumulator 2020 in series. The outlet port of the accumulator 2020 is connected in turn to a check valve 2021 inside of the machine room 2013. Furthermore, the outlet port of the check valve 2021 is connected to communicate with the outlet port the R evaporator 2006 and the refrigerant sucking side of the compressor 2014. The symbols 2100 and 2101 in FIG. 10 designate valves for test which are provided for the purpose of adjusting the amount of refrigerant as leaked during a test for refrigerant leakage. These valves are not provided in the final product.

In the case of the refrigerator-freezer of the refrigeration cycle as described above, a controller 2030 is provided to monitor the inner temperatures by means of a temperature sensor located in the fresh-food compartment 2001 and the vegetable compartment 2002 and a temperature sensor located in the switchable compartment 2003 and the freezer compartment 2004 and to take control of the three-way valve 2017 in order that the HC refrigerant is passed through the R evaporator 2006 and the F evaporator 2007 in parallel for the purpose of adjusting the temperatures of the respective compartments.

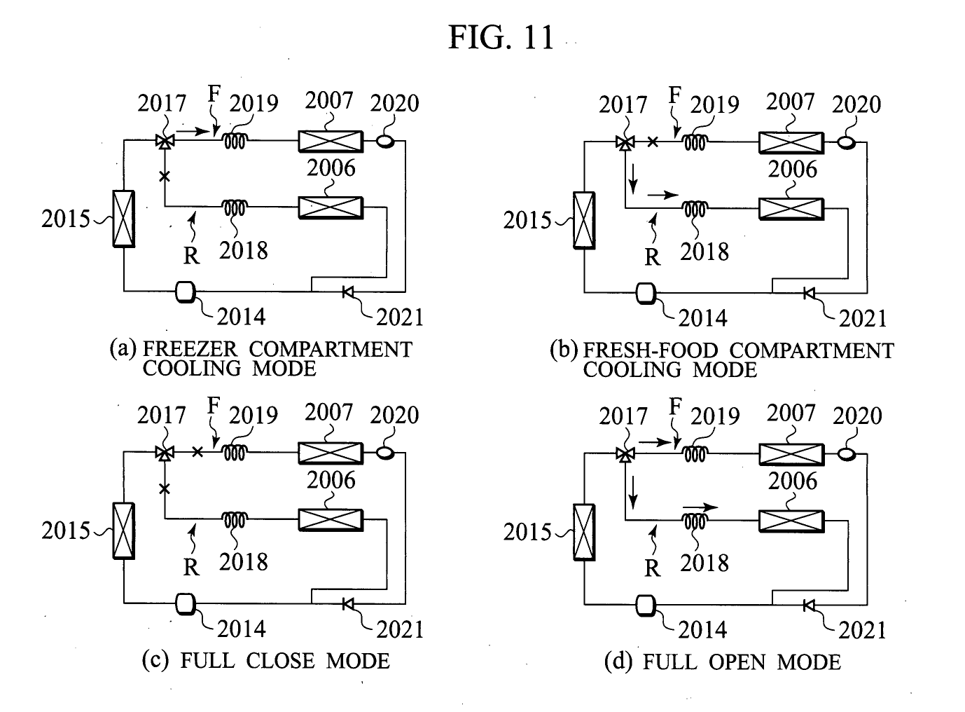

It is possible to switch the conduits of the fresh-food compartment cooling route R and the freezer compartment cooling route F by switching the three-way valve 2017, and also possible to select a full close mode by closing the both routes at the same time and a full open mode by opening the both routes at the same time. That is, there are switchable modes, i.e., a freezer compartment cooling mode as illustrated in FIG. 11(a), a fresh-food compartment cooling mode as illustrated in FIG. 11(b), the full close mode as illustrated in FIG. 11(c) and the full open mode as illustrated in FIG. 11(d). Meanwhile, an individual on/off valve can be provided for each of the fresh-food compartment cooling route R and the freezer compartment cooling route F as the shunt means for the refrigerant in place of the three-dimensional 2018. The respective modes can be switched by opening or closing one of the on/off valves or both of them.

The mechanical control of the compressor 2014, the cooling fans 2011 and 2012, the three-dimensional and so forth can be taken by the controller 2030. The controller 2030 receives signals output from refrigerant temperature sensors, pressure sensors, a compressor rpm sensor located in respective appropriate positions for taking necessary control on the basis of the respective signals. The cooling control operation of the controller 2030 will be explained in the followings.

In the case of the freezer compartment cooling mode as illustrated in FIG. 11(a), the refrigerant enters the F evaporator 2007 after decompression through the F capillary 2019, serving to cooling the freezer compartment 2004, and then returns to the compressor 2014. Namely, the refrigerant flows in the order of the F capillary 2019, the F evaporator 2007, the accumulator 2020 and then the check valve 2021 so that the cold air circulates through the switchable compartment 2003 and the freezer compartment 2004 by the operation of the freezer compartment cooling fan 2012.

On the other hand, when the refrigeration cycle is switched to the fresh-food compartment cooling mode by switching the three-way valve 2017, the refrigerant is decompressed by the R capillary 2018 and transported into the R evaporator 2006 to cool the fresh-food compartment 2001 and the vegetable compartment 2002, and then returns to the compressor 2014. Namely, the refrigerant flows in the order of the R capillary 2018 and then the R evaporator 2006 to cool the fresh-food compartment 2001 and the vegetable compartment 2002 by the operation of the fresh-food compartment fan 2011.

In the fresh-food compartment cooling mode, the pressure of the refrigerant in the fresh-food compartment cooling route R is higher than that in the freezer compartment cooling route F so that the check valve 2021 is closed by pressure δP to keep the refrigerant as cooled in the freezer compartment cooling route F. In this situation, when the refrigeration cycle is switched to the freezer compartment cooling mode, it is possible to immediately cool the freezer compartment by the use of the refrigerant as cooled, and therefore possible to effectively cool the freezer compartment without delay of the refrigerant.

On the other hand, in the freezer compartment cooling mode, the pressure and the temperature in the F evaporator 2007 are about 0.1 MPa and −26° C. respectively while the temperature of the R evaporator 2006 is about 0° C. to 2° C. but the pressure thereof is about 0.1 MPa like in the F evaporator 2007. Accordingly, the pressure in the R evaporator 2006 is saturated in the freezer compartment cooling mode, and therefore the refrigerant is evaporated and becomes dried up. Because of this, when the three-way valve 2017 is switched again in this situation from the freezer compartment cooling mode directly to the fresh-food compartment cooling mode, the circulation of the refrigerant is delayed so that it takes several minutes for the refrigerant transported to the fresh-food compartment cooling route R through the three-way valve 2017 to reach the outlet port of the fresh-food compartment cooling route R through the R evaporator 2006. At this time, the refrigerant is delayed corresponding to the differential temperature äT between the inlet port side and the outlet port side of the R evaporator 2006. The R evaporator 2010 can not be effectively used in this situation. With this situation in mind, for the purpose of secure an amount of the refrigerant as cooled in the fresh-food compartment cooling route R even just after switching to the fresh-food compartment cooling mode, the three-way valve 2017 is switched to the full open mode as illustrated in FIG. 11(d) for a predetermined time period ö (for example, 1 to 5 minutes) in advance of switching to the freezer compartment cooling mode in order to maintain a certain amount of the refrigerant as cooled in the fresh-food compartment cooling route R.

Namely, the controller 2030 serves to control the entirety of the refrigerator-freezer so that the respective locations are respectively at appropriate temperatures by repeating the cooling cycle of freezer compartment cooling in the freezer compartment cooling mode→simultaneous cooling in the full open mode→fresh-food compartment cooling in the fresh-food compartment cooling mode→freezer compartment cooling in the freezer compartment cooling mode.

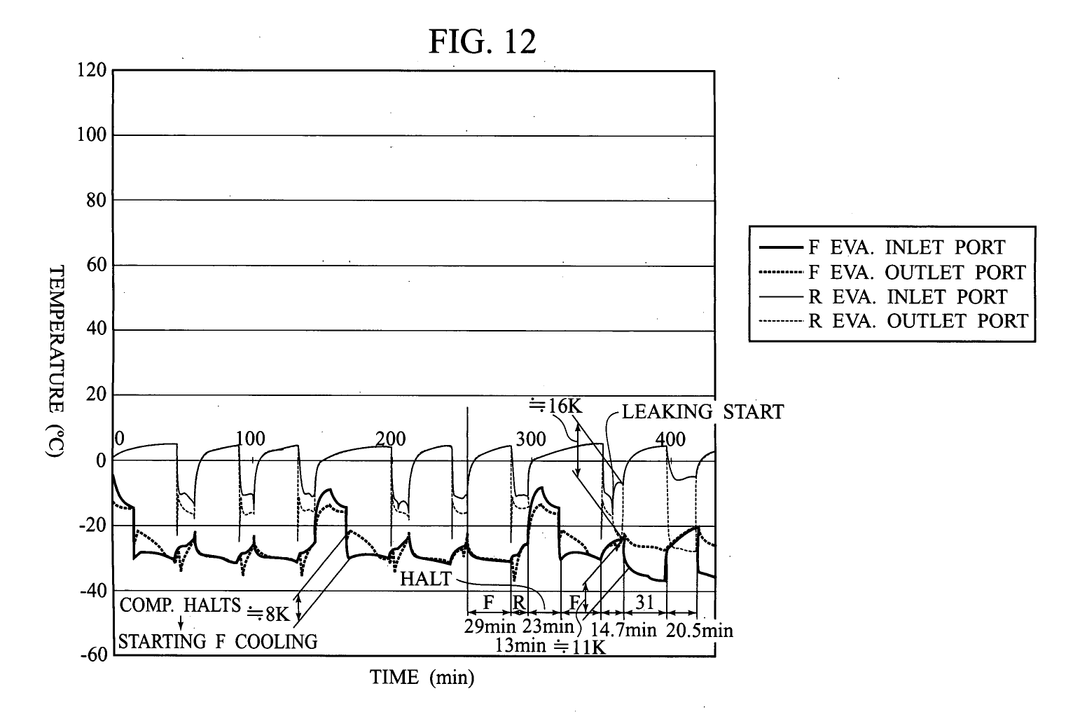

Table 1 to Table 3 show the results of measuring the temperatures of the conduit in the inlet and outlet port sides for each of the R evaporator 2006 and the F evaporator 2007, when the refrigerant has leaked, by the use of the test valves 2100 and 2101 as illustrated in FIG. 10 and the results of measuring the concentration of the refrigerant in the refrigerator-freezer as described above after opening the test valves 2100 and 2101. Also, FIG. 12 to FIG. 14 are graphic diagrams in which are plotted to show the variation thereof in time.

TABLE 1
Normal Operation (room temp. = 25° C.; Door Closed)

| | Operation Mode | | | | |
|---|---|---|---|---|---|
| | | | | | F Cooling Just |
| | F Cooling | Pump Down | R Cooling | Comp. Halted | After Halting Comp. |
| Time | about 29 min | about 1 min | about 13 min | about 23 min | without delay |
| R Outlet Port | — | 5 | −10 | — | — |
| Temp. (With Max. | | | | | |
| R Diff. Temp.) | | | | | |
| R Inlet Port | — | −25 | −15 | — | — |
| Temp. (With Max. | | | | | |
| R Diff. Temp.) | | | | | |
| R Diff. Temp.(K) | 0 | 30 | 5 | 0 | 0 |
| F Outlet Port | — | −37 | — | −9 | −22 |
| Temp. (With Max. | | | | | |
| R Diff. Temp.) | | | | | |
| F Inlet Port | — | −29 | — | −14 | −29 |
| Temp. (With Max. | | | | | |
| R Diff. Temp.) | | | | | |
| F Diff. Temp.(K) | 0 | 8 | 0 | 5 | 7 |
| | | | (After About 7 min) | | |

TABLE 2

| Operation Mode | | | | | | |
|---|---|---|---|---|---|---|
| F | Pump | | | R | | |
| Cooling | Down | R Cooling | F Cooling | Cooling | F Cooling | R Cooling |

R Evaporator Leaking: φ0.1 mm (2 g/min)

| | | | | | |
|---|---|---|---|---|---|
| Leaking | Leaking | No | Leaking | Stopping | Leaking |
| Condition | After about | Leaking | (max50%) | Leaking | (max50%) |
| | 5 min | | | (max50%) | |
| Time | | about 14.7 min | about 31 min | about 21 min | about 31 min |
| R Outlet Port | −7 | — | −6 | 0 | — |
| Temp. (With | | | | | |
| Max. R Diff. | | | | | |
| Temp.) | | | | | |
| R Inlet Port | 16 | 0 | 21 | 3 | — |
| Temp. (With | | | | | |
| Max. R Diff. | | | | | |
| Temp.) | | | | | |
| R Diff. | 16 | 0 | 21 | 3 | — |
| Temp.(K) | | | | | |
| F Outlet Port | −24 | −27 | — | 22 | −23 |
| Temp. (With | | | | | |
| Max. R Diff. | | | | | |
| Temp.) | | | | | |
| F Inlet Port | −26 | −37 | −29 | −26 | — |
| Temp. (With | | | | | |
| Max. R Diff. | | | | | |
| Temp.) | | | | | |
| F Diff. | 2 | 10 | 7 | 13 | |
| Temp.(K) | | | | | |

F Evaporator Leaking: φ0.1 mm (2 g/min)

| | | | | | | | |
|---|---|---|---|---|---|---|---|
| Leaking | Leaking | No | No | No | Leaking | Stopping | Leaking |
| Condition | After about | Leaking | Leaking | Leaking | (max50%) | Leaking | (max50%) |
| | 23 min | | | | | (max50%) | |
| Time | about 30 min | about 1 min | about 16 min | about 30 min | about 16 min | about 30 min | about 6 min |
| R Outlet | — | 6 | −7 | — | −7 | 0 | |
| Port Temp. | | | | | | | |
| (With Max. | | | | | | | |
| R Diff. | | | | | | | |
| Temp.) | | | | | | | |
| R Inlet | — | −26 | −23 | — | −27 | −3 | |
| Port Temp. | | | | | | | |
| (With Max. | | | | | | | |
| R Diff. | | | | | | | |
| Temp.) | | | | | | | |
| R Diff. | 0 | 32 | 16 | 0 | 20 | 3 | |
| Temp.(K) | | | | | | | |
| F Outlet | −25 | −29 | −24 | −27 | — | 28 | |
| Port Temp. | | | | | | | |
| (With Max. | | | | | | | |
| R Diff. | | | | | | | |
| Temp.) | | | | | | | |
| F Inlet | −35 | −35 | −23 | −37 | — | −38 | |
| Port Temp. | | | | | | | |
| (With Max. | | | | | | | |
| R Diff. | | | | | | | |
| Temp.) | | | | | | | |
| F Diff. | 6 | 6 | 1 | 10 | 0 | 10 | |
| Temp.(K) | | | | | | | |

<Normal Operation>

The temperature characteristics of the respective modes during a normal operation are as follows.
In the freezer compartment cooling mode (F cooling mode), there is little differential temperature between the inlet port and the outlet port of each of the R evaporator 2006 and the F evaporator 2007.
In an pump down operation (refrigerant collection from the F evaporator 2007) before switching to the fresh-food freezer compartment cooling mode (R cooling mode), the temperature of the outlet port of the F evaporator 2007 quickly falls down to increase the differential temperature to about 8K. The temperature of the inlet port of the R evaporator 2006 also quickly falls down resulting in a differential temperature of about 30K.
In the R cooling mode, the differential temperature between the inlet and outlet port of the R evaporator 2006 is about 5K at every time. In the F evaporator 2007, the differential temperature having increased in the pump down operation decreases to zero after 7 minutes elapses.
With the compressor 2014 being halted, there is little differential temperature between the inlet port and the outlet port of the R evaporator 2006. In the F evaporator 2007, while the temperature of the inlet port somewhat rises, the differential temperature increases to about 5K.

When the compressor is halted, the temperature of the inlet port of the F evaporator 2007 falls down first just after the F cooling mode starts so that the differential temperature between the inlet port and the outlet port becomes about 7K. However, the differential temperature disappears about 20 minutes after the F cooling mode starts.

<Refrigerant Leakage Test I>

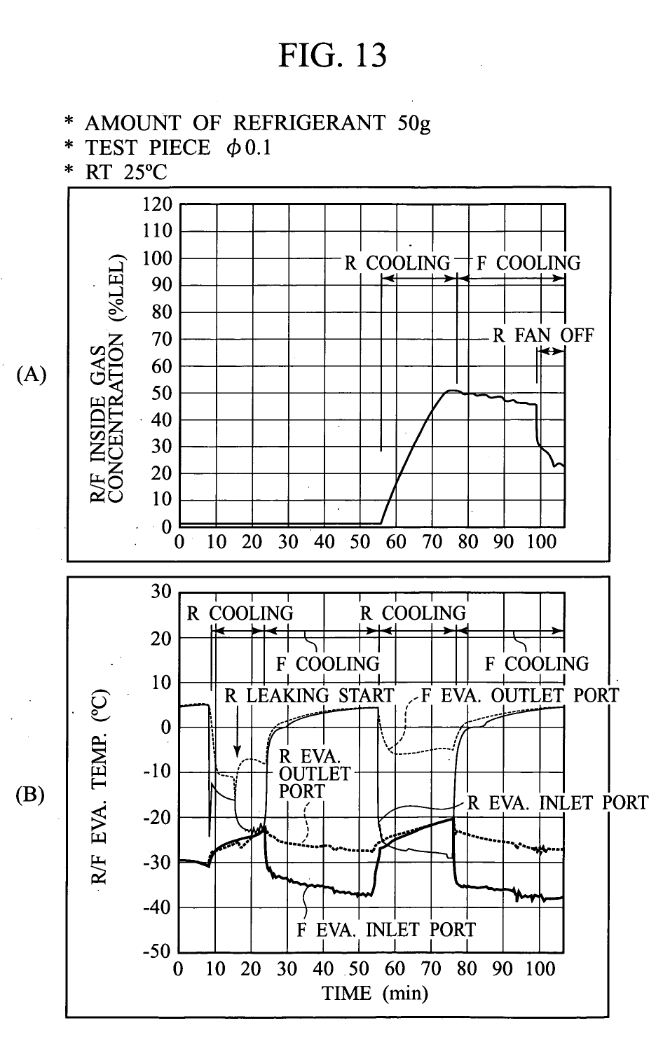

While the test valve 2100 located on the conduit of the inlet port the R evaporator 2006 as illustrated in FIG. 10 is opened to an extent equivalent to a pinhole of ö0.1 mm diameter, the concentration of the refrigerant is measured by a refrigerant leakage detecting sensor which is located in the vicinity of the R evaporator 2006. Also, the refrigerant temperatures are measured by the temperature sensors located in the inlet port side and the outlet port side of the conduit R and the conduit F connected to the R evaporator 2006 and the F evaporator 2007. The data as measured of the concentration and the temperature of the refrigerant is as shown in Table 1 and Table 2. Also, the variations thereof as a function of time are illustrated in FIG. 12 and FIG. 13.
The refrigerant leakage test of the R evaporator 2006 was started about 5 minutes after the R cooling operation was started.
In synchronism with starting of the refrigerant leakage test, the temperature of the outlet port of the R evaporator 2006 was quickly elevated resulting in the differential temperature of about 16 K between the outlet port and the inlet port of the R evaporator 2006. This is because, when the pinhole of 0.1 mm diameter was opened through the conduit, the opening size was very small so that at the beginning the conduit was under a negative pressure to suck the external air into the conduit.
In the side of the F evaporator 2007, there is no significant change, while the temperature of the outlet port was slightly lowered just after the refrigerant leakage test was started resulting in the differential temperature of about 2 K between the outlet port and the inlet port of the F evaporator 2007.
At this time, as illustrated in FIG. 13(A), there was no actual refrigerant leakage.
Next, when the cycle is switched to the F cooling mode, while there was little differential temperature between the outlet port and the inlet port of the R evaporator 2006, the differential temperature between the inlet port and the outlet port of the F evaporator increased to about 10 K due to the abnormal occurrence that the temperature of the outlet port was elevated for the entirety of the mode (about 30 minutes) while the temperature of the inlet port was lowered (the under-charge effect due to the external air flowing into the F evaporator). Also, at this time, there was no actual refrigerant leakage.
In the second F cooling mode after the test was started, the temperature of the outlet port of the R evaporator was elevated for the entirety of the mode (about 21 minutes) while the temperature of the inlet port thereof was lowered (the under-charge effect), and therefore resulting in a differential temperature of about 21 K. At this time, there was detected actual refrigerant leakage resulting in a maximum of 50% (LEL) in the concentration. Here, the concentration % (LEL) is the percentage of the concentration to the lower explosion limit (LEL)=1.8% (V/V). Accordingly, 50% (LEL) is corresponding to real 0.9% (V/V).
The temperature change in the second cycle of the F cooling mode was in the same manner as in the first cycle of the F cooling mode.
Not shown in the figure, since a large amount of the external air flowing into the refrigeration cycle just after the third R cooling operation was started, the electric current level supplied to the compressor was elevated to invoke an abnormal current control mechanism, to halt the compressor and to increase the pressure, and therefore the concentration of the refrigerant as leaked exceeded 100% (LEL).

From the change in the temperature and the leakeage patterns of the refrigerant as described above, it will be understood that the refrigerant does not leak from the vicinity of the R evaporator 2006 to the vegetable compartment 2002 and the fresh-food compartment just after generation of a small opening (a pinhole) in the R evaporator. By detecting the transition of the refrigerant temperature in the conduit in this early period as different from that in the normal operation, it is therefore possible to find the opening in a conduit in advance of actual refrigerant leakage for safely preventing refrigerant leakage.

When there is formed an opening in a conduit in the inlet port side of the R evaporator 2006 during the R cooling operation, as illustrated in FIG. 12 and FIG. 13, the temperature of the inlet port of the R evaporator falls down by about 5 to 10 as compared with a normal temperature just after formation of the opening so that the differential temperature between the inlet port and the outlet port of the R evaporator increases to no lower than about 10° C. from a normal value (about 5° C.). In addition to this, it will be understood that the abnormal temperature transition and the abnormal differential temperature transition continue thereafter.

<Refrigerant Leakage Test II>

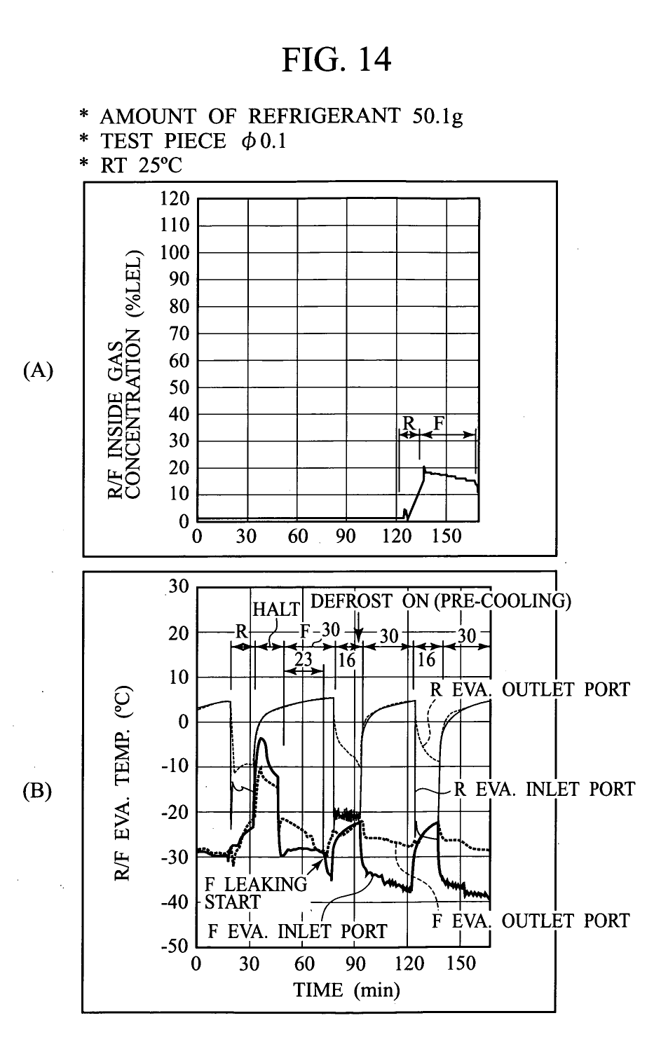

In the conduit system as illustrated in FIG. 11, the concentration of the refrigerant was measured by a refrigerant leakage detecting sensor located in the vicinity of the F evaporator 2007 after opening the test valve 2101 located on the conduit in the inlet port side of the F evaporator 2007 to an extent equivalent to a pinhole of ö0.1 mm diameter, while the refrigerant temperature was measured by means of the temperature sensors located in the inlet port side and the outlet port side of the conduit R and the conduit F connected to the R evaporator 2006 and the F evaporator 2007. The data as measured of the concentration and the temperature of the refrigerant is as shown in Table 1 and Table 3. Also, the variations as a function of time are illustrated in FIG. 12 and FIG. 14.
The refrigerant leakage test of the F cooling system was started about 23 minutes after the F cooling operation was started by opening the refrigerant leakage test valve 2101 for the F cooling system to an extent equivalent to a pinhole of ö0.1 mm diameter.
Just after opening the test valve 2101, the temperature of the inlet port of the F evaporator 2007 started falling down resulting in a maximum of 10 K in the differential temperature between the inlet port and the outlet port. At this time, as understood from the upper graphic diagram of FIG. 14, there was no actual refrigerant leakage.
In the first cycle of the R cooling mode, the differential temperature between the inlet port and the outlet port of the R evaporator 2006 increased to about 16 K due to the abnormal occurrence that the temperature of the outlet port was elevated for the entirety of the mode (about 16 minutes) while the temperature of the inlet port was lowered (the under-charge effect). At this time, there was no actual refrigerant leakage yet.
The temperature change in the second cycle of the F cooling mode was in the same manner as in the first cycle of the R cooling mode, resulting in a differential temperature of about 10 K between the inlet port and the outlet port of the F evaporator 2007* At this time, there was no actual refrigerant leakage yet.
In the second cycle of the R cooling mode, the refrigerant started leaking through the test valve 2101 of the F evaporator 2007 into the switchable compartment 2003 and the freezer compartment 2004 resulting in a concentration of the refrigerant of about 20% (LEL).
Meanwhile, although not shown in the figure, the concentration of the refrigerant reached 100% (LEL) when the compressor 2014 was halted just before the third cycle of the R cooling mode in the same manner as in the refrigerant leakage test I.

As described above, when there is formed an opening in the conduit F of the F evaporator 2007 during the F cooling operation, as illustrated in FIG. 12 and FIG. 14, the temperature of the inlet port of the F evaporator falls down by about 5 to 10° C. as compared with a normal temperature just after formation of the opening so that the differential temperature between the inlet port and the outlet port of the F evaporator increases to no lower than about 10° C. from a normal value (about 5° C.). In addition to this, it will be understood that the abnormal temperature transition and the abnormal differential temperature transition continue thereafter.

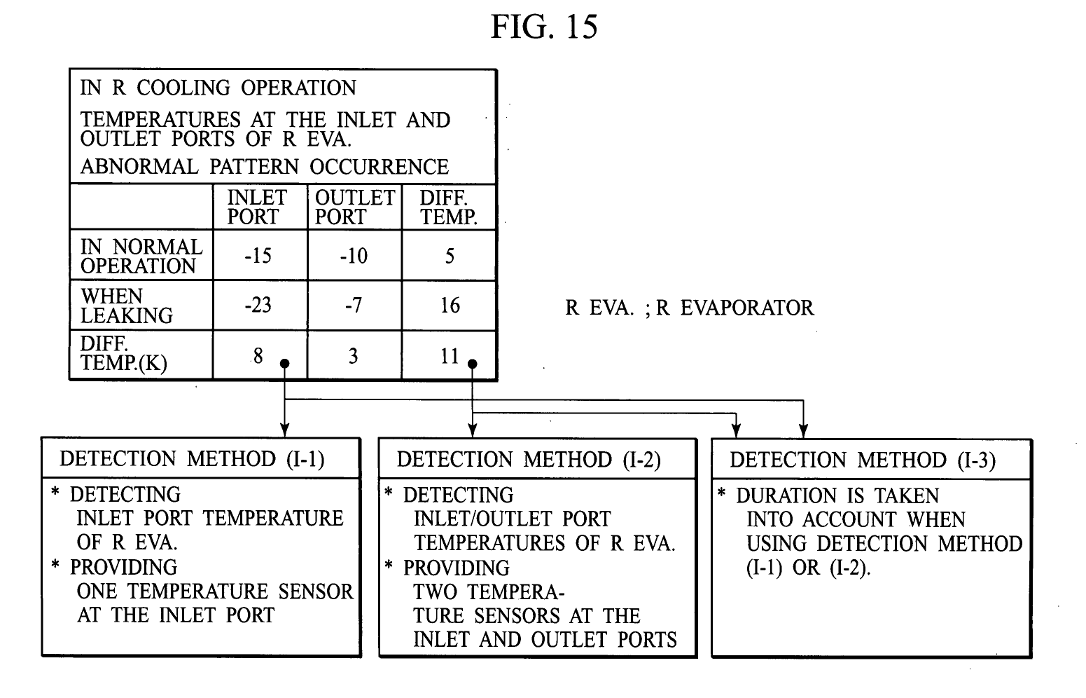

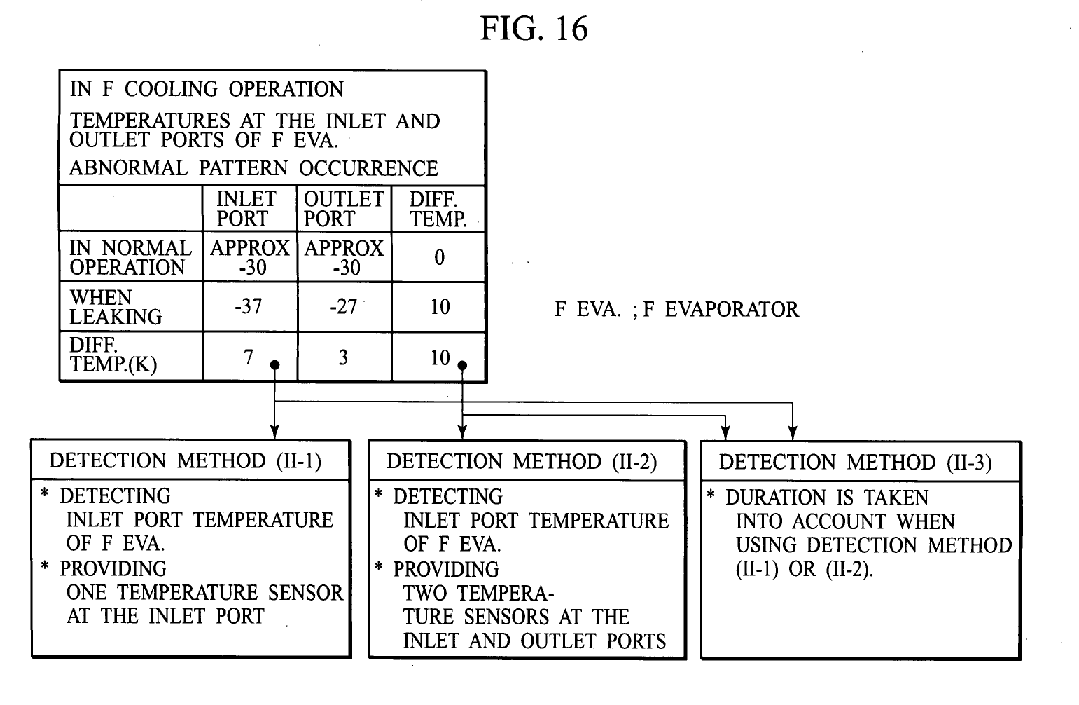

It is therefore possible to find the opening in a conduit, which would cause refrigerant leakage, in advance of actual refrigerant leakage on the basis of the following criteria of judgment as illustrated in FIG. 15 and FIG. 16.

(I-1) While monitoring the temperature of the inlet port of the R evaporator 2006, refrigerant leakage is judged to occur when an abnormal value is detected which is different from a normal value by no smaller than a predetermined value.

(I-2) While monitoring the temperatures of the outlet port and the inlet port of the R evaporator 2006, refrigerant leakage is judged to occur when the differential temperature therebetween is different from a normal value.

(I-3) the judgment of (I-1) and (I-2) is made taking into consideration timely information.

(II-1) While monitoring the temperature of the inlet port of the F evaporator 2007, refrigerant leakage is judged to occur when an abnormal value is detected which is different from a normal value by no smaller than a predetermined value.

(II-2) While monitoring the temperatures of the outlet port and the inlet port of the F evaporator 2007, refrigerant leakage is judged to occur when the differential temperature therebetween is different from a normal value.

(II-3) the judgment of (II-1) and (II-2) is made taking into consideration timely information.

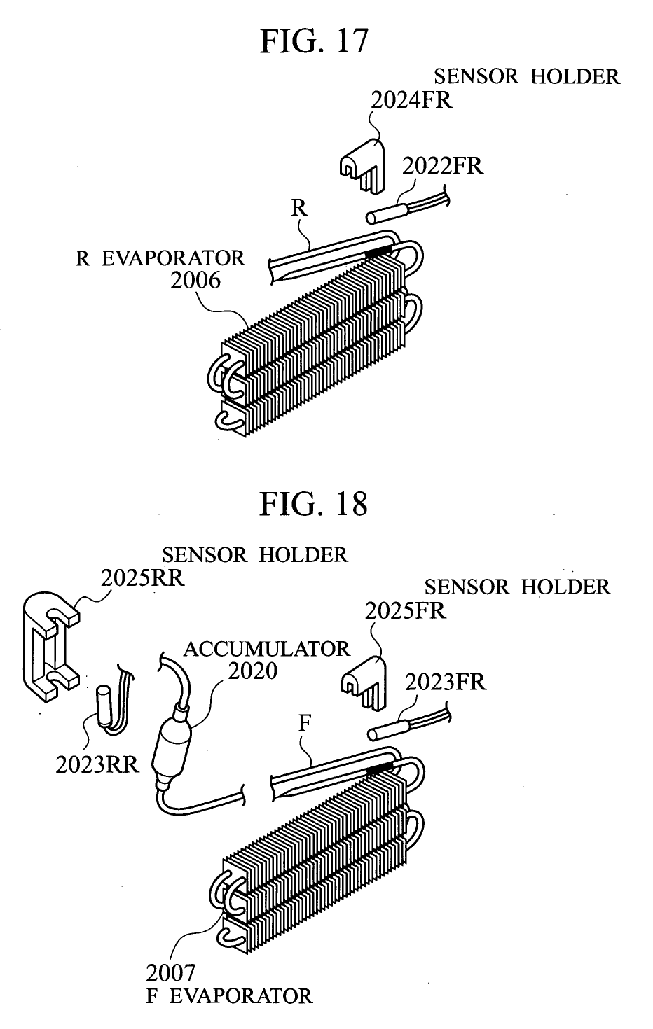

With the foregoing results and consideration in mind, as illustrated in FIG. 17 and FIG. 18, the refrigerator-freezer is provided with a function to judge refrigerant leakage by the controller 2030 serving to monitor the output signals of the temperature sensors 2022FR and 2023FR fixed to the fresh-food compartment conduit R and the freezer compartment conduit F by means of sensor holders 2024FR and 2025FR in the inlet port sides of the R evaporator 2006 and the F evaporator 2007 respectively in accordance with an embodiment of the present invention, or serving to monitor the output signals of the temperature sensors 2022FR and 2022RR (same as 2022FR) and the temperature sensors 2023FR and 2023RR fixed to the fresh-food compartment conduit R and the freezer compartment conduit F by means of sensor holders 2024FR and 2025RR (same as 2025FR) and sensor holders 2025FR and 2025RR in both the inlet port sides and the outlet port sides of the R evaporator 2006 and the F evaporator 2007 respectively in accordance with another embodiment of the present invention,

<First Exemplary Implementation>

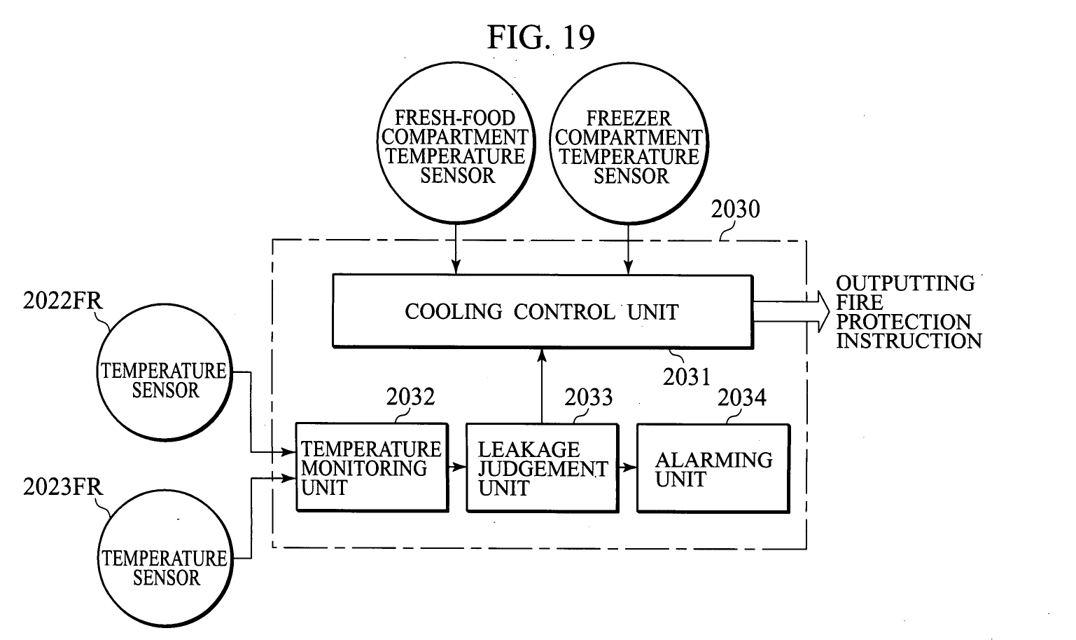

FIG. 19 is a block diagram showing the functions of the controller 2030 as associated with each other in accordance with a first exemplary implementation of the refrigerator-freezer of the second embodiment of the present invention will be explained. The controller 2030 is composed of a temperature monitoring unit 2032 for monitoring refrigerant leakage, a leakage judgment unit 2033 and an alarming unit 2034 in addition to a cooling control unit 2031 for taking control of refrigerating and freezing operation as described above.

For the purpose of monitoring the refrigerant leakage test in accordance with this embodiment of the present invention, the temperature sensor 2022FR is located on the fresh-food compartment conduit R in the inlet port side of the R evaporator 2006 while the temperature sensor 2023FR is located on the freezer compartment conduit F in the inlet port side of the F evaporator 2007.

The temperature monitoring unit 2032 serves to cyclicly receive the temperature detection signal at a predetermined frequency from the temperature sensor 2022FR in the inlet port side of the R evaporator and the temperature sensor 2023FR in the inlet port side of the F evaporator, to store the signals in the form of sequential data, to cyclicly calculate the temperatures averaged for a predetermined period for each operation mode and to store the averaged data.

The leakage judgment unit 2033 serves to judge refrigerant leakage (exactly speaking, to judge the formation of an opening in the actual case whereas the judgment of formation of an opening is referred to as the judgment of leakage in this description) by comparing the current data output from the temperature monitoring unit 2032 with the previous averaged temperature. When refrigerant leakage is judged to occur, the leakage judgment unit 2033 outputs the result to the alarming unit 2034 and also to the cooling control unit 2031.

The alarming unit 2034 is provided with a buzzer or a buzzer and an alarm lamp in order to output warning by buzzing or buzzing and turning on the alarm lamp when the leakage judgment unit 2033 generates a signal indicative of the judgment of refrigerant leakage to occur.

When the leakage judgment unit 2033 judges refrigerant leakage to occur, the cooling control unit 2031 serves to close the three-way valve 2017 and drive the compressor 2014 in order to collect the refrigerant in the conduits R and F in the high pressure side and to confine the refrigerant between the three-way valve 2017 and the valve of the compressor 2014, and also serves to inhibit the operation of electric elements which would cause a fire by halting the optical plasma disinfection mechanism, the ice cuber, the defrosting heater and so forth and turning off the electric power source circuits of the door switch, the inner lamps and the like.

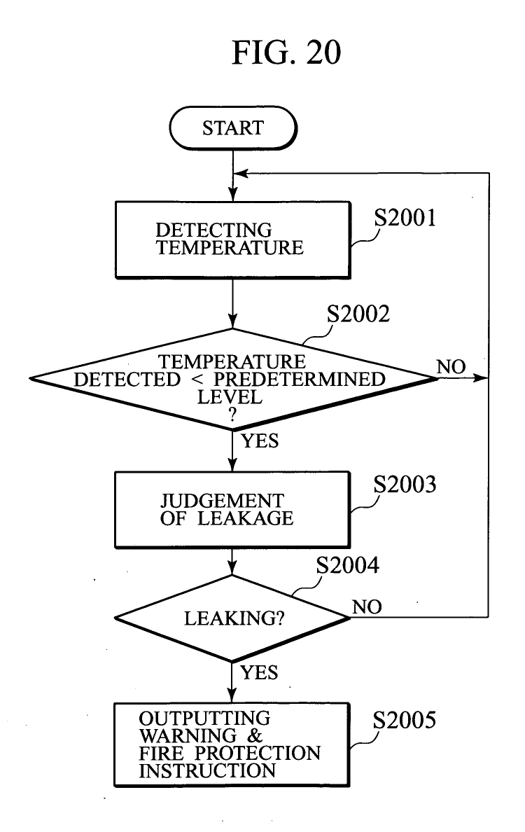

Next, the operation of the controller 2030 for judging refrigerant leakage will be explained with reference to the flowchart as illustrated in FIG. 20. In the case of the refrigerator-freezer as illustrated in FIG. 9, refrigerant leakage has to be monitored for both the R cooling system and the F cooling system. For this purpose, the temperature sensor 2022FR is located on the conduit in the inlet port side of the R evaporator 2006, while the temperature sensor 2023FR is located on the conduit in the inlet port side of the F evaporator 2007, in order to monitor the temporary change by means of the temperature monitoring unit 2032 which receives the temperature signals from these temperature sensors. Then, the leakage judgment unit 2033 serves to judge whether or not refrigerant leakage occurs (in the steps S2001 to S2003) on the basis of the temperature in the inlet port side of the R evaporator 2006 and the temperature in the inlet port side of the F evaporator 2007 as obtained by the temperature monitoring unit 2032.
In the case where the temperature of the inlet port of the R evaporator 2006 is used for the judgment, refrigerant leakage is judged to occur in the R cooling mode when the temperature is lowered by 7° C. or more relative to the average temperature in the previous cycle of the same mode operation.
Also, in the case where the temperature of the inlet port of the F evaporator 2007 is used for the judgment, refrigerant leakage is judged to occur in the F cooling mode when the temperature is lowered by 7° C. or more relative to the average temperature in the previous cycle of the same mode operation.

When the leakage judgment unit 2033 judges “refrigerant leaking”, the leakage judgment unit 2033 outputs a warning instruction to the alarming unit 2034 and a fire protectsion instruction to the cooling control unit 2031 (in the steps S2004 and S2005).

By this configuration, in the case of in this embodiment of the present invention, it is possible to detect an opening and take control required for avoiding refrigerant leakage in advance of actual leakage, i.e., while the external air is sucked into the conduit causing the under-charge effect with a pinhole generated on the refrigerant conduit. Furthermore, there are advantages of cost reduction since the leakage judgment is made by the use of the temperature sensors 2022FR and 2023FR which are located on the refrigerant conduits the inlet port sides of the R evaporator 2006 and the F evaporator 2007 respectively.

<Second Exemplary Implementation>

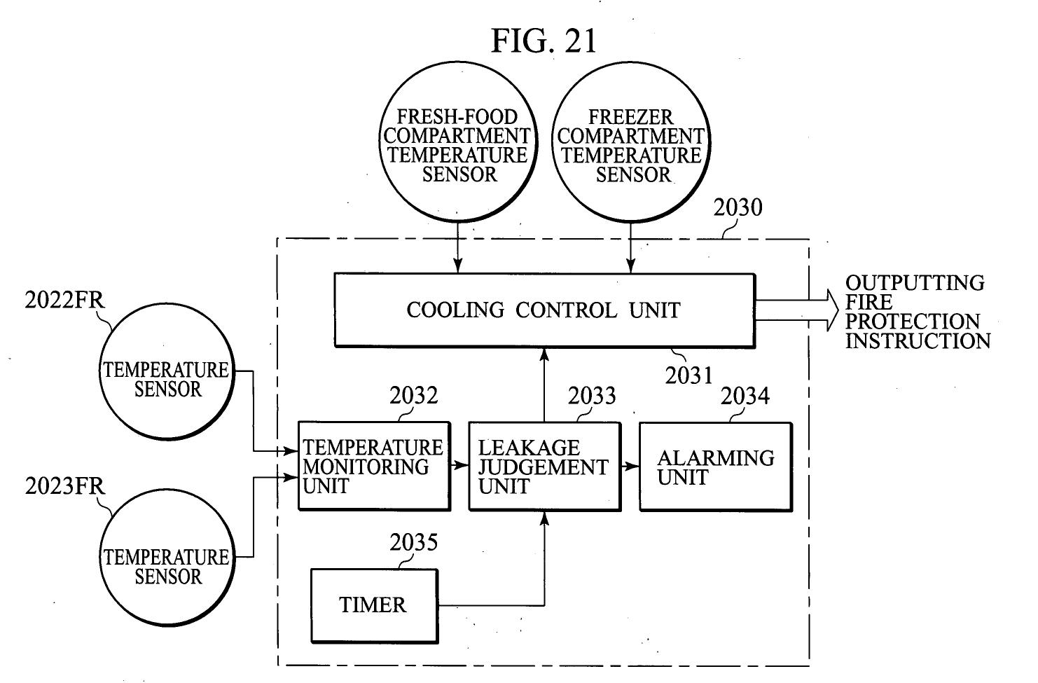

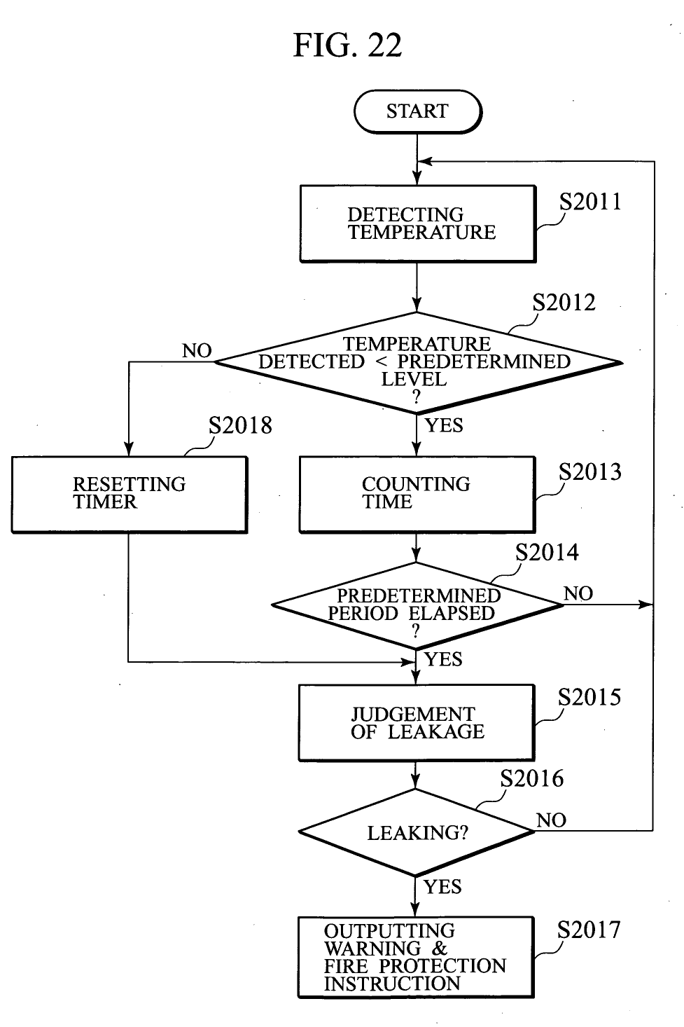

In the followings, a second exemplary implementation of the refrigerator-freezer with reference to FIG. 21 and FIG. 22 in accordance with the second embodiment of the present invention will be explained. The second exemplary implementation is characterized in that the controller 2030 serves to perform leakage judgment taking into consideration timely information, when the judgment is made in accordance with the first exemplary implementation, in order to furthermore improve the reliability of the leakage judgment.

Namely, the temperature monitoring unit 2032 obtains curent temperature data by receiving the temperature signals of the temperature sensors 2022FR and 2023FR located on the conduit R and the conduit F of the R evaporator 2006 and the F evaporator 2007 in the inlet port sides thereof respectively, in order to calculate and save the average temperatures in each cycle of the R cooling mode and each cycle of the F cooling mode (in the step S2011). When the refrigerant temperature in the inlet port side of the R evaporator 2006 in the R cooling mode is lowered by 5° C. or more relative to the average temperature in the previous cycle, the leakage judgment unit 2033 serves to measure the period of time during which the low temperature condition continues by starting a timer 2035 (in the steps S2012 to S2014). If the temperature in the inlet port side is continuously lower than a normal temperature by 5° C. or more for 20 or more minutes, the leakage judgment unit 2033 judges refrigerant leakage to occur (in the step S2015).

Also, when the refrigerant temperature in the inlet port side of the F evaporator 2007 in the F cooling mode is lowered by 5° C. or more relative to the average temperature in the previous cycle, the leakage judgment unit 2033 serves to measure the period of time during which the low temperature condition continues by starting the timer 2035 (in the steps S2012 to S2014). If the temperature in the inlet port side is continuously lower than a normal temperature by 5° C. or more for 20 or more minutes, the leakage judgment unit 2033 judges refrigerant leakage to occur (in the step S2015).

When the leakage judgment unit 2033 judges “refrigerant leaking”, the leakage judgment unit 2033 outputs a warning instruction to the alarming unit 2034 and a fire protection instruction to the cooling control unit 2031 (in the step S2017) in the same manner as in the first exemplary implementation.

Meanwhile, even after it is judged that the current refrigerant temperature is lowered by 5° C. or more relative to the average temperature in the step S2012 and thereby the timer 2035 is started, the temperature monitoring is initiated again (in the step S2018) by resetting the timer if the current temperature becomes higher than the average temperature minus 5° C. before a predetermined period of time elapses.

By this configuration, in accordance with the second exemplary implementation, in addition to the advantages of the first exemplary implementation, it is possible to furthermore improve the reliability of the leakage judgment by taking into consideration timely information.

<Third Exemplary Implementation>

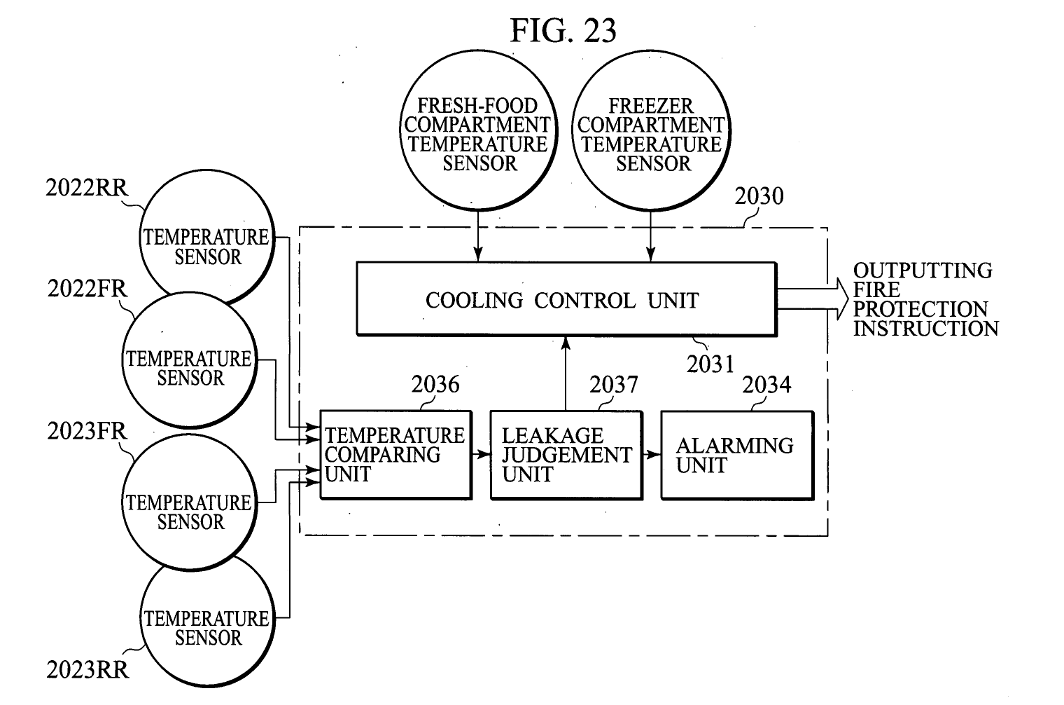

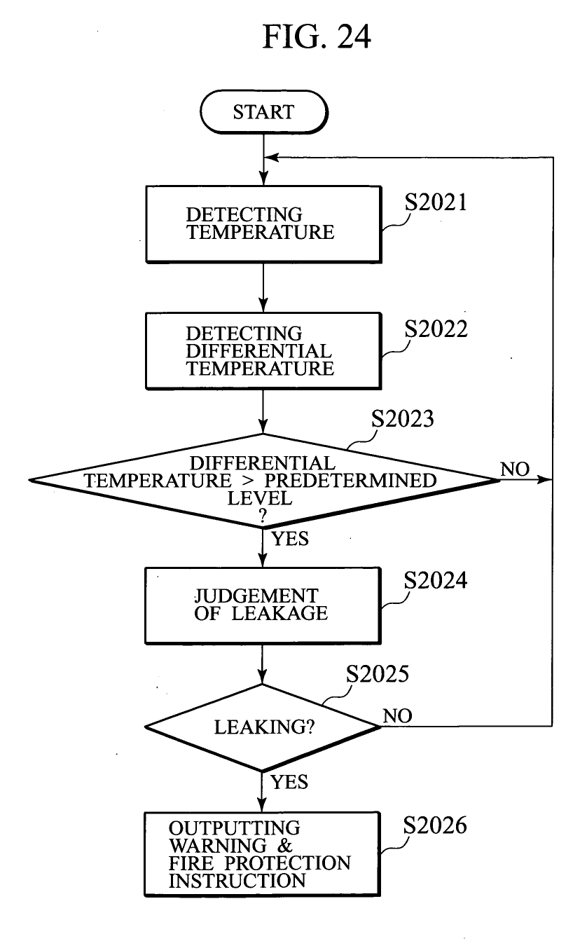

In the followings, a third exemplary implementation of the refrigerator-freezer with reference to FIG. 23 and FIG. 24 in accordance with the second embodiment of the present invention will be explained. The third exemplary implementation is characterized in that the controller 2030 serves to monitor the differential temperature between the inlet port and the outlet port of each of the R evaporator 2006 and the F evaporator 2007 in order to judge refrigerant leakage.

Namely, the controller 2030 is composed of a temperature comparing unit 2036 for detecting the differential temperature between the inlet port and the outlet port, a leakage judgment unit 2037 and an alarming unit 2034 which is equivalent to that of the first exemplary implementation in addition to a cooling control unit 2031 for taking control of refrigerating and freezing as described above.

The temperature sensor 2022FR in accordance with this exemplary implementation is located on the fresh-food compartment conduit R in the inlet port side of the R evaporator 2006 while the temperature sensor 2022RR is located in the outlet port side. Also, the temperature sensor 2023FR is located on the freezer compartment conduit F in the inlet port side of the F evaporator 2007 while the temperature sensor 2023RR is located in the outlet port side.

The temperature comparing unit 2036 serves to cyclicly receive the temperature detection signal at a predetermined frequency from the temperature sensor 2022FR in the inlet port side of the R evaporator and the temperature sensor 2022RR in the outlet port side of the R evaporator and to obtain the differential temperature therebetween, and serves to cyclicly receive the temperature detection signal at a predetermined frequency from the temperature sensor 2023FR in the inlet port side of the F evaporator and the temperature sensor 2023RR in the outlet port side of the F evaporator and to obtain the differential temperature therebetween.

The leakage judgment unit 2037 serves to compare a predetermined value with the differential temperature between the inlet port and the outlet port of each of the R evaporator 2006 and the F evaporator 2007 as output from the temperature comparing unit 2036, to judge whether or not refrigerant leakage occurs (exactly speaking, to judge the formation of an opening as described above) and to output the comparison result to the alarming unit 2034 and also to the cooling control unit 2031 when refrigerant leakage is judged to occur.

The alarming unit 2034 is provided with a buzzer or a buzzer and an alarm lamp in order to output warning by buzzing or buzzing and turning on the alarm lamp when the leakage judgment unit 2037 generates the judgment of refrigerant leakage to occur, in the same manner as in the first second exemplary implementations.

When the leakage judgment unit 2037 judges refrigerant leakage to occur, the cooling control unit 2031 serves to close the three-way valve 2017 and drive the compressor 2014 in order to collect the refrigerant in the conduits R and F in the high pressure side and to confine the refrigerant between the three-way valve 2017 and the valve of the compressor 2014, and also serves to inhibit the operation of electric elements which would cause a fire by halting the optical plasma disinfection mechanism, the ice cuber, the defrosting heater and so forth and turning off the electric power source circuits of the door switch, the inner lamps and the like.

Next, the operation of the controller 2030 as described above for judging refrigerant leakage will be explained with reference to the flowchart as illustrated in FIG. 24. In the case of the refrigerator-freezer as illustrated in FIG. 9, for the purpose of monitoring refrigerant leakage for both the R cooling system and the F cooling system, the transition of the differential temperature between the inlet port and the outlet port of each of the R evaporator 2006 and the F evaporator 2007 is monitored. Then, the leakage judgment unit 2037 serves to judge whether or not refrigerant leakage occurs (in the steps S2021 to S2023) on the basis of the temperature in the inlet port side of the R evaporator 2006 and the temperature in the inlet port side of the F evaporator 2007 as obtained by the temperature monitoring unit 2032.
In the case where the differential temperature between the inlet port and the outlet port of the R evaporator 2006 is used for the judgment, refrigerant leakage is judged to occur in the R cooling mode when the differential temperature is no narrower than 15° C. (in the step S2023) and the step S2024.
In the case where the differential temperature between the inlet port and the outlet port of the F evaporator 2007 is used for the judgment, refrigerant leakage is judged to occur in the F cooling mode when the differential temperature is no narrower than 10° C. (in the step S2023) and the step S2024.

When the leakage judgment unit 2037 judges “refrigerant leaking”, the leakage judgment unit 2037 outputs a warning instruction to the alarming unit 2034 and a fire protection instruction to the cooling control unit 2031 (in the steps S2025 and S2026).

By this configuration, in the case of in this embodiment of the present invention, it is possible to detect an opening and take control required for avoiding refrigerant leakage in advance of actual leakage, i.e., while the external air is sucked into the conduit causing the under-charge effect with a pinhole generated on the refrigerant conduit. Furthermore, there are advantages of cost reduction since the leakage judgment is made by the use of the temperature sensors 2022FR, 2022RR, 2023FR and 2023RR which are located on the refrigerant conduits the inlet port sides and the outlet port side of the R evaporator 2006 and the F evaporator 2007 respectively. Still Further, since the leakage judgment is based upon differential temperatures, it is possible to furthermore improve the reliability of the leakage judgment as compared to the case where a temperature sensor is located only in the inlet port side and refrigerant leakage is judged only with the detected temperature thereof.

<Fourth Exemplary Implementation>

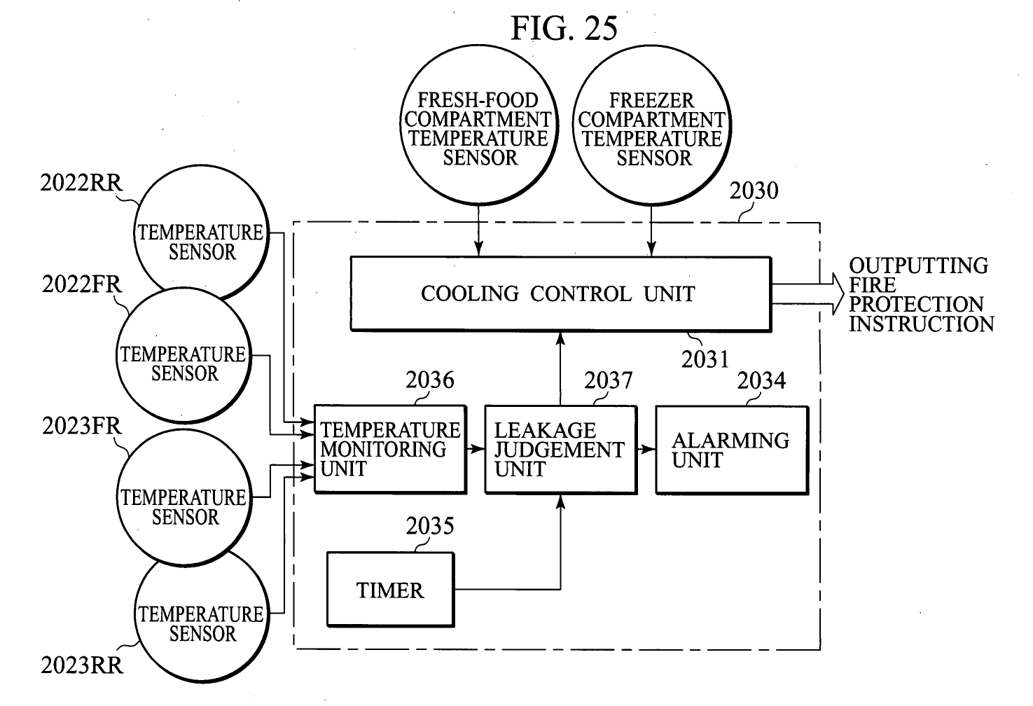

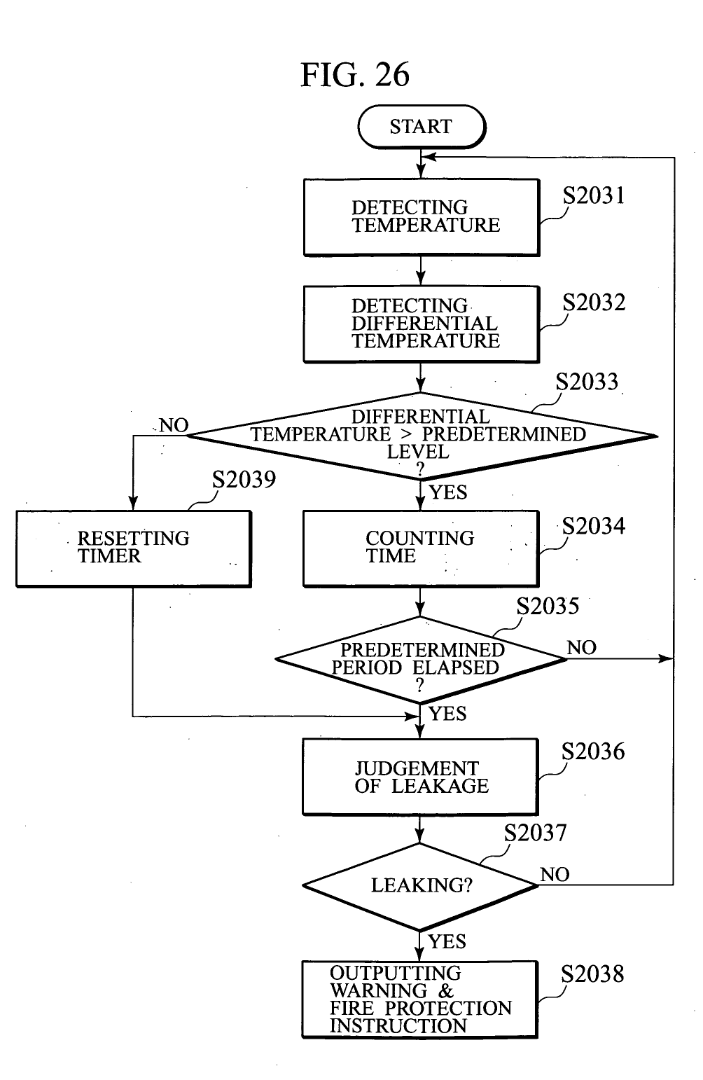

In the followings, a fourth exemplary implementation of the refrigerator-freezer with reference to FIG. 25 and FIG. 26 in accordance with the second embodiment of the present invention will be explained. The fourth exemplary implementation is characterized in that the controller 2030 serves to perform leakage judgment taking into consideration timely information, when the judgment is made in accordance with the third exemplary implementation, in order to furthermore improve the reliability of the leakage judgment by taking into consideration timely information.

Namely, the temperature comparing unit 2036 obtains curent temperature data by receiving the temperature signals of the temperature sensors 2022FR, 2022RR, 2023FR and 2023RR located on the conduit R and the conduit F of the R evaporator 2006 and the F evaporator 2007 in the inlet port sides and the outlet port sides thereof respectively, in order to detect the differential temperatures between the inlet and outlet ports (in the step S2031) and S2032.

When the differential temperature between the inlet port and the outlet port of the R evaporator 2006 in the R cooling mode is 10° C. or more, the leakage judgment unit 2037 serves to measure the period of time during which this condition continues by starting the timer 2035 (in the steps S2033 and S2034). If the differential temperature between the inlet port and the outlet port is continuously higher than the predetermined temperature for 5 or more minutes, the leakage judgment unit 2037 judges refrigerant leakage to occur (in the steps S2035 and S2036).

When the differential temperature between the inlet port and the outlet port of the F evaporator 2007 in the F cooling mode is 5° C. or more, the leakage judgment unit 2037 serves to measure the period of time during which this condition continues by starting the timer 2035 (in the steps S2033 and S2034). If the differential temperature between the inlet port and the outlet port is continuously higher than the predetermined temperature for 5 or more minutes, the leakage judgment unit 2037 judges refrigerant leakage to occur (in the steps S2035 and S2036). In this case, since in a normal operation the differential temperature is in the range of about 7, 8 K just after switching to the F cooling mode, the leakage judgment is started after the time period required for dissipating the normal differential temperature, for example, 20 minutes, in the F cooling mode after resuming the operation of the compressor 2017.

When the leakage judgment unit 2037 judges “refrigerant leaking”, the leakage judgment unit 2037 outputs a warning instruction to the alarming unit 2034 and a fire protection instruction to the cooling control unit 2031 (in the step S2038) in the same manner as in the first exemplary implementation.

Meanwhile, even after it is judged that the differential temperature becomes higher than a predetermined temperature in the step S2033 and thereby the timer 2035 is started, the temperature monitoring is initiated again (in the step S2039) by resetting the timer if the differential temperature becomes within the predetermined temperature range before a predetermined period of time elapses.

By this configuration, in accordance with the fourth exemplary implementation, in addition to the advantages of the first exemplary implementation, it is possible to furthermore improve the reliability of the leakage judgment by taking into consideration timely information.

Meanwhile, the numerical values of the reference temperatures and the reference periods of time used in the respective exemplary implementations are meant to be illustrative only and not limiting but can be determined in accordance with experiments conducted for each of the respective products and depending upon the capacity and the grade of each refrigerator-freezer.

Although in accordance with the above described exemplary implementations, the invention has been described with respect to the refrigerator-freezer with a parallel cycle having two evaporators, it is not to be so limited but applicable to a refrigerator-freezer having a fresh-food compartment evaporator only, a refrigerator-freezer having a freezer compartment evaporator only, and any other type of a refrigerator-freezer make use of the HC refrigerant different than as described above.

Also, while the temperature sensor is provided in each of the R cooling system and the F cooling system in order to judge refrigerant leakage separately for each of the R cooling system and the F cooling system, in the respective exemplary implementations as described above, the present invention is not to be so limited but applicable to the case where the temperature sensor is provided only one of the R cooling system and the F cooling system in only the inlet port side or in both the inlet port side and the outlet port side of the evaporator to judge refrigerant leakage in accordance with the criteria of judgment as described above in the respective exemplary implementations. For example, in the case where the temperature sensor is provided only for the F cooling system, it is also possible to judge refrigerant leakage in the R cooling mode in accordance with the criteria of judgment as described above for the F cooling mode. Also, it is possible to obtain appropriate criteria of judgment anew by experiments.

Namely, in accordance with an aspect of the second embodiment of the present invention, a refrigeration cycle formed by a compressor, a capillary, an evaporator and an accumulator connected in series, and filled with a flammable refrigerant; a cooling fan configured to blow the cold air cooled by the evaporator in the refrigerator-freezer; and a temperature sensor configured to measure the temperature of the flammable refrigerant flowing in the evaporator; and a refrigerant leakage detection system configured to monitor the temperature change of the flammable refrigerant by the temperature sensor and judge leakage of the flammable refrigerant on the basis of the temperature change with reference to the state transitions of the refrigerator-freezer.

By this configuration, it is possible to safely detect an opening such as a pinhole on the basis of the variation of the temperature of the refrigerant in the evaporator as detected by the temperature sensor in advance of actual leakage. Furthermore, there are advantages of cost reduction since the temperature sensor is used which is cheaper than a refrigerant leakage detecting sensor.

Also, in accordance with another aspect of the second embodiment of the present invention, a refrigerator-freezer comprises: a refrigeration cycle formed by a compressor, a capillary, an evaporator and an accumulator connected in series, and filled with a flammable refrigerant; a cooling fan configured to blow the cold air cooled by the evaporator in the refrigerator-freezer; and a refrigerant leakage detection system configured to detect leakage of the flammable refrigerant, wherein the refrigerant leakage detection system is provided with a temperature sensor configured to measure the temperature of a refrigerant conduit of the evaporator and judges that the flammable refrigerant is leaking from the high pressure side of the refrigeration cycle when the temperature detected by the temperature sensor with the compressor being operated is no higher than a predetermined temperature. By this configuration, it is possible to safely detect an opening such as a pinhole in advance of actual leakage. Furthermore, there are advantages of cost reduction since the temperature sensor is used which is cheaper than a refrigerant leakage detecting sensor.

Preferably, the refrigerator-freezer is provided with a refrigerant confinement mechanism configured to confine the flammable refrigerant in a location of the refrigerant conduit from which the flammable refrigerant does not leak into a freezer compartment and a fresh-food compartment of the refrigerator-freezer when it is judged by the refrigerant leakage detection system that the flammable refrigerant is leaking.

By this configuration, when the refrigerant leakage detection system judges refrigerant leakage to occur, the refrigerant is confined to a location from which the refrigerant does not leak in advance of actual leakage.

Preferably, the flammable refrigerant is a hydrocarbon base flammable refrigerant (HC refrigerant).

By this configuration, it is possible to provide a flon free refrigerator-freezer.

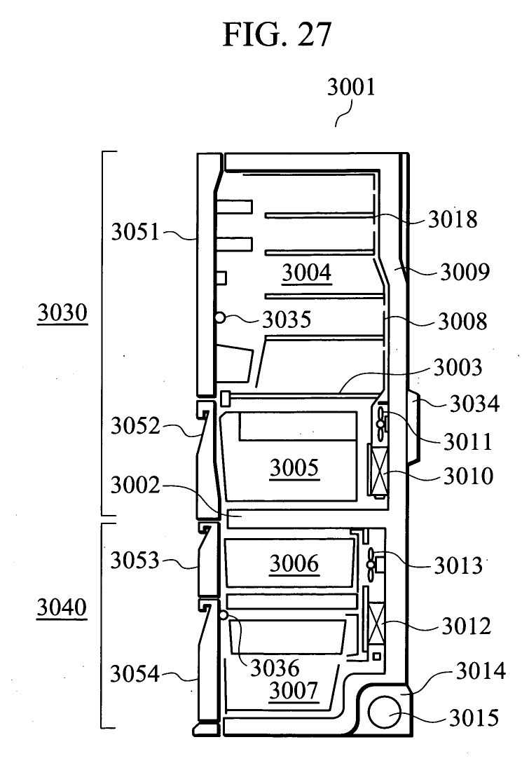

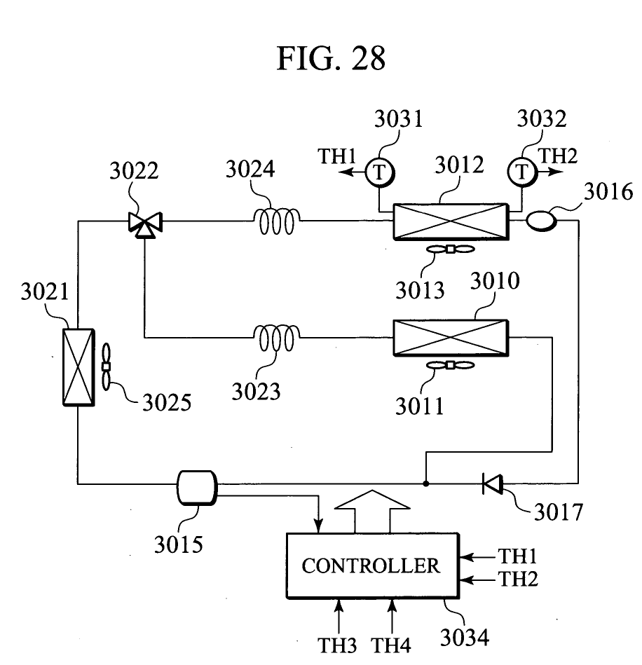

In the following, the refrigerator-freezer in accordance with a third embodiment of the present invention will be explained. FIG. 27 is a longitudinal cross sectional view showing a refrigerator-freezer in accordance with a third embodiment of the present invention. FIG. 28 is a schematic diagram showing the refrigeration cycle of the refrigerator-freezer.

The refrigerator-freezer 3001 is composed of a thermal insulated cabinet 3009 and an inner cabinet 3008 in which a refrigerator temperature zone 3030 and a freezer temperature zone 3040 are formed by means of a thermal insulated partition 3002. The cold air in the refrigerator temperature zone 3030 and the cold air in the freezer temperature zone 3040 are completely separated from each other and shall not be mixed with each other.

The refrigerator temperature zone 3030 is partitioned by means of a refrigerator partition 3003 into a fresh-food compartment 3004 and a vegetable compartment 3005 while the freezer temperature zone 3040 is partitioned into a first freezer compartment 3006 and a second freezer compartment 3007, each compartment being provided with an individual door 3051 to 3054.

A fresh-food compartment evaporator (R evaporator) 3010 and a fresh-food compartment cooling fan 3011 are provided behind the vegetable compartment 3005 as cooling means. The fresh-food compartment cooling fan 3011 is operated with the temperature variation in the refrigerator-freezer and the opening and closing operation of the door of the refrigerator-freezer. Also, a cold air circulation conduit 3018 is formed behind the fresh-food compartment 3004 for the purpose of supplying the cold air into the refrigerator temperature zone.

Furthermore, a freezer compartment evaporator (F evaporator) 3012 and a freezer compartment cooling fan 3013 are provided behind the first and second freezer compartment 3006 and 3007 as cooling means in order to cool the first and second freezer compartment 3006 and 3007 by circulating the cold air.

A condenser 3021 is provided in a machine room 3014 located in the rear bottom of the body of the refrigerator-freezer 3001, as well as a compressor 3015, for constituting the refrigeration cycle of an HC refrigerant included therein as a flammable refrigerant, for example, isobutane. A three-way valve 3022 is provided in the downstream side of the condenser 3021 as a refrigerant path switch mechanism. One outlet port of the three-way valve 3022 is connected to a fresh-food compartment capillary 3023 and the R evaporator 3010 in series while the other outlet port of the three-way valve 3022 is connected to a freezer compartment capillary 3024, the F evaporator 3012 and an accumulator 3016 in series. The conduit of the outlet port of the accumulator 3016 is connected to a check valve 3017 in the machine room 3014 while the outlet port of the check valve 3017 is communicating with the outlet port of the R evaporator 3010 to communicate with in the sucking side of the compressor 3015.

In the case of the refrigeration cycle of the refrigerator-freezer as constructed in this manner, the refrigerant path is switched by means of the three-way valve 3022 so that, when the freezer temperature zone 3040 is cooled, the refrigerant is decompressed through a freezer capillary 3024, passed through the F evaporator 3012, serving to cool the freezer temperature zone 3040 and then returned to the compressor 3015 again. On the other hand, when the refrigerator temperature zone 3030 is cooled the refrigerant is decompressed through a refrigerator capillary 3023, passed through the R evaporator 3010, serving to cool the refrigerator temperature zone 3030 and then returned to the compressor 3015 again.

Namely, the refrigerant flows in the order of the freezer capillary 3024, the F evaporator 3012, the accumulator 3016 and then the check valve 3017 so that the cold air circulates through the first and second freezer compartment 3006 and 3007 by the operation of the freezer compartment cooling fan 3013. On the other hand, when the refrigerant path is switched to the refrigerator temperature zone 3030 from the freezer temperature zone 3040 by switching the three-way valve 3022, the refrigerant flows through the R evaporator 3010 to cool the fresh-food compartment 3004 and the vegetable compartment 3005 by the operation of the fresh-food compartment fan 3011. In the refrigeration cycle, the refrigerant in the refrigeration cycle is, for example, a hydrocarbon base flammable refrigerant (HC refrigerant) such as propane, isobutane and a mixture thereof.

In this case, it is assumed that isobutane (R600a) is used as the flammable refrigerant. In the refrigeration cycle as illustrated in FIG. 28, the pressure and temperature of the R evaporator 3010 are about 0.11 MPa and −10° C. respectively while the pressure and temperature of the F evaporator 3012 are about 0.055 MPa and −26° C.

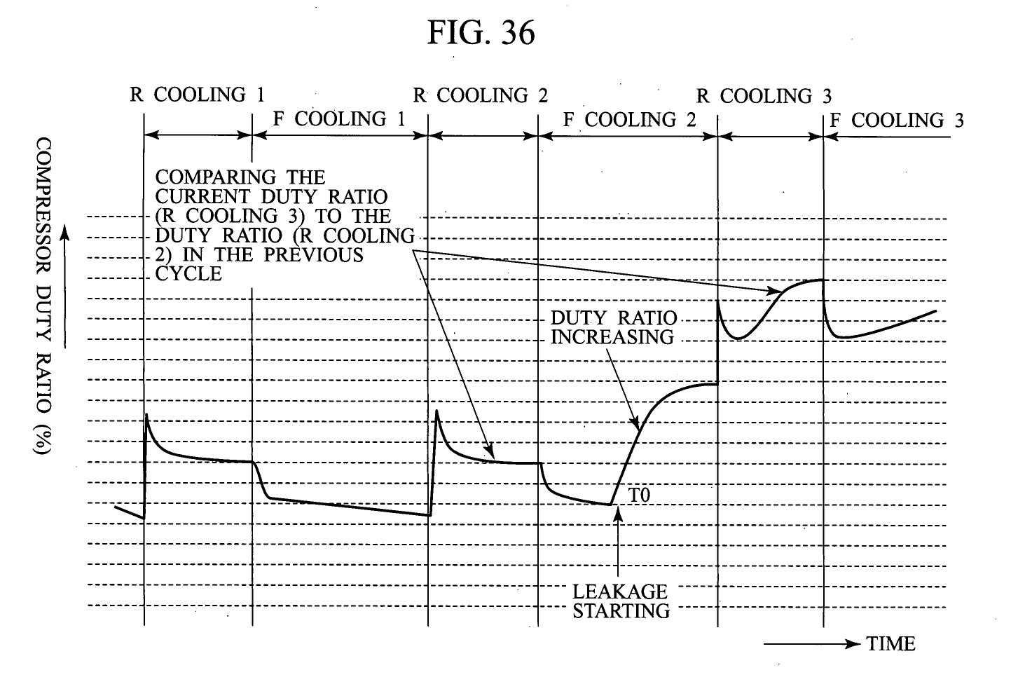

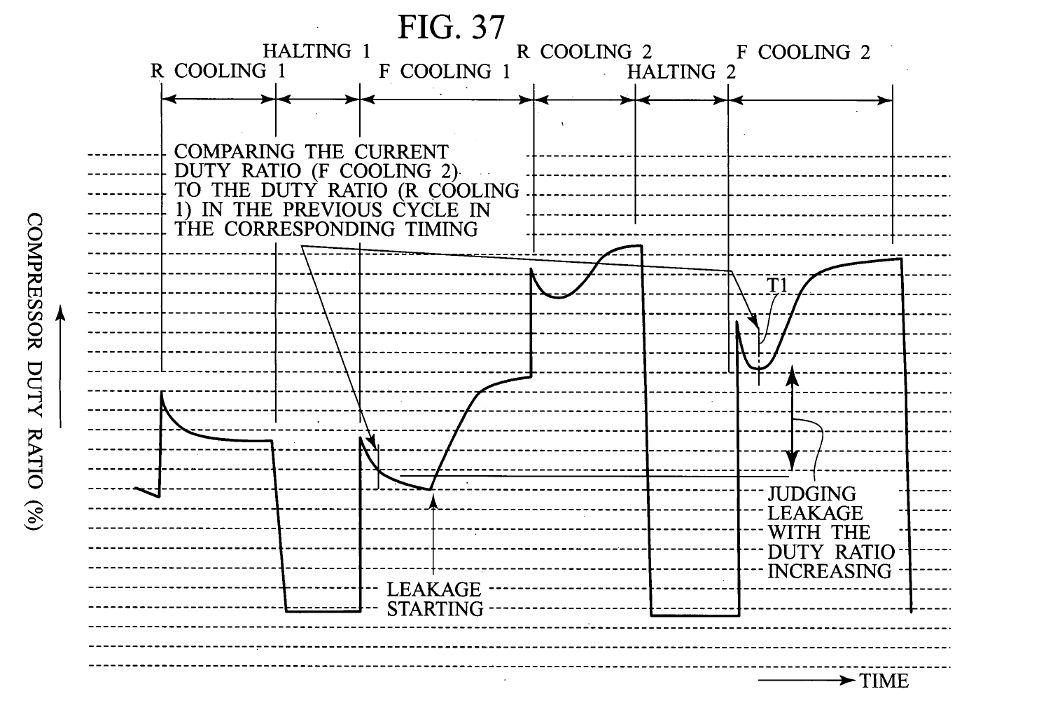

A typical transition pattern of the duty ratio of the compressor during alternating cooling operation is as illustrated in FIG. 36 corresponding to the pressure change of the R evaporator 3010 and the F evaporator 3012. When the refrigerator temperature zone 3030 is cooled, since the pressure of the evaporator in the refrigerator temperature zone 3030 is higher than the pressure of the evaporator in the freezer temperature zone 3040, the check valve 3017 is closed by the differential pressure to maintain the refrigerant as cooled in the F evaporator (R cooling periods \mathring{1} and \mathring{2}. In this situation, when the refrigeration cycle is switched to the cooling mode for cooling the freezer temperature zone 3040, the cooling operation is performed by the refrigerant as cooled.

When the freezer temperature zone 3040 is cooled, the temperature and the pressure of the F evaporator 3012 are about 0.055 MPa and −26° C. while the temperature and the pressure of the R evaporator 3010 are 0° C. to 2° C. and 0.055 MPa same as that of the F evaporator 3012 (F cooling periods \mathring{1}). Since the pressure of the atmosphere is about 0.1 MPa, the pressures of the F evaporator 3012 and the R evaporator 3010 are no higher than the pressure of the atmosphere.

The refrigerant path is switched by switching the three-way valve 3022 in order to alternately cool the refrigerator temperature zone 3030 and the freezer temperature zone 3040 while the fresh-food compartment cooling fan 3011 is operated during cooling the freezer temperature zone 3040 and the freezer compartment cooling fan 3013 is operated during cooling the freezer temperature zone 3040 for cooling the respective compartments. Meanwhile, even when the freezer temperature zone 3040 is cooled, the fresh-food compartment cooling fan 3011 is rotated to a predetermined temperature for the purpose of the defrosting operation for the fresh-food compartment evaporator 3010.

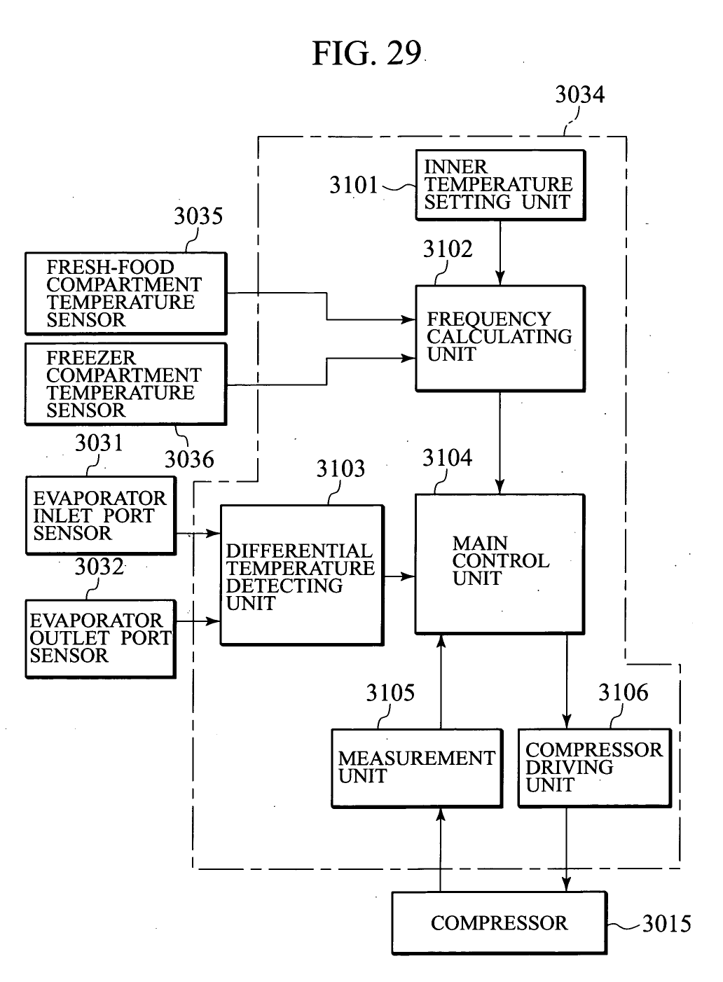

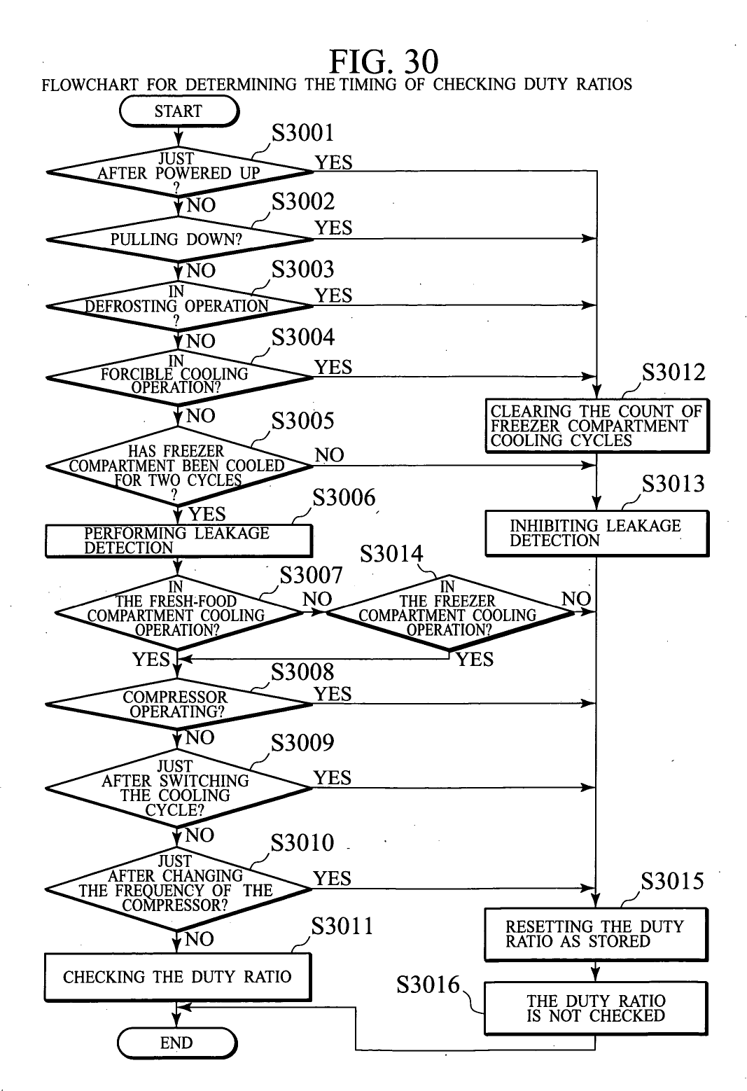

When refrigerant leakage occurs, different considerations are required between the case of the leakage path located in the high pressure side of the refrigeration cycle and the leakage path located in the low pressure side of the refrigeration cycle. Namely, when the refrigerator-freezer is cooled in a normal operation, the temperature of the F evaporator 3012 is −18° C. to −26° C. which is no higher than the boiling point of isobutane, i.e., −11° C. (1 atm). Also, the temperature of the R evaporator 3010 is cooled near the boiling point during cooling the refrigerator temperature zone 3030. Accordingly, as described above, the pressure of the refrigerant in the low pressure side of the refrigeration cycle including the evaporator is no higher than the pressure of the atmosphere during operation of the compressor, and therefore the refrigerant does not leak when there is formed a pinhole or a crack through a refrigerant conduit in the low pressure side of the refrigeration cycle, but rather the external air is sucked into the refrigerant conduit through the pinhole or the crack at this time. On the other hand, in the case where refrigerant leakage occurs in the high pressure side, the pressure of the refrigerant becomes higher than the pressure of the atmosphere, and therefore the refrigerant immediately starts leaking to decrease the pressure of the refrigerant in the refrigerant path. FIG. 29 is a block diagram showing the functions of the controller of the refrigerator-freezer of the third embodiment of the present invention will be explained.

The control device of the refrigerator-freezer as illustrated in FIG. 29 is composed of a fresh-food compartment temperature sensor 3035, a freezer compartment temperature sensor 3036, an inner temperature setting unit 3101, a frequency calculating unit 3102, a differential temperature detecting unit 3103 for detecting the differential temperature between the temperature TH1 of the inlet port and the temperature TH1 of the outlet port of the F evaporator 3012 as detected by an evaporator inlet port sensor 3031 and an evaporator outlet port sensor 3032 respectively, a main control unit 3104 for taking control of the operation of the compressor 3015 in order to adjust the inside temperature and for judging refrigerant leakage a compressor driving unit 3106 for driving the compressor 3015 with reference to the designated frequency and the duty ratio as output from the main control unit 3104, and a parameter measuring unit 3105 for measuring the frequency and the duty ratio. Meanwhile, the controller 3034 as illustrated in FIG. 28 is composed of the inner temperature setting unit 3101, the frequency calculating unit 3102, the differential temperature detecting unit 3103, the main control unit 3104, the parameter measuring unit 3105 and the compressor driving unit 3106. The compressor driving unit 3106 serves to drive the compressor 3015 in accordance with the designated frequency which is obtained by the main control unit 3104 on the basis of PID calculation.

<First Exemplary Implementation>

In the followings, a first exemplary implementation of the refrigerator-freezer in accordance with the third embodiment of the present invention will be explained. First of all, the method of controlling the temperatures of the fresh-food compartment and the freezer compartment will be explained as the basic functions of the refrigerator-freezer. Controlling the temperatures is carried out by adjusting the driving frequency and the duty ratio of the compressor 3015 on the basis of the instructive signal as output from the inner temperature setting unit 3101 and the inner temperatures as detected by the inner sensors 3035 and 3036 located in the fresh-food compartment and the freezer compartment.

The driving frequency of the compressor 3015 is calculated by the equation 1,
designated frequency=current frequency+0.06(et-et-1)+0.016 (et-et-1-et-2)+ . . . et=(the difference between the set temperature and the current temperature as measured of the fresh-food compartment)×2+(the difference between the set temperature and the current temperature as measured of the freezer compartment)×2
where et-1 is the value of et as previously calculated.

The driving frequency is calculated by the frequency calculating unit 3102, rounded off into one of a plurality of predetermined frequencies and used for operating the compressor 3015. The parameter measuring unit 3105 serves to measure the current duty ratio of the compressor 3015 and output to the main control unit 3104. The temperatures TH1 and TH2 at the inlet port and the outlet port of the F evaporator 3012 are detected while the differential temperature therebetween is obtained by the differential temperature detecting unit 3103 and output to the main control unit 3104. The main control unit 3104 serves to judge refrigerant leakage on the basis of the duty ratio of the compressor 3015. The mechanism of judging refrigerant leakage will be explained.

The duty ratio is the microscopic ratio of the power supply duration to (the power supply duration+the power stop duration) in the PWM control. For example, 100%, 50% are 0% correspond respectively to the full power, the half power and the halt. The duty ratio of the compressor 3015 is depending on the frequency (corresponding to the rotation per minite) and the load. Accordingly, even with the same load, the duty ratio can change depending upon the frequency while the degree of the variation in the duty ratio responsive to the variation in the load is also depending upon the frequency. However, it is possible to monitor the variation in the load irrespective of the frequency by obtaining the rate of change in the duty ratio relative to an arbitrary duty ratio as the base reference by the use of the equation 2,
the rate of change=(the difference between the base duty ratio and the current duty ratio)/the base duty ratio.

Since there is a certain correlation between the load on the compressor and the rate of change in the duty ratio, it is possible to judge refrigerant leakage to occur when the rate of change in the duty ratio as calculated deviates from a predetermined range.

While the base duty ratio can be determined as “1 or 100%” in a most simplified case, it is preferred to use a more appropriate base duty ratio from the view point of detection of refrigerant leakage.

In this case, determined as the base duty ratio is the duty ratio detected at the timing when the duty ratio changes irrespective of whether or not refrigerant leakage occurs, for example, after switching the refrigeration cycle or after switching the driving frequency of the compressor 3015. Refrigerant leakage in the high pressure side or the low pressure side of the refrigerant path is judged on the basis of the rate of change in the (current) duty ratio at the timing relative to the base duty ratio as calculated repeatedly with a predetermined time interval on the basis of the equation 2. In this case, refrigerant leakage is judged by comparing the current duty ratio of the compressor 3015 with the duty ratio (the base duty ratio) as calculated in the previous cycle of the same cooling mode.

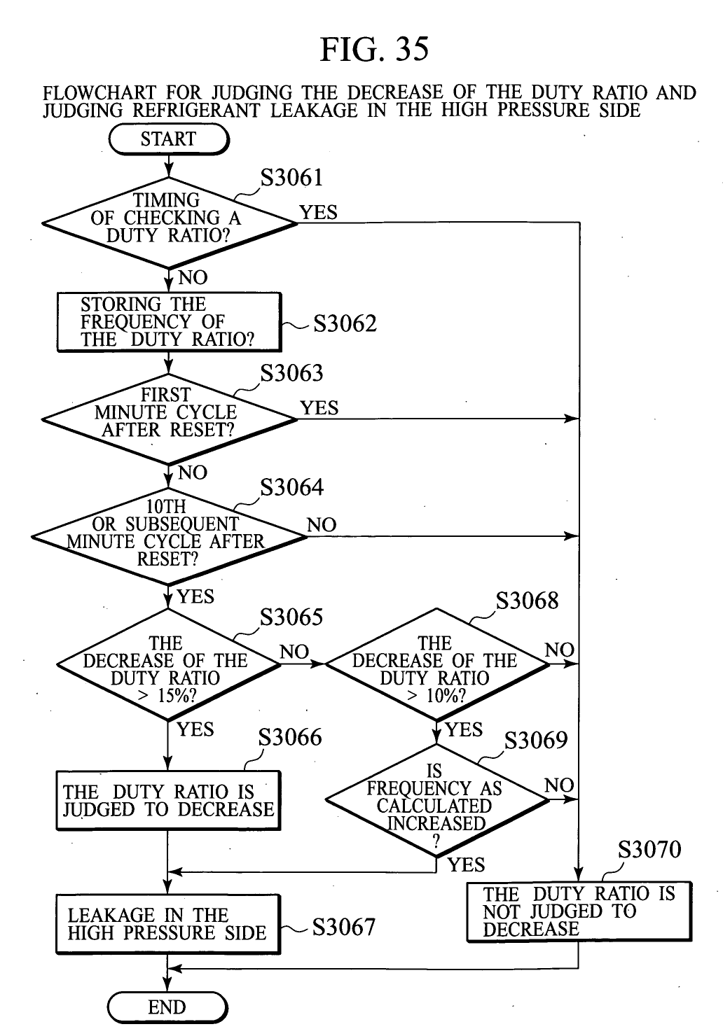

As understood by comparing the duty ratios before and after the time point TO at which refrigerant leakage occurs as illustrated in FIG. 36, the air is sucked into the refrigeration cycle due to the differential pressure from the pressure of the atmosphere to increase the pressure inside the refrigeration cycle when a crack and the like is generated in the F evaporator 3012 or the R evaporator 3010 which is inside of the refrigerator-freezer (i.e., in the low pressure side). Then, the duty ratio of the compressor 3015 increases as the pressure increases. In a normal operation mode, the duty ratio in the fresh-food compartment cooling mode (R cooling mode) is higher than that in the freezer compartment cooling mode (F cooling mode). However, as illustrated in FIG. 35 in which refrigerant leakage occurs at the time point TO in the F cooling cycle \mathring{2}, the duty ratio increases in the F cooling cycle \mathring{2} and then continuously increases in the subsequent R cooling cycle.

If refrigerant leakage is judged to occur in the F cooling cycle \mathring{2} in which the duty ratio increases, it is possible to secure the safety. However, the judgment is sometimes impossible when the cooling mode is switched or when the compressor is halted. Then, the main control unit 3104 serves to continuously monitor the duty ratio as measured from the parameter measuring unit 3105, compare the duty ratio of the compressor 3015 in the R cooling cycle \mathring{3} with the refrigerant leaking to that in the previous R cooling cycle (in a normal operation), and then if the rate of increase of the duty ratio reaches 10% or higher, refrigerant leakage is judged to occur in the refrigerator-freezer (i.e., in the low pressure side). Namely, the parameter measuring unit 3105 serves to output the duty ratio as measured to the main control unit 3104 once for every three minutes. On the other hand, the main control unit 3104 serves to compare the duty ratio as received to the corresponding duty ratio in the previous R cooling cycle and save the duty ratios as received for use in the next cycle. Then, if refrigerant leakage is judged to occur, electric parts in the refrigerator-freezer are halted while a notice such as an alarm or an indication is generated to inform the user of the refrigerant leakage in the step 1020.

By this configuration, in the case of in this embodiment of the present invention, it is possible to detect an opening such as a pinhole, a crack and so forth in the low pressure side of the refrigerant path of the refrigerator-freezer and take necessary steps required for avoiding refrigerant leakage in advance of actual leakage.

<Second Exemplary Implementation>

Next, a method of judging refrigerant leakage will be explained as a second exemplary implementation of the refrigerator-freezer in accordance with the third embodiment of the present invention. Refrigerant leakage is judged by comparing the duty ratio in a predetermined timing, after switching the refrigeration mode or after resuming the operation of the compressor 3015, with the duty ratio in the same timing in the previous cooling cycle.

FIG. 36 is a graphic diagram in which refrigerant leakage occurs in the F cooling cycle \mathring{1}, followed by comparing the duty ratio a predetermined time after switching the refrigeration mode or after resuming the operation of the compressor, with the duty ratio in the same timing T1 in the subsequent cooling cycle. In a normal operation, the duty ratio is not stable just after switching the cooling mode or after resuming the operation of the compressor 3015 because of a temporary peak. Because of this, the current duty ratio and the previous duty ratio (the base duty ratio) are compared in the timing of, for example, two minutes after switching the cooling mode or after resuming the operation of the compressor 3015. In this comparison, if the increase of the current duty ratio relative to the base duty ratio is no smaller than a predetermined value, it is judged that the load on the compressor 3015 increases with the external air being sucked and that refrigerant leakage occurs in the low pressure side.

In this case, the duty ratios of the compressor 3015 are compared with each other preferably with the compressor 3015 operating at the same frequency. The duty ratio of the compressor 3015 changes as the frequency of the compressor in a normal operation changes. Accordingly, it is possible to judge refrigerant leakage with a high degree of accuracy by fixing the frequency of the compressor for a predetermined period until the leakage judgment is completed, even if there is a requirement of changing the frequency of the compressor, when judging refrigerant leakage.

<Third Exemplary Implementation>

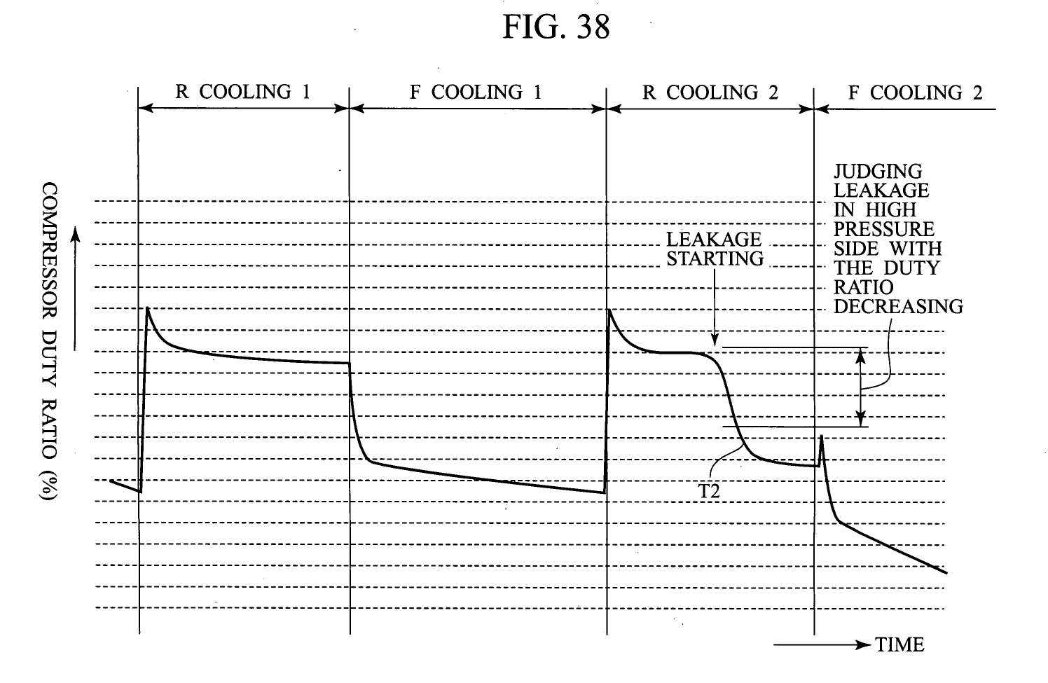

Next, a method of judging refrigerant leakage will be explained as a third exemplary implementation of the refrigerator-freezer in accordance with the third embodiment of the present invention. In accordance with the third exemplary implementation, refrigerant leakage is judged to occur in the high pressure side when the decrease of the duty ratio of the compressor 3015 exceeds the predetermined value. FIG. 38 is a graphic diagram showing the duty ratio which is falling down when refrigerant leakage occurs in the high pressure side of the refrigerator-freezer.

As described above, when an opening such as a pinhole, a crack and so forth is generated in the high pressure side of the refrigerant path, refrigerant leakage occurs without delay since the pressure of the refrigerant is greater than the pressure of the atmosphere. For this reason, the amount of the refrigerant is decreased in the refrigerant path to decrease the load on the compressor 3015. Then, if the duty ratio of the compressor 3015 decreases by no smaller than a predetermined value relative to the previous duty ratio in the same timing, refrigerant leakage is judged to be occurring in the high pressure side. When refrigerant leakage is judged to occur, an alarm is generated to the outside while the refrigerant is diffused by turning the machine fan 3025 as illustrated in FIG. 28 to take a necessary procedure with safety.

Meanwhile, also in the case of judging refrigerant leakage in the high pressure side, it is possible to ensure the reliablity of judging refrigerant leakage by fixing the frequency of the compressor for a predetermined period until the leakage judgment is completed. Namely, the conditions such as the frequency of the compressor have to be even in order to improve the accuracy of comparing the duty ratios. For this reason, when it is judged that refrigerant leakage might occur since the differential duty ratio is detected to be no smaller than a predetermined value, the frequency of the compressor is fixed for a predetermined period until the leakage judgment is completed, even if there is a requirement of changing the frequency of the compressor or requirement of switching the operation mode.

<Fourth Exemplary Implementation>

Next, a method of judging refrigerant leakage will be explained as a fourth exemplary implementation of the refrigerator-freezer in accordance with the third embodiment of the present invention. The fourth exemplary implementation is characterized in that, when the duty ratios of the compressor 3015 are compared and the differential temperature between the inlet port and the outlet port of the F evaporator 3012 becomes no smaller than a predetermined value while the duty ratio becomes also no smaller than a predetermined value, it is judged that refrigerant leakage occurs in the low pressure side. It has been confirmed that when refrigerant leakage occurs, the differential temperature between the inlet port and the outlet port of the evaporator increases as well as the variation of the duty ratio. It is therefore possible to judge refrigerant leakage with a higher degree of accuracy, as compared to the case only with the detection of the duty ratio, by judging refrigerant leakage to occur in the low pressure side when both the variations are detected.

<Fifth Exemplary Implementation>

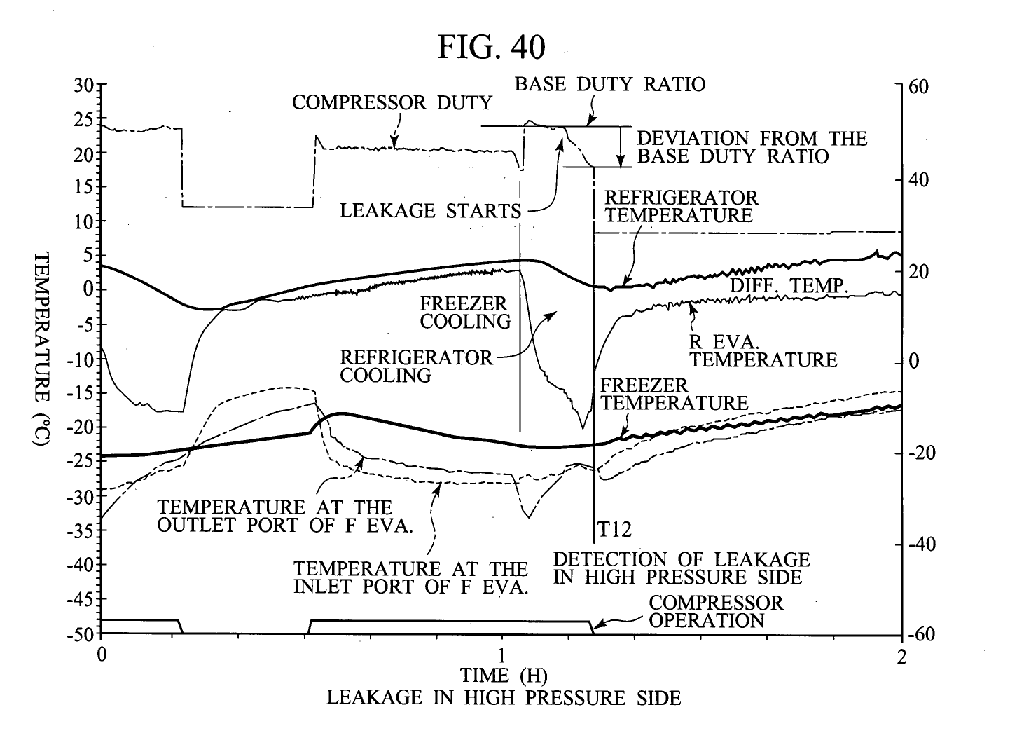

Next, a method of judging refrigerant leakage will be explained as a fifth exemplary implementation of the refrigerator-freezer in accordance with the third embodiment of the present invention. FIG. 40 is a graphic diagram showing the state transitions of the refrigerator-freezer when relatively large refrigerant leakage occurs in the high pressure side. As illustrated in the figure, when the refrigerant leaks in the high pressure side and the amount of the refrigerant quickly decreases, the load of the compressor 3015 becomes light. The duty ratio therefore falls down so that when the decrease of the current duty ratio relative to the base duty ratio as calculated on the basis of the equation 2 is no smaller than a predetermined value (in the timing T3012), it is judged that refrigerant leakage occurs in the high pressure side.

By this configuration, even if the frequencies of the compressor 3015 are different, it is possible to judge refrigerant leakage under the same condition.

<Sixth Exemplary Implementation>

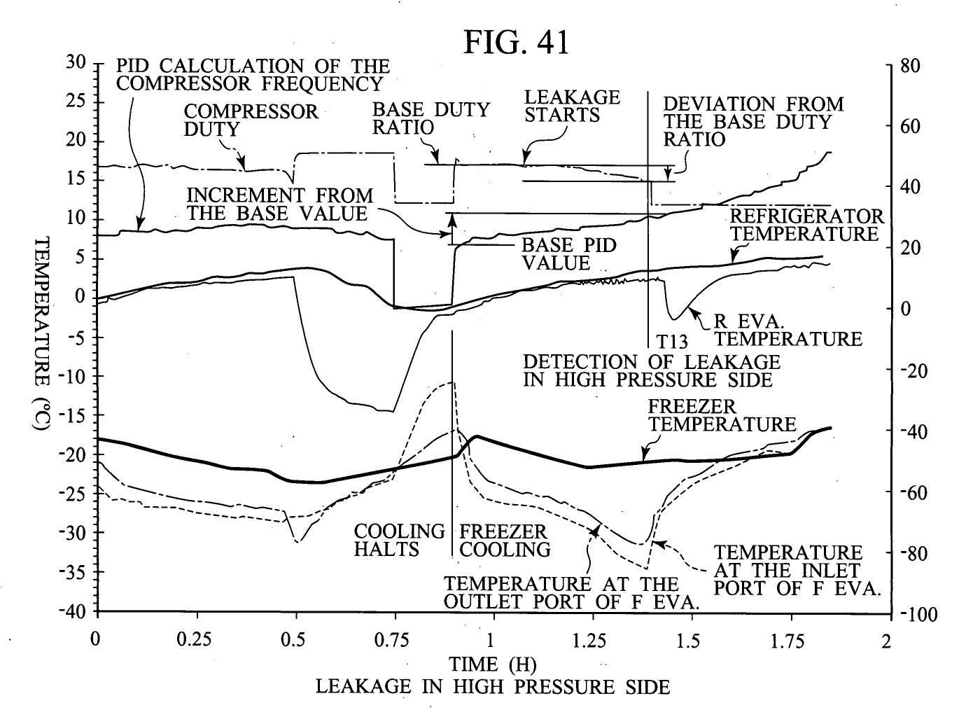

Next, a method of judging refrigerant leakage will be explained as a sixth exemplary implementation of the refrigerator-freezer in accordance with the third embodiment of the present invention with reference to FIG. 41. The sixth exemplary implementation is characterized in that refrigerant leakage in the high pressure side is judged with reference to the result of PID calculation of the frequency of the compressor 3015 as well as the rate of change in the duty ratio.

FIG. 41 is a graphic diagram showing the state transitions of the refrigerator-freezer when relatively small refrigerant leakage occurs in the high pressure side of the refrigerant path. In a normal operation, the duty ratio of the compressor 3015 decreases when the inside of the refrigerator-freezer is sufficiently cooled from a high temperature state so that the load is lessened. However, when refrigerant leakage occurs as illustrated in FIG. 41, the load of the compressor 3015 is lessened while the main control unit 3104 increases the result of PID calculation in order to compensate the lowering of the cooling capacity due to the loss of the refrigerant by increasing the driving frequency of the compressor 3015. Namely, whereas the decrease in the duty ratio indicates the progress of cooling, the driving frequency of the compressor 3015 is increased at odd. It is therefore possible to judge relatively small refrigerant leakage in the high pressure side by detecting the odd condition.

For this purpose, the frequency calculating unit 3102 serves to calculate the designated frequency on the basis of the differential temperature between a predetermined temperature and the inner temperatures TH3 and TH4 detected by the inside sensors 3035 and 3036 while the main control unit 3104 serves to calculate a PID output level on the basis of the differential value between the designated frequency and the frequency as measured by the parameter measuring unit 3105 and control the frequency of the rotation of the compressor 3015 and the duty ratio by pulse width modulation.

Determined as the base duty ratio is the duty ratio detected in such timing as a constant value can be set as the base duty ratio irrespective of whether or not refrigerant leakage occurs. Also, determined as the base PID output level is the result of PID calculation for driving the compressor 3015 in the same timing. Then, the rate of change in the duty ratio relative to the base duty ratio is calculated on the basis of the equation 2 in the predetermined timing while the result of PID calculation is obtained in the same predetermined timing.

When the decrease of the duty ratio becomes no smaller than a predetermined value and the increase of the frequency as the result of PID calculation is no smaller than a predetermined value, it is judged that refrigerant leakage occurs in the high pressure side. In this case, the predetermined value for evaluating the decrease of the duty ratio is set smaller than that of the fifth exemplary implementation. Namely, it is possible to safely judge refrigerant leakage even when relatively small refrigerant leakage occurs in the high pressure side and therefore the variation of the duty ratio is small, while the method of judging refrigerant leakage in accordance with the fifth exemplary implementation is effective in the case where relatively large refrigerant leakage occurs in the high pressure.

<Seventh Exemplary Implementation>

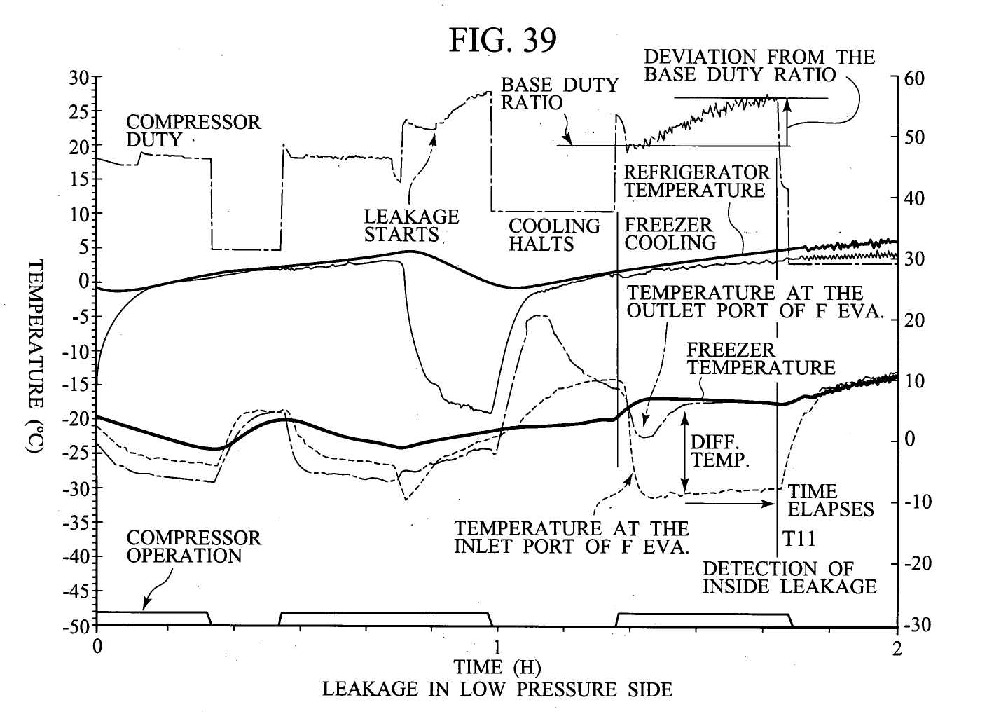

Next, a method of judging refrigerant leakage will be explained as a seventh exemplary implementation of the refrigerator-freezer in accordance with the third embodiment of the present invention with reference to FIG. 41. FIG. 39 is a graphic diagram showing the state transitions of the refrigerator-freezer when refrigerant leakage occurs in the low pressure side of the refrigerant path (more exactly speaking, when an opening such as a pinhole, a crack and so forth is generated in the refrigerant path in advance of actual refrigerant leakage).

As illustrated in FIG. 39, the load increases due to the external air as sucked for a certain time after the opening is generated in the refrigerant path to increase the duty ratio. At the same time, the differential temperature between the inlet port and the outlet port of the F evaporator 3012 becomes larger than that in a normal operation, Then, as described above, it is judged that refrigerant leakage occurs in the low pressure side when the increase of the current duty ratio as calculated relative to the base duty ratio is no smaller than a predetermined value while maintained for a predetermined time is the condition that the differential temperature between the inlet port and the outlet port of the F evaporator 3013 is no lower than a predetermined value.

Meanwhile, in the case where the increase of the current duty ratio is taken into consideration, there is a possibility that refrigerant leakage would be misjudged by confusing refrigerant leakage with the variation due to a heavy load in the case where the door is frequently opened and closed or where a substantial amount of food having a relatively high temperature is loaded. However, it is possible to safely detect refrigerant leakage in the low pressure side also by checking the differential temperature between the inlet port and the outlet port of the evaporator.

In the above, the method of judging refrigerant leakage has been explained. Next, the actual process of judging refrigerant leakage by means of the control device of the refrigerator-freezer as illustrated in FIG. 29 will be explained with reference to the flowcharts as illustrated in FIG. 30 through FIG. 34.

FIG. 30 is a flowchart showing the procedure for determining the timing to check the duty ratio of the compressor in accordance with the third embodiment of the present invention. This procedure for determining the timing to check the duty ratio is performed for the purpose of avoiding misjudgment of refrigerant leakage by confusing refrigerant leakage with the variation of the duty ratio while the load becomes temporarily lessened, e.g., at power up, during pull down operation, during the defrosting operation, during forcibly cooling and so forth. This procedure is repeated in a certain controlling cycle.

First of all, after starting the procedure, it is judged whether or not the system is just powered up (in the step S3001). If powered up (in the step S3001: YES), the count of the freezer compartment cooling cycle is cleared (in the step S3012) followed by inhibiting the refrigerant leakage detecting operation (in the step S3013). Then, the duty ratio data is cleared (in the step S3015) followed by finishing the procedure while the duty ratio is not checked (in the step S3016).

If it is judged that the system is currently operating rather than just powered up (in the step S3001: NO), that the system is not in the pull-down operation (in the step S3002: NO), that the system is not in the defrosting operation (in the step S3003: NO) and that the system is not in the defrosting operation (in the step S3004: NO), it is judged whether or not two cycles of the freezer compartment cooling operation have been completed (in the step S3005).

If it is judged that two cycles of the freezer compartment cooling operation have not been completed yet (in the step S3005: NO) and therefore the temperature of the freezer compartment is not stabilized, the refrigerant leakage detecting operation is inhibited (in the step S3013). On the other hand, it is judged that two cycles of the freezer compartment cooling operation have been completed (in the step S3005: YES), the refrigerant leakage detecting operation is initiated (in the step S3006).

In order to perform the refrigerant leakage detecting operation, it is judged whether or not the system is in the fresh-food compartment cooling mode (in the step S3007). If the system is not in the fresh-food compartment cooling mode (in the step S3007: NO), it is judged whether or not the system is in the freezer compartment cooling mode (in the step S3014).

If the system is in the fresh-food compartment cooling mode (in the step S3007: YES) or in the freezer compartment cooling mode (in the step S3014: YES), it is then judged whether or not the compressor 3015 is just started (in the step S3008). At this time, if the operation of the compressor 3015 is not being started (in the step S3008: NO) and therefore the operation of the system is stabilized, it is judged whether or not the refrigeration cycle is just switched by means of the three-way valve 3022 (in the step S3009).

If not just after the refrigeration cycle is switched (in the step S3009: NO), it is judged whether or not the frequency of the compressor 3015 is just changed (in the step S3010). If not just after the frequency of the compressor 3015 is changed (in the step S3010: NO), the duty ratio is checked (in the step S3011).

In accordance with the procedure as described above, the duty ratio check is temporarily halted if the variation of the duty ratio is large when the load increases in the refrigerator-freezer for example due to the opening/closing operation of the door of the refrigerator-freezer so that the frequency of the compressor 3015 is switched by the frequency calculation. Also, the duty ratio check is not performed when the operation of the compressor 3015 is being started, or when the frequency is changed by changing the designated frequency, or just after the refrigeration cycle is switched, since the duty ratio changes irrespective of refrigerant leakage. Accordingly, it is possible to avoid misjudgment of refrigerant leakage in these cases.

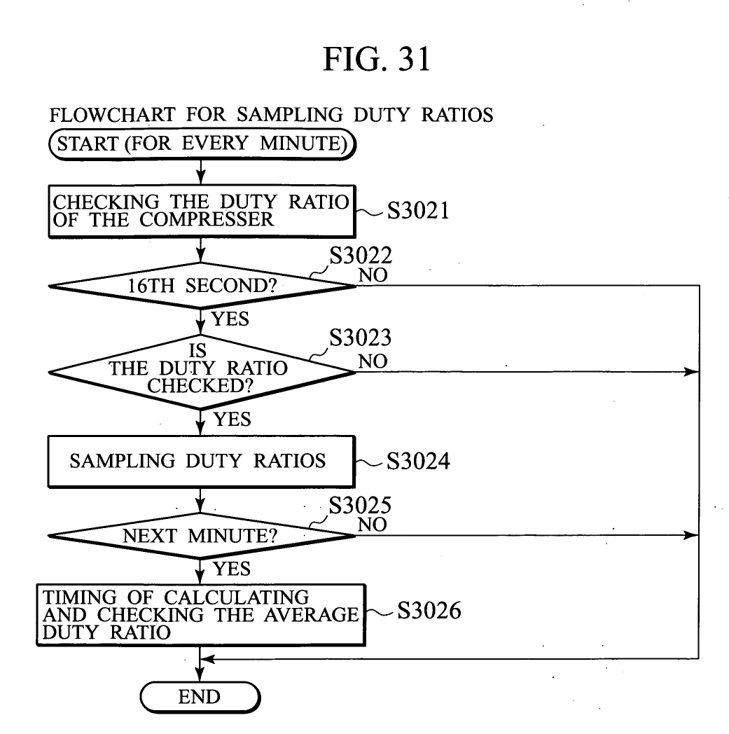

FIG. 31 is a flowchart showing the procedure for sampling duty ratios.

The duty ratio is sampled for every 16 seconds (in the steps S3021 to S3024) and averaged to an average value for about every minute. Each time the average value is generated, an instruction of outputting the duty ratio check timing signal is issued (in the steps S3025 and S3026) if the conditions for the duty ratio check are satisfied.

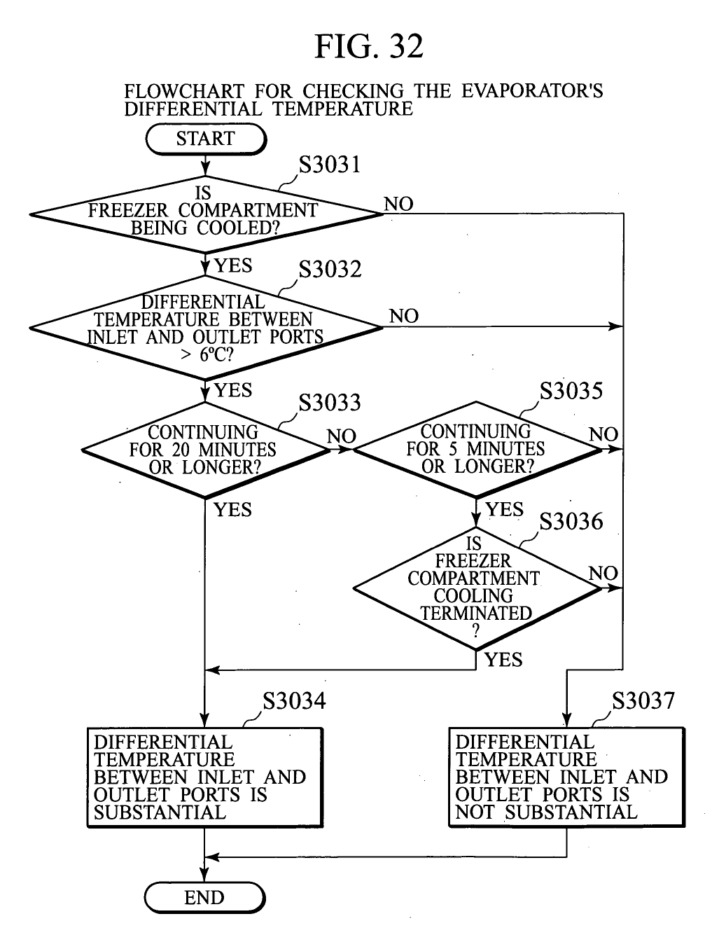

FIG. 32 is a flowchart showing the procedure for checking the differential temperature between the inlet port and the outlet port of the F evaporator 3012 aside the freezer compartment. This procedure is repeated for every cycle as predetermined separate from the sampling procedure of the duty ratio as described above.

First of all, it is judged whether or not the system is in the freezer compartment cooling mode (in the step S3031). If the system is not in the freezer compartment cooling mode (in the step S3031: NO), the procedure then proceeds to the step S3037 assuming that the differential temperature between the inlet port and the outlet port is no higher than a predetermined vale (in the step S3037).

On the other hand, if the system is in the freezer compartment cooling mode (in the step S3031: YES), the differential temperature detecting unit 3103 serves to obtain the differential temperature between the inlet port and the outlet port on the basis of the results of temperature TH1 and TH2 measured by the evaporator inlet port sensor 3031 and the evaporator outlet port sensor 3032. Then, it is judged whether or not the differential temperature between the inlet port and the outlet port exceeds 6° C. (in the step S3032). If the differential temperature exceeds 6° C. (in the step S3032: YES), it is judged whether or not this condition has continued for 20 minutes (in the step S3033). And, if this condition has continued for 20 minutes, it is judged that there is a differential temperature no lower than the predetermined value (in the step S3034). On the other hand, even if the differential temperature between the inlet port and the outlet port exceeds 6° C., the freezer compartment cooling cycle might be completed before 20 minutes elapses (in the step S3033: NO). In this case, if the differential temperature exceeding 6° C. has continued for 5 minites when the freezer compartment cooling cycle is completed (the step S3035: YES, step S3035: YES), it is judged that there is a differential temperature no lower than the predetermined value (in the step S3034) on the assumption that the condition would continue thereafter. Under the other conditions, it is judged that there is not a differential temperature between the inlet port and the outlet port no lower than the predetermined value.

By this procedure, it is judged that there actually is an opening through which the refrigerant leaking if the differential temperature exceeding 6° C. has substantially continued for 20 minutes.

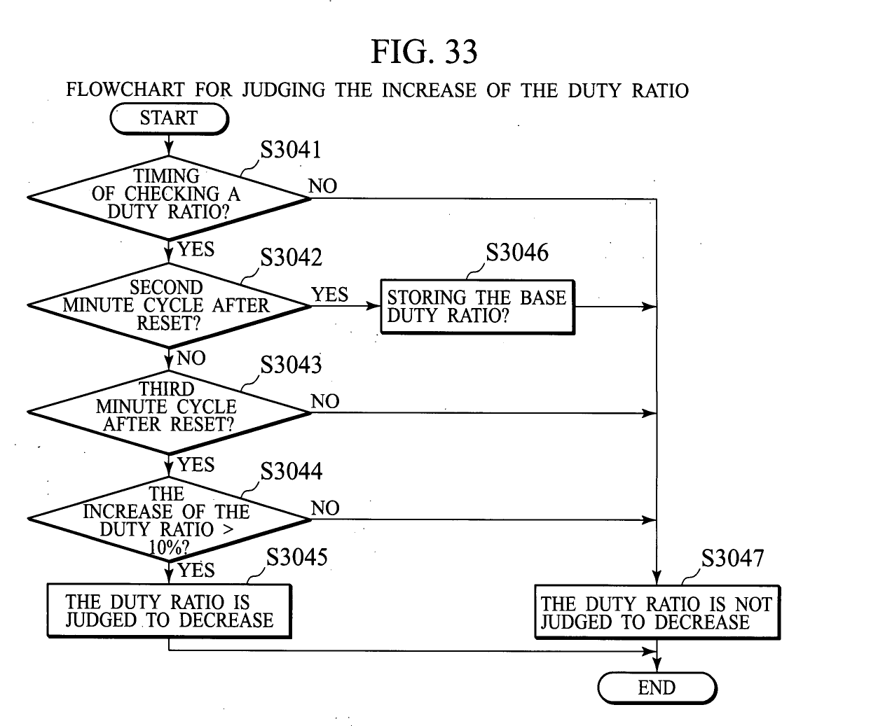

FIG. 33 is a flowchart showing the procedure for judging the increase of the duty ratio. This procedure is also repeated for every cycle as predetermined. The increase of the duty ratio is judged (in the step S3041: YES), as long as the conditions for the duty ratio check are satisfied (in the step S3011), followed by judging whether or not it is in the second minute cycle after clearing the duty ratio data (i.e., in the second minute cycle after reset) (in the step S3042). As a result of the judgment, if it is in the second minute cycle (in the step S3042: YES), the duty ratio at the time point is stored as a base duty ratio followed by terminating the procedure while the increase of the duty ratio is not judged (in the steps S3046 and S3047).

On the other hand, as a result of the judgment, if it is not in the second minute cycle (in the step S3042: NO), it is judged whether or not it is in the third minute cycle after reset (in the step S3043). Then, if it is in the third minute cycle after reset (in the step S3043: YES), it is judged whether or not the rate of increase of the current duty ratio relative to the base duty ratio exceeds 10% (in the step S3044). If the rate of increase of the current duty ratio exceeds 10% (in the step S3044: YES), it is judged that there is a predetermined increase of the current duty ratio (in the step S3045).

In the procedure for judging the increase of the duty ratio, the duty ratio in the second minute cycle after starting the duty ratio check is stored as the base duty ratio. This is because if the first duty ratio is used as the base duty ratio, the average value might not be accurately obtained while the duty ratio is stabilized only after about several tens of minutes. After the third minute cycle, it is judged that the increase of the duty ratio is significant when the rate of change as calculated on the basis of the equation 2 by comparing the current duty ratio with the second duty ratio as the base duty ratio exceeds 10%.

In a normal operation, the rate of change in the duty ratio responsive to the change in the load on the refrigerator-freezer or inside of the freezer compartment due to the opening/closing operation of the door is no larger than 10% . When the change in the load is large, the duty ratio check is reset during calculation of the designated frequency.

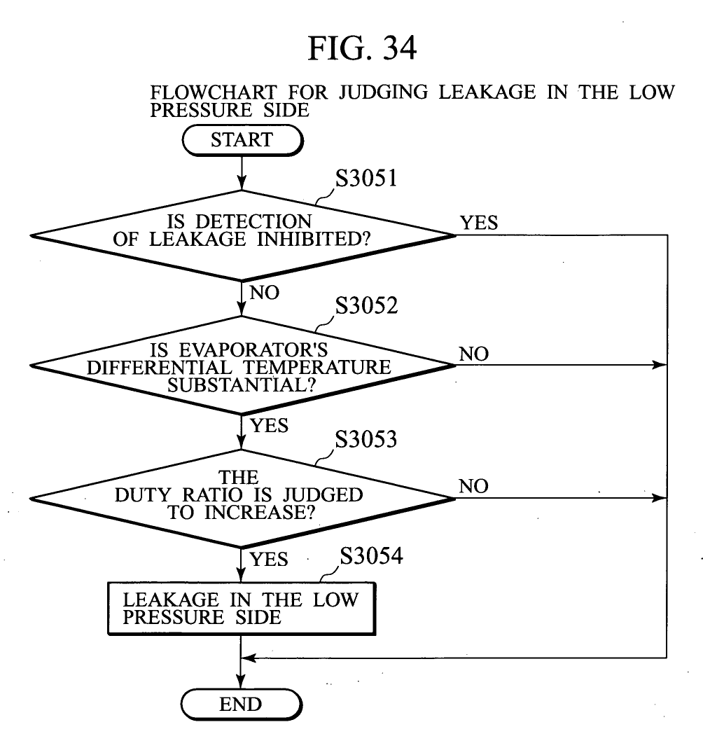

FIG. 34 is a flowchart showing the procedure for judging refrigerant leakage in the low pressure side. In this procedure, first, it is judged (in the step S3051) whether or not the refrigerant leakage detection has been inhibited in the above step S3013. If the refrigerant leakage detection has been inhibited (in the step S3051: YES), the procedure is terminated since the judgment is not necessary.

On the other hand, if the refrigerant leakage detection has not been inhibited (in the step S3051: NO), it is judged (in the step S3052) whether or not the differential temperature between the inlet port and the outlet port of the F evaporator 3012 has been judged to be no lower than a predetermined value in the above step S3034. If the differential temperature has been judged to be no lower than a predetermined value (in the step S3052: YES), then it is judged (in the step S3053) whether or not the increase of the duty ratio has been judged to be no lower than a predetermined value in the above step S3045. When the increase of the duty ratio has been judged to be lower than a predetermined value (in the step S3053: YES), refrigerant leakage is judged to occur in the low pressure side (in the step S3054).

Namely, refrigerant leakage is judged to occur in the low pressure side when the differential temperature between the inlet port and the outlet port of the F evaporator 3012 is no lower than a predetermined value while the increase of the duty ratio of the compressor 3015 is judged to be significant. By this configuration, it is possible to judge refrigerant leakage in advance of actual refrigerant leakage while the external air is sucked through a relatively small opening.

Meanwhile, the procedure for judging refrigerant leakage in the low pressure side as illustrated in the flowchart can be simplified by skipping the differential temperature judgment of the evaporator in the step S3052 to judge refrigerant leakage to occur in the low pressure side if it is judged in the step S3053 that the rate of increase of the current duty ratio relative to the base duty ratio is no lower than a predetermined value. In this case, however, the predetermined value for evaluating the increase of the current duty ratio is larger than that in the case where the differential temperature is also checked.

FIG. 35 is a flowchart showing the procedure for judging the decrease of the duty ratio and judging refrigerant leakage in the high pressure side. In this procedure, first, the decrease of the duty ratio is judged. For this purpose, it is judged (in the step S3061) whether or not the conditions for the duty ratio check are satisfied in the above step S3012. If the conditions for the duty ratio check are not satisfied (in the step S3061: NO), the procedure is terminated while the duty ratio is not checked (in the step S3070).

On the other hand, if the conditions for the duty ratio check are satisfied (in the step S3061: NO), the duty ratio and the frequency of the compressor 3015 at the time point are stored (in the step S3062). Thereafter, it is judged (in the step S3063) whether or not it is in the first minute cycle after clearing the duty ratio data in the above step S3015. As a result of the judgment, if it is in the first minute cycle (in the step S30463: YES), the decrease of the duty ratio is not significant (in the step S3070).

If it is not in the first minute cycle (in the step S30463: NO), then it is judged whether or not it is in the tenth minute cycle after reset (in the step S3064). Then, if ten minutes have not elapsed yet (in the step S3064: NO), it is assumed that the decrease of the duty ratio is not significant (in the step S3070).

Conversely, if ten minutes have elapsed (in the step S3064: YES), it is judged whether or not the rate of decrease of the current duty ratio exceeds 15% (in the step S3065). If ten minutes have not elapsed yet (in the step S3065: NO), it is judged whether or not the rate of decrease of the current duty ratio exceeds 10% (in the step S3068).

As a result of the judgment, if the rate of decrease of the current duty ratio does not exceed 10% (in the step S3066: NO), the judgment of the duty ratio is not performed (in the step S3070).

On the other hand, while ten minutes have elapsed (in the step S3064: YES), if the decrease of the current duty ratio is within 10% to 15% (the step S3065: NO, the step S3067: YES) and if the current designated frequency is increased as compared with the designated frequency generated 10 minutes before, then refrigerant leakage is judged to be occurring in the high pressure side (the step S3069: YES, the step S3067).

Also, if the rate of decrease of the current duty ratio exceeds 15% (in the step S3065: YES), refrigerant leakage is judged to be occurring in the high pressure side irrespective of the variation of the frequency (in the step S3067).

In this procedure, the average change in the duty ratio as calculated in the first minute cycle is not used. Then, after the second minute cycle, the duty ratio is recorded for every minute, and after ten minutes have elapsed, when the rate of change as calculated on the basis of the equation 2 by comparing the current duty ratio with the duty ratio detected 10 minutes before exceeds 15%, the duty ratio is judged to significantly decrease followed by judging refrigerant leakage to occur in the high pressure side.

Namely, the judgment is made when the rate of change in the duty ratio exceeds 15% because in a normal operation the duty ratio may change by about 15% in the freezer compartment cooling operation for 30 to 40 minutes.

Also, in the case where the decrease of the current duty ratio is within 10% to 15%, then refrigerant leakage is judged to be occurring in the high pressure side, if the current designated frequency is increased as compared with the designated frequency 10 minutes before. While there is no error in the predetermined temperature for calculating the frequency of the compressor 3015, it is not necessary to provide a threshold vale for the designated frequency since the inner temperature is not constant but changes beyond measurement error for a certain time.

As explained above, since refrigerant leakage from the refrigeration cycle can be safely detected in accordance with this embodiment of the present invention, it is possible to avoid a fire by halting the operation of an electric element(s) which might be a source of a fire when refrigerant leakage is judged to occur, and possible to inform the user of the refrigerant leakage by alarming in order not to carelessly put a flammable thing in the vicinity of the refrigerator-freezer.

Namely, in accordance with an aspect of the third embodiment of the present invention, in a control device for a refrigerator-freezer comprises: a thermal insulated cabinet in which a fresh-food compartment and a freezer compartment are defined; a fresh-food compartment evaporator configured to cool the fresh-food compartment; a fresh-food compartment capillary located in the inlet port side of the fresh-food compartment evaporator; a freezer compartment evaporator configured to cool the freezer compartment; a freezer compartment capillary located in the inlet port side of the freezer compartment evaporator; a refrigerant path switch mechanism located in the upstream side of the fresh-food compartment capillary and the freezer compartment capillary and configured to switch the refrigerant path for selectively supplying the flammable refrigerant to the fresh-food compartment evaporator and the freezer compartment evaporator; a compressor constituting a circulation path of the flammable refrigerant including two routes for cooling the fresh-food compartment and the freezer compartment as a cooling cycle of the refrigerator-freezer together with the fresh-food compartment evaporator, the freezer compartment evaporator, the fresh-food compartment capillary, the freezer compartment capillary and the refrigerant path switch mechanism and configured to compress the flammable refrigerant; a controller configured to calculate the frequency of the compressor on the basis of a PID calculation with reference to the inner temperatures of the fresh-food compartment and the freezer compartment, and control the compressor and the refrigerant path switch mechanism in accordance with the frequency as calculated in order to alternately cool the fresh-food compartment and the freezer compartment, the control device is provided with a refrigerant leakage detection system configured to judge refrigerant leakage on the basis of the rate of change of the duty ratio of the compressor.

By this configuration, when refrigerant leakage is judged to occur in the refrigeration cycle of the refrigerator-freezer resulting in substantial change in the load on the compressor responsible for flowing the refrigerant in the refrigerant path, it is possible to detect refrigerant leakage with a high reliability by detecting the load change beyond a predetermined range in terms of the duty ratio of the compressor under the PWM control without need for a gas sensor.

Furthermore, preferably, the rate of change of the duty ratio is the rate of change of the average duty ratio in the current cycle of a cooling mode relative to the average duty ratio in the previous cycle of the same cooling mode. By this configuration, it is possible to judge refrigerant leakage with a high reliability irrespective of an instantaneous variation of the duty ratio.

Furthermore, preferably, the rate of change of the duty ratio is the rate of change of the duty ratio in the current cycle of a cooling mode relative to a base duty ratio at a predetermined time point in a past cycle of the same cooling mode. By this configuration, it is possible to detect the duty ratio of the compressor with a high degree of accuracy and judge refrigerant leakage with a high reliability.

Furthermore, preferably, the base duty ratio is the rate duty ratio at a time point when the refrigerant path is switched by means of the refrigerant path switch mechanism, or the duty ratio at a time point when the frequency of the compressor is changed in the previous cycle. By this configuration, it is possible to detect the duty ratio of the compressor with a high degree of accuracy and judge refrigerant leakage with a high reliability.

Namely, in accordance with another aspect of the third embodiment of the present invention, in a method of judging refrigerant leakage for a refrigerator-freezer comprises: a thermal insulated cabinet in which a fresh-food compartment and a freezer compartment are defined; a fresh-food compartment evaporator configured to cool the fresh-food compartment; a fresh-food compartment capillary located in the inlet port side of the fresh-food compartment evaporator; a freezer compartment evaporator configured to cool the freezer compartment; a freezer compartment capillary located in the inlet port side of the freezer compartment evaporator; a refrigerant path switch mechanism located in the upstream side of the fresh-food compartment capillary and the freezer compartment capillary and configured to switch the refrigerant path for selectively supplying the flammable refrigerant to the fresh-food compartment evaporator and the freezer compartment evaporator; a compressor constituting a circulation path of the flammable refrigerant including two routes for cooling the fresh-food compartment and the freezer compartment as a cooling cycle of the refrigerator-freezer together with the fresh-food compartment evaporator, the freezer compartment evaporator, the fresh-food compartment capillary, the freezer compartment capillary and the refrigerant path switch mechanism and configured to compress the flammable refrigerant; a controller configured to calculate the frequency of the compressor on the basis of a PID calculation with reference to the inner temperatures of the fresh-food compartment and the freezer compartment, and control the compressor and the refrigerant path switch mechanism in accordance with the frequency as calculated in order to alternately cool the fresh-food compartment and the freezer compartment, refrigerant leakage is judged by comparing the duty ratio in the current cycle of a cooling mode with the duty ratio in the previous cycle of the same cooling mode.

By this configuration, it is possible to detect refrigerant leakage with a high reliability by detecting the load change beyond a predetermined range without need for a gas sensor.

Furthermore, preferably, refrigerant leakage is judged by comparing the duty ratio in the current cycle of the cooling mode in a predetermined timing with the duty ratio in the previous cycle of the same cooling mode in the same timing. By this configuration, it is possible to judge refrigerant leakage with a high reliability by comparing the current duty ratio with the base duty ratio detected after the system has been stabilized.

Namely, in accordance with a further aspect of the third embodiment of the present invention, in a method of judging refrigerant leakage for a refrigerator-freezer comprises: a thermal insulated cabinet in which a fresh-food compartment and a freezer compartment are defined; a fresh-food compartment evaporator configured to cool the fresh-food compartment; a fresh-food compartment capillary located in the inlet port side of the fresh-food compartment evaporator; a freezer compartment evaporator configured to cool the freezer compartment; a freezer compartment capillary located in the inlet port side of the freezer compartment evaporator; a refrigerant path switch mechanism located in the upstream side of the fresh-food compartment capillary and the freezer compartment capillary and configured to switch the refrigerant path for selectively supplying the flammable refrigerant to the fresh-food compartment evaporator and the freezer compartment evaporator; a compressor constituting a circulation path of the flammable refrigerant including two routes for cooling the fresh-food compartment and the freezer compartment as a cooling cycle of the refrigerator-freezer together with the fresh-food compartment evaporator, the freezer compartment evaporator, the fresh-food compartment capillary, the freezer compartment capillary and the refrigerant path switch mechanism and configured to compress the flammable refrigerant; a controller configured to calculate the frequency of the compressor on the basis of a PID calculation with reference to the inner temperatures of the fresh-food compartment and the freezer compartment, and control the compressor and the refrigerant path switch mechanism in accordance with the frequency as calculated in order to alternately cool the fresh-food compartment and the freezer compartment, refrigerant leakage is judged by comparing the duty ratio in the current cycle of a cooling mode with the duty ratio in the previous cycle of the same cooling mode.

By this configuration, it is possible to detect possible refrigerant leakage without need for a gas sensor in an early stage when it is impossible to detect with a gas sensor, i.e., when the external air is sucked into the refrigerant conduit through an opening generated on a conduit in the low pressure side.

The foregoing description of preferred embodiments has been presented for purposes of illustration and description. It is not intended to be exhaustive or to limit the invention to the precise form described, and obviously many modifications and variations are possible light of the above teaching. The embodiment was chosen in order to explain most clearly the principles of the invention and its practical application thereby to enable others in the art to utilize most effectively the invention in various embodiments and with various modifications as are suited to the particular use contemplated.

For example, the present invention can be applied also to any cooling system making use of a refrigerant such as an air conditioner and so forth in the same manner as a refrigerator-freezer, a freezer and the like with a single function. Also, since the heat transportation mechanism of a thermal cycle such as a heat pump cycle is basically equivalent to that as described above, the present invention is applicable to a heat pump cycle.

Practical Industrial Applicability:

As explained above, in accordance with the present invention, since refrigerant leakage from the refrigeration cycle can be safely detected, it is possible to avoid a fire by halting the operation of an electric element(s) which might be a source of a fire when refrigerant leakage is judged to occur, and possible to inform the user of the refrigerant leakage by alarming in order not to carelessly put a flammable thing in the vicinity of the refrigerator-freezer.

1. A refrigerator-freezer comprising:
a refrigeration cycle formed by a compressor, a capillary, an evaporator and an accumulator connected in series, and filled with a flammable refrigerant;
a cooling fan configured to blow the cold air cooled by said evaporator in said refrigerator-freezer; and
a refrigerant leakage detection system configured to detect leakage of said flammable refrigerant,
wherein said refrigerant leakage detection system is provided with a temperature sensor configured to measure the temperature of a refrigerant conduit of said evaporator and judges that said flammable refrigerant is leaking in the low pressure side of the refrigeration cycle when the temperature is detected by said temperature sensor with said compressor being halted is no lower than a predetermined temperature.

2. The refrigerator-freezer as claimed in claim 7 wherein said refrigerant conduit is a refrigerant conduit located in the inlet port side of said evaporator.

3. The refrigerator-freezer as claimed in claim 7 wherein, when it is judged by said refrigerant leakage detection system that said flammable refrigerant is leaking, the operation of said compressor is halted.

4. The refrigerator-freezer as claimed in claim 7 wherein, when it is judged by said refrigerant leakage detection system that said flammable refrigerant is leaking, a notice such as an alarm is generated a predetermined time after the detection of refrigerant leakage.

5. The refrigerator-freezer as claimed in claim 7 wherein a ventilation conduit for intercommunicating with the external space is provided in the bottom section of a cooling room in which is located the evaporator and wherein, when it is judged by said refrigerant leakage detection system that said flammable refrigerant is leaking, the operation of said cooling fan is halted.

6. The refrigerator-freezer as claimed in claim 7 wherein when the operation of said compressor is continued without a halt, said compressor is halted for every predetermined time period.

7. A refrigerator-freezer comprising:
a refrigeration cycle formed by a compressor, a capillary, an evaporator and an accumulator connected in series, and filled with a flammable refrigerant;
a cooling fan configured to blow the cold air cooled by said evaporator in said refrigerator-freezer; and
a refrigerant leakage detection system configured to detect leakage of said flammable refrigerant,
wherein said refrigerant leakage detection system is provided with a temperature sensor configured to measure the temperature of a refrigerant conduit of said evaporator and judges that said flammable refrigerant is leaking from the high pressure side of the refrigeration cycle when the temperature detected by said temperature sensor with said compressor being operated is no higher than a predetermined temperature.

8. The refrigerator-freezer as claimed in claim 7 wherein said refrigerant conduit is a refrigerant conduit located in the inlet port side of said evaporator.

9. The refrigerator-freezer as claimed in claim 7 wherein a ventilation conduit for intercommunicating with the external space is provided in the bottom section of a cooling room in which is located the evaporator and wherein, when it is judged by said refrigerant leakage detection system that said flammable refrigerant is leaking, the operation of said cooling fan is halted.

10. The refrigerator-freezer as claimed in claim 7 wherein, when it is judged by said refrigerant leakage detection system that said flammable refrigerant is leaking, the operation of said compressor is halted.

11. The refrigerator-freezer as claimed in claim 7 wherein, when it is judged by said refrigerant leakage detection system that said flammable refrigerant is leaking, a notice such as an alarm is generated a predetermined time after the detection of refrigerant leakage.

12. The refrigerator-freezer as claimed in claim 7 wherein when the operation of said compressor is continued without a halt, said compressor is halted for every predetermined time period.

13. A refrigerator-freezer comprising:
a refrigeration cycle formed by a compressor, a capillary, an evaporator and an accumulator connected in series, and filled with a flammable refrigerant;
a cooling fan configured to blow the cold air cooled by said evaporator in said refrigerator-freezer; and
a refrigerant leakage detection system configured to detect leakage of said flammable refrigerant,
wherein said refrigerant leakage detection system is provided with a temperature sensor configured to measure the temperature of a refrigerant conduit of said evaporator and judges that said flammable refrigerant is leaking in the high pressure side of the refrigeration cycle when the temperature detected by said temperature sensor is no lower than a predetermined temperature while the input power to said compressor is decreasing, and that said flammable refrigerant is leaking in the low pressure side of the refrigeration cycle when the temperature detected by said temperature sensor is no higher than a predetermined temperature while the input power to said compressor is increasing.

14. The refrigerator-freezer as claimed in claim 13 wherein a ventilation conduit for intercommunicating with the external space is provided in the bottom section of a cooling room in which is located the evaporator and wherein, when it is judged by said refrigerant leakage detection system that said flammable refrigerant is leaking, the operation of said cooling fan is halted.

15. A refrigerator-freezer comprising:
a refrigeration cycle formed by a compressor, a capillary, an evaporator and an accumulator connected in series, and filled with a flammable refrigerant;
a cooling fan configured to blow the cold air cooled by said evaporator in said refrigerator-freezer; and
a refrigerant leakage detection system configured to detect leakage of said flammable refrigerant,
wherein said refrigerant leakage detection system is provided with temperature sensors configured to measure the temperatures of refrigerant conduits in the inlet and outlet port sides of said evaporator and judges that said flammable refrigerant is leaking in the high pressure side of the refrigeration cycle when the differential temperature between temperatures detected by said temperature sensors is no lower than a predetermined temperature while the input power to said compressor is decreasing, and that said flammable refrigerant is leaking in the low pressure side of the refrigeration cycle when the differential temperature between temperatures detected by said temperature sensors is no higher than a predetermined temperature while the input power to said compressor is increasing.

16. The refrigerator-freezer as claimed in claim 15 wherein a temperature sensor is provided on or near the accumulator to measure the temperature of the conduit in the outlet port side of said evaporator and functions also as a temperature sensor for detecting the timing of starting a defrosting operation.

17. The refrigerator-freezer as claimed in claim 15 wherein a ventilation conduit for intercommunicating with the external space is provided in the bottom section of a cooling room in which is located the evaporator and wherein, when it is judged by said refrigerant leakage detection system that said flammable refrigerant is leaking, the operation of said cooling fan is halted.

18. The refrigerator-freezer as claimed in claim 15 wherein, when it is judged by said refrigerant leakage detection system that said flammable refrigerant is leaking, the operation of said compressor is halted.

19. The refrigerator-freezer as claimed in claim 15 wherein, when it is judged by said refrigerant leakage detection system that said flammable refrigerant is leaking, a notice such as an alarm is generated a predetermined time after the detection of refrigerant leakage.

20. A refrigerator-freezer comprising:
a refrigeration cycle formed by a compressor, a capillary, an evaporator and an accumulator connected in series, and filled with a flammable refrigerant;
a cooling fan configured to blow the cold air cooled by said evaporator in said refrigerator-freezer; and
a temperature sensor configured to measure the temperature of said flammable refrigerant flowing in said evaporator; and
a refrigerant leakage detection system configured to monitor the temperature change of said flammable refrigerant by said temperature sensor and judge leakage of said flammable refrigerant on the basis of the temperature change with reference to the state transitions of said refrigerator-freezer.

21. The refrigerator-freezer as claimed in claim 20 wherein the refrigerator-freezer is provided with a refrigerant confinement mechanism configured to confine said flammable refrigerant in a location of the refrigerant conduit from which said flammable refrigerant does not leak into a freezer compartment and a fresh-food compartment of said refrigerator-freezer when it is judged by said refrigerant leakage detection system that said flammable refrigerant is leaking.

22. The refrigerator-freezer as claimed in claim 20 wherein, when it is judged by said refrigerant leakage detection system that said flammable refrigerant is leaking, a notice such as an alarm is generated.

23. The refrigerator-freezer as claimed in claim 20 wherein, when it is judged by said refrigerant leakage detection system that said flammable refrigerant is leaking, the operation of said compressor is halted.

24. A refrigerator-freezer comprising:
a thermal insulated cabinet in which a fresh-food compartment and a freezer compartment are defined;
a fresh-food compartment evaporator configured to cool said fresh-food compartment;
a fresh-food compartment capillary located in the inlet port side of said fresh-food compartment evaporator;
a freezer compartment evaporator configured to cool said freezer compartment;
a freezer compartment capillary located in the inlet port side of said freezer compartment evaporator;
a refrigerant path switch mechanism located in the upstream side of said fresh-food compartment capillary and said freezer compartment capillary and configured to switch the refrigerant path for selectively supplying said flammable refrigerant to said fresh-food compartment evaporator and said freezer compartment evaporator;
a compressor constituting a circulation path of said flammable refrigerant including two routes for cooling said fresh-food compartment and said freezer compartment as a cooling cycle of said refrigerator-freezer together with said fresh-food compartment evaporator, said freezer compartment evaporator, said fresh-food compartment capillary, said freezer compartment capillary and said refrigerant path switch mechanism and configured to compress said flammable refrigerant;
a temperature sensor located configured to detect the temperature of said flammable refrigerant flowing in at least one of said fresh-food compartment evaporator and said freezer compartment evaporator; and
a refrigerant leakage detection system configured to monitor the temperature change of said flammable refrigerant by said temperature sensor and judge leakage of said flammable refrigerant on the basis of the temperature change with reference to the state transitions of said refrigerator-freezer.

25. The refrigerator-freezer as claimed in claim 20 wherein the refrigerator-freezer is provided with a refrigerant confinement mechanism configured to confine said flammable refrigerant in a location of the refrigerant conduit from which said flammable refrigerant does not leak into the freezer compartment and the fresh-food compartment of said refrigerator-freezer when it is judged by said refrigerant leakage detection system that said flammable refrigerant is leaking.

26. The refrigerator-freezer as claimed in claim 24 wherein, when it is judged by said refrigerant leakage detection system that said flammable refrigerant is leaking, a notice such as an alarm is generated.

27. The refrigerator-freezer as claimed in claim 24 wherein, when it is judged by said refrigerant leakage detection system that said flammable refrigerant is leaking, the operation of an electric device preselected of said refrigerator-freezer is halted.

28. The refrigerator-freezer as claimed in claim 24 wherein, when it is judged by said refrigerant leakage detection system that said flammable refrigerant is leaking, said refrigerant confinement mechanism serves to confine said flammable refrigerant in a high pressure location between the refrigerant draining side of said compressor and said refrigerant path switch mechanism by closing said refrigerant path switch mechanism and driving said compressor for a predetermined time period.

29. The refrigerator-freezer as claimed in claim 25 wherein, when it is judged by said refrigerant leakage detection system that said flammable refrigerant is leaking, said refrigerant confinement mechanism serves to confine said flammable refrigerant in a high pressure location between the refrigerant draining side of said compressor and a check valve by closing said check valve and driving said compressor for a predetermined time period.

30. The refrigerator-freezer as claimed in claim 24 wherein said temperature sensor is provided in each of the inlet port side and the outlet port side of said freezer compartment evaporator or said fresh-food compartment evaporator and
wherein when the differential temperature of said flammable refrigerant between the inlet port side and the outlet port side exceeds a predetermined value, it is judged by said refrigerant leakage detection system that said flammable refrigerant is leaking.

31. The refrigerator-freezer as claimed in claim 24 wherein said temperature sensor is provided in each of the inlet port side and the outlet port side of said freezer compartment evaporator or said fresh-food compartment evaporator and
wherein when the differential temperature of said flammable refrigerant between the inlet port side and the outlet port side continuously exceeds a predetermined value for a predetermined time period, it is judged by said refrigerant leakage detection system that said flammable refrigerant is leaking.

32. The refrigerator-freezer as claimed in claim 24 wherein said temperature sensor is provided in each of the inlet port side and the outlet port side of said fresh-food compartment evaporator and
wherein when the differential temperature of said flammable refrigerant between the inlet port side and the outlet port side continuously exceeds 10 K for 5 minutes, it is judged by said refrigerant leakage detection system that said flammable refrigerant is leaking.

33. The refrigerator-freezer as claimed in claim 24 wherein said temperature sensor is provided in each of the inlet port side and the outlet port side of said freezer compartment evaporator and
wherein when the differential temperature of said flammable refrigerant between the inlet port side and the outlet port side continuously exceeds 5 K for 5 minutes, it is judged by said refrigerant leakage detection system that said flammable refrigerant is leaking.

34. The refrigerator-freezer as claimed in claim 33 wherein, in a freezer compartment cooling mode just after starting the operation of said compressor, said refrigerant leakage detection system judges whether or not said flammable refrigerant is leaking on the basis of the temperature as detected by said temperature sensor a predetermined time after starting the freezer compartment cooling mode.

35. The refrigerator-freezer as claimed in claim 24 wherein said temperature sensor is provided in the inlet port side of said freezer compartment evaporator or said fresh-food compartment evaporator and
wherein said refrigerant leakage detection system serves to store the temperature data as detected by said temperature sensor and judges that said flammable refrigerant is leaking when the current temperature of said flammable refrigerant is no higher than the average temperature in the previous cycle minus a predetermined value.

36. The refrigerator-freezer as claimed in claim 24 wherein said temperature sensor is provided in the inlet port side of said freezer compartment evaporator or said fresh-food compartment evaporator and
wherein said refrigerant leakage detection system serves to store the temperature data as detected by said temperature sensor and judges that said flammable refrigerant is leaking when the current temperature of said flammable refrigerant is continuously no higher than the average temperature in the previous cycle minus a predetermined value for a predetermined time period.

37. The refrigerator-freezer as claimed in claim 36 wherein when the current temperature of said flammable refrigerant is continuously lower than the average temperature by no lower than 5 K for 20 minutes, it is judged by said refrigerant leakage detection system that said flammable refrigerant is leaking.

38. The refrigerator-freezer as claimed in claim 36 wherein said flammable refrigerant is a hydrocarbon base flammable refrigerant (HC refrigerant).

39. A control device for a refrigerator-freezer comprising:
a thermal insulated cabinet in which a fresh-food compartment and a freezer compartment are defined;
a fresh-food compartment evaporator configured to cool said fresh-food compartment;
a fresh-food compartment capillary located in the inlet port side of said fresh-food compartment evaporator;
a freezer compartment evaporator configured to cool said freezer compartment;
a freezer compartment capillary located in the inlet port side of said freezer compartment evaporator;
a refrigerant path switch mechanism located in the upstream side of said fresh-food compartment capillary and said freezer compartment capillary and configured to switch the refrigerant path for selectively supplying said flammable refrigerant to said fresh-food compartment evaporator and said freezer compartment evaporator;
a compressor constituting a circulation path of said flammable refrigerant including two routes for cooling said fresh-food compartment and said freezer compartment as a cooling cycle of said refrigerator-freezer together with said fresh-food compartment evaporator, said freezer compartment evaporator, said fresh-food compartment capillary, said freezer compartment capillary and said refrigerant path switch mechanism and configured to compress said flammable refrigerant;
a controller configured to calculate the frequency of said compressor on the basis of a PID calculation with reference to the inner temperatures of said fresh-food compartment and said freezer compartment, and control said compressor and said refrigerant path switch mechanism in accordance with the frequency as calculated in order to alternately cool said fresh-food compartment and said freezer compartment,
wherein said control device is provided with a refrigerant leakage detection system configured to judge refrigerant leakage on the basis of the rate of change of the duty ratio of said compressor.

40. The control device for the refrigerator-freezer as claimed in claim 39 wherein the rate of change of the duty ratio is the rate of change of the average duty ratio in the current cycle of a cooling mode relative to the average duty ratio in the previous cycle of the same cooling mode.

41. The control device for the refrigerator-freezer as claimed in claim 39 wherein the rate of change of the duty ratio is the rate of change of the duty ratio in the current cycle of a cooling mode relative to a base duty ratio at a predetermined time point in a past cycle of the same cooling mode.

42. The control device for the refrigerator-freezer as claimed in claim 41 wherein said base duty ratio is the rate duty ratio at a time point when the refrigerant path is switched by means of said refrigerant path switch mechanism.

43. The control device for the refrigerator-freezer as claimed in claim 41 wherein said base duty ratio is the duty ratio at a time point when the frequency of the compressor is changed in the previous cycle.

44. The control device for the refrigerator-freezer as claimed in claim 39 wherein said refrigerant leakage detection system judges that said flammable refrigerant is leaking in the high pressure side of the refrigeration cycle when the decrease of the duty ratio is no smaller than a predetermined value.

45. The control device for the refrigerator-freezer as claimed in claim 39 wherein said refrigerant leakage detection system judges that said flammable refrigerant is leaking in the high pressure side of the refrigeration cycle when the increase of the duty ratio is no smaller than a predetermined value.

46. The control device for the refrigerator-freezer as claimed in claim 39 wherein a temperature sensor is provided in each of the inlet port and the outlet port of said freezer compartment evaporator, and
wherein when the differential temperature of said flammable refrigerant between the inlet port side and the outlet port side of said freezer compartment evaporator exceeds a predetermined value while the increase of the current duty ratio exceeds a predetermined value, it is judged by said refrigerant leakage detection system that said flammable refrigerant is leaking in the low pressure side of the refrigeration cycle.

47. The control device for the refrigerator-freezer as claimed in claim 39 wherein when the decrease of the duty ratio exceeds a predetermined value while the increase of the frequency as calculated on the basis of the PID calculation exceeds a predetermined value, it is judged by said refrigerant leakage detection system that said flammable refrigerant is leaking in the high pressure side of the refrigeration cycle.

48. A method of judging refrigerant leakage for a refrigerator-freezer comprising:
a thermal insulated cabinet in which a fresh-food compartment and a freezer compartment are defined;
a fresh-food compartment evaporator configured to cool said fresh-food compartment;
a fresh-food compartment capillary located in the inlet port side of said fresh-food compartment evaporator;
a freezer compartment evaporator configured to cool said freezer compartment;
a freezer compartment capillary located in the inlet port side of said freezer compartment evaporator;
a refrigerant path switch mechanism located in the upstream side of said fresh-food compartment capillary and said freezer compartment capillary and configured to switch the refrigerant path for selectively supplying said flammable refrigerant to said fresh-food compartment evaporator and said freezer compartment evaporator;
a compressor constituting a circulation path of said flammable refrigerant including two routes for cooling said fresh-food compartment and said freezer compartment as a cooling cycle of said refrigerator-freezer together with said fresh-food compartment evaporator, said freezer compartment evaporator, said fresh-food compartment capillary, said freezer compartment capillary and said refrigerant path switch mechanism and configured to compress said flammable refrigerant;
a controller configured to calculate the frequency of said compressor on the basis of a PID calculation with reference to the inner temperatures of said fresh-food compartment and said freezer compartment, and control said compressor and said refrigerant path switch mechanism in accordance with the frequency as calculated in order to alternately cool said fresh-food compartment and said freezer compartment,
wherein refrigerant leakage is judged by comparing the duty ratio in the current cycle of a cooling mode with the duty ratio in the previous cycle of the same cooling mode.

49. The method of judging refrigerant leakage for the refrigerator-freezer as claimed in claim 48 wherein refrigerant leakage is judged by comparing the duty ratio in the current cycle of the cooling mode in a predetermined timing with the duty ratio in the previous cycle of the same cooling mode in the same timing.

50. The method of judging refrigerant leakage for the refrigerator-freezer as claimed in claim 48 wherein the duty ratios are compared with each other at the same frequency of the compressor.

51. The method of judging refrigerant leakage for the refrigerator-freezer as claimed in claim 48 wherein when the decrease of the duty ratio as a result of the comparison in the duty ratio of said compressor exceeds a predetermined value, it is judged that said flammable refrigerant is leaking in the high pressure side.

52. The method of judging refrigerant leakage for the refrigerator-freezer as claimed in claim 48 wherein when the increase of the duty ratio as a result of the comparison in the duty ratio of said compressor exceeds a predetermined value, it is judged that said flammable refrigerant is leaking in the low pressure side.

53. The method of judging refrigerant leakage for the refrigerator-freezer as claimed in claim 48 wherein when the decrease of the duty ratio as a result of the comparison in the duty ratio of said compressor exceeds a predetermined value or when the increase of the duty ratio as a result of the comparison in the duty ratio of said compressor exceeds a predetermined value, said refrigerant path switch mechanism and the frequency of said compressor are fixed for a predetermined period.

54. A method of judging refrigerant leakage for a refrigerator-freezer comprising:
a thermal insulated cabinet in which a fresh-food compartment and a freezer compartment are defined;
a fresh-food compartment evaporator configured to cool said fresh-food compartment;
a fresh-food compartment capillary located in the inlet port side of said fresh-food compartment evaporator;
a freezer compartment evaporator configured to cool said freezer compartment;
a freezer compartment capillary located in the inlet port side of said freezer compartment evaporator;
a refrigerant path switch mechanism located in the upstream side of said fresh-food compartment capillary and said freezer compartment capillary and configured to switch the refrigerant path for selectively supplying said flammable refrigerant to said fresh-food compartment evaporator and said freezer compartment evaporator;
a compressor constituting a circulation path of said flammable refrigerant including two routes for cooling said fresh-food compartment and said freezer compartment as a cooling cycle of said refrigerator-freezer together with said fresh-food compartment evaporator, said freezer compartment evaporator, said fresh-food compartment capillary, said freezer compartment capillary and said refrigerant path switch mechanism and configured to compress said flammable refrigerant;
a controller configured to calculate the frequency of said compressor on the basis of a PID calculation with reference to the inner temperatures of said fresh-food compartment and said freezer compartment, and control said compressor and said refrigerant path switch mechanism in accordance with the frequency as calculated in order to alternately cool said fresh-food compartment and said freezer compartment,
wherein, while the duty ratio in the current cycle of a cooling mode is compared with the duty ratio in the previous cycle of the same cooling mode and the differential temperature between the inlet port and the outlet port of the freezer compartment evaporator is measured,
it is judged that said flammable refrigerant is leaking in the low pressure side of the refrigeration cycle when the differential temperature of said flammable refrigerant between the inlet port side and the outlet port side of said freezer compartment evaporator exceeds a predetermined value while the increase of the current duty ratio exceeds a predetermined value.
